(19) United States
(12) Patent Application Publication
(10) Pub. No.: US 2013/0030867 A1
(43) Pub. Date: Jan. 31, 2013

(54) MANAGING CONSISTENT INTERFACES FOR CAMPAIGN RESPONSE OPTION, SALES TARGET PLAN, SALES PRICE LIST AND SALES SPECIFICATION BUSINESS OBJECTS ACROSS HETEROGENEOUS SYSTEMS

(71) Applicants: Dirk Wagner, Schiffweiler (DE); Martin Steiert, Heidelberg (DE); Thomas Nitschke, Wiesloch (DE); Aravinda Pantar, Bangalore (IN); Peter Latocha, Malsch (DE); Michael Seubert, Sinsheim (DE); Christoph Lehner, Heidelberg (DE); Gururaj Raman, Bad-Schoenborn (DE); Christof Weissenberger, Sinsheim (DE); Werner Gnan, Angelbachtal (DE)

(72) Inventors: Dirk Wagner, Schiffweiler (DE); Martin Steiert, Heidelberg (DE); Thomas Nitschke, Wiesloch (DE); Aravinda Pantar, Bangalore (IN); Peter Latocha, Malsch (DE); Michael Seubert, Sinsheim (DE); Christoph Lehner, Heidelberg (DE); Gururaj Raman, Bad-Schoenborn (DE); Christof Weissenberger, Sinsheim (DE); Werner Gnan, Angelbachtal (DE)

(73) Assignee: SAP AG, Walldorf (DE)

(21) Appl. No.: 13/192,543

(22) Filed: Jul. 28, 2011

(51) Int. Cl. G06Q 30/02

(52) U.S. Cl. 705/7.32; 705/26.61

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a campaign response option, a sales target plan, a sales price list and a sales specification business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a tangible computer readable medium includes program code for providing a message-based interface for exchanging campaign response options. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification of a response option that specifies how a customer who has been contacted as part of a campaign can respond to the campaign, the first message including a first message package derived from the common business object model and hierarchically organized in memory as a campaign response option message entity and a campaign response option package comprising a campaign response option entity, where the campaign response option entity includes a universally unique identifier (UUID), an identifier (ID), a status, and a life cycle status code.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The campaign response option package further comprises at least one of the following: an overview package and a description package. The campaign response option entity further includes at least one of the following: a category code and system administrative data.

In another aspect, a distributed system operates in a landscape of computer systems providing message-based services defined in a service registry. The system comprises a graphical user interface comprising computer readable instructions, embedded on tangible media, for providing a notification of a response option that specifies how a customer who has been contacted as part of a campaign can respond to the campaign, using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a campaign response option message entity and a campaign response option package comprising a campaign response option entity, where the campaign response option entity includes a universally unique identifier (UUID), an identifier (ID), a status, and a life cycle status code.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface

In another aspect, a tangible computer readable medium includes program code for providing a message-based interface for exchanging sales price list information. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a synchronous request for finding a sales price list by its type code, property identifier (ID) and property value that includes a first message package derived from the common business object model and hierarchically organized in memory as a sales price list find by type code and property ID and property value query message entity and a sales price list package comprising a sales price list entity.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The sales price list entity includes at least one of the following: an ID, a release status code, a price specification list release status code, an approval status code, a consistency status code, a validity period, a creation date time interval, a last changed datetime interval, a type code, a first property valuation price specification element property valuation, a second property valuation price specification element property valuation, a third property valuation price specification element property valuation, a fourth property valuation price specification element property valuation, a fifth property valuation price specification element property valuation, a sixth property valuation price specification element property valuation, a seventh property valuation price specification element property valuation, an eighth property valuation price specification element property valuation, a ninth property valuation price specification element property valuation, a tenth property valuation price specification element property valuation, a first price specification property valuation price specification element property valuation, a second price specification property valuation price specification element property valuation, a third price specification property valuation price specification element property valuation, a fourth price specification property valuation price specification element property valuation, a fifth price specification property valuation price specification element property valuation, a sixth price specification property valuation price specification element property valuation, a seventh price specification property valuation price specification element property valuation, an eighth price specification property valuation price specification element property valuation, a ninth price specification property valuation price specification element property valuation, and a tenth price specification property valuation price specification element property valuation.

In another aspect, a distributed system operates in a landscape of computer systems providing message-based services defined in a service registry. The system comprises a graphical user interface comprising computer readable instructions, embedded on tangible media, for a synchronous request for finding a sales price list by its type code, property identifier (ID) and property value using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a sales price list find by type code and property ID and property value query message entity and a sales price list package comprising a sales price list entity.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging sales price specification information.

The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a synchronous request for finding a sales price specification by its type code, property identifier (ID) and property value that includes a first message package derived from the common business object model and hierarchically organized in memory as a sales price specification find by type code and property ID and property value query elements message entity and a sales price specification find by type code and property ID and property value query elements package comprising a sales price specification find by type code and property ID and property value query elements entity.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The sales price specification find by type code and property ID and property value query elements entity includes at least one of the following: a price specification element type code, a release status code, a consistency status code, a validity period, a creation date time interval, a last changed datetime interval, a first price specification element property valuation, a second price specification element property valuation, a third price specification element property valuation, a fourth price specification element property valuation, a fifth price specification element property valuation, a sixth price specification element property valuation, a seventh price specification element property valuation, an eighth price specification element property valuation, a ninth price specification element property valuation, and a tenth price specification element property valuation.

In another aspect, a distributed system operates in a landscape of computer systems providing message-based services defined in a service registry. The system comprises a graphical user interface comprising computer readable instructions, embedded on tangible media, for a synchronous request for finding a sales price specification by its type code, property ID and property value using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a sales price specification find by type code and property ID and property value query elements message entity and a sales price specification find by type code and property ID and property value query elements package comprising a sales price specification find by type code and property ID and property value query elements entity.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging sales target plans that provide revenue targets for particular sales units and time horizons. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification of a sales target plan that provides revenue targets for a particular sales unit and a time horizon that includes a first message package derived from the common business object model and hierarchically organized in memory as a sales target plan message entity and a sales target plan package comprising a sales target plan entity, a characteristic package, and a key figure package.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The sales target plan package further comprises at least one of the following: a description package, a version package, a view package, and a restriction by characteristic package. The sales target plan entity includes at least one of the following: a universally unique identifier (UUID), a sales target plan identifier (ID), a sales unit ID, a horizon start year month, a horizon end year month, a status and a meta object key.

In another aspect, a distributed system operates in a landscape of computer systems providing message-based services defined in a service registry. The system comprises a graphical user interface comprising computer readable instructions, embedded on tangible media, for providing a notification of a sales target plan that provides revenue targets for a particular sales unit and a time horizon using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a sales target plan message entity and a sales target plan package comprising a sales target plan entity, a characteristic package, and a key figure package.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example Campaign Response Option Object Model.

FIG. 33 depicts an example SalesPriceListFindbyTypeCodeandPropertyIDandPropertyValueQuery_sync Message Data Type.

FIGS. 34-1 through 34-7 collectively depict an example SalesPriceListFindbyTypeCodeandPropertyIDandPropertyValueQuery_sync Element Structure.

FIG. 35 depicts an example SalesPriceListFindbyTypeCodeandPropertyIDandPropertyValueResponse_sync Message Data Type.

FIGS. 36-1 through 36-3 collectively depict an example SalesPriceListFindbyTypeCodeandPropertyIDandPropertyValueResponse_sync Element Structure.

FIG. 37 depicts an example SalesPriceSpecificationFindbyTypeCodeandPropertyIDandPropertyValueQuery_sync Message Data Type.

FIGS. 38-1 through 38-5 collectively depict an example SalesPriceSpecificationFindbyTypeCodeandPropertyIDandPropertyValueQuery_sync Element Structure.

FIG. 39 depicts an example SalesPriceSpecificationFindbyTypeCodeandPropertyIDandPropertyValueResponse_sync Message Data Type.

FIGS. 40-1 through 40-12 collectively depict an example SalesPriceSpecificationFindbyTypeCodeandPropertyIDandPropertyValueResponse_sync Element Structure.

FIG. 41 depicts an example Sales Target Plan Object Model.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

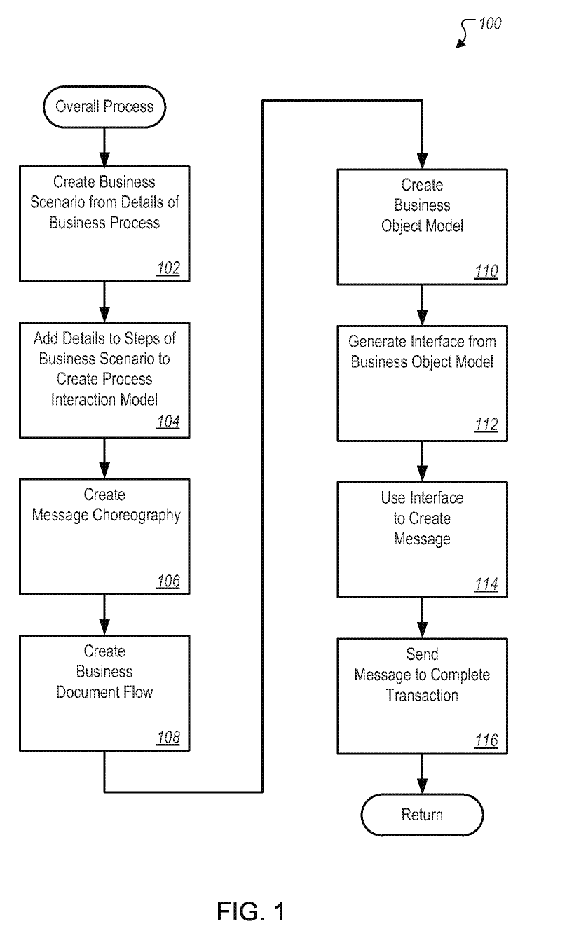

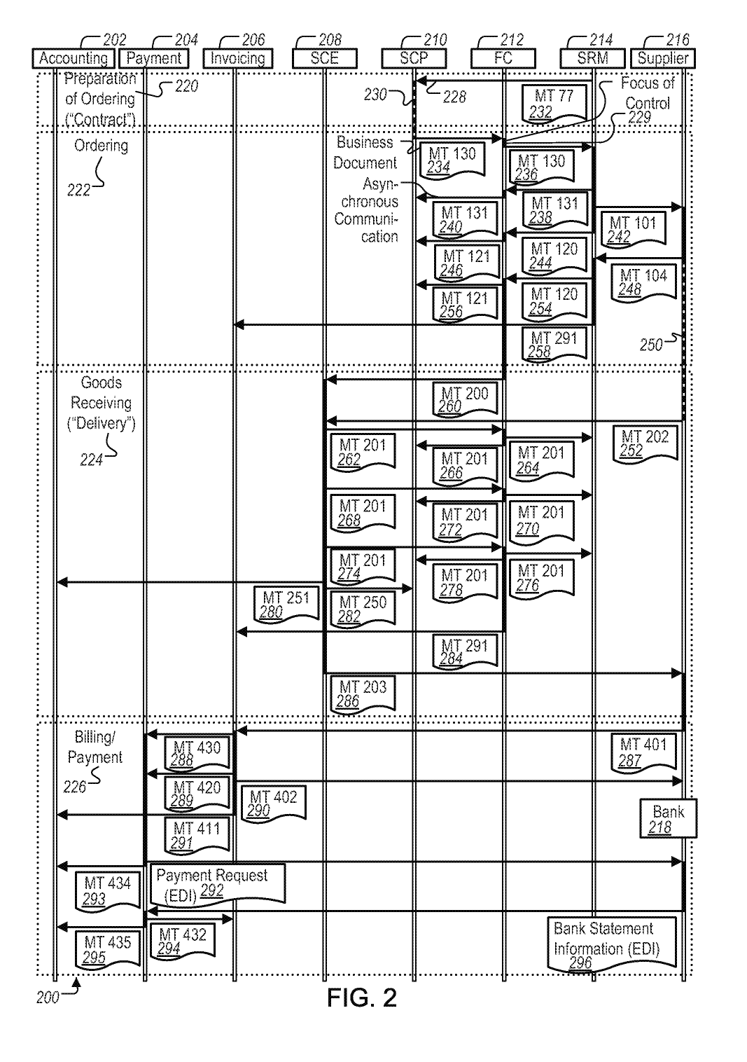

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components. After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

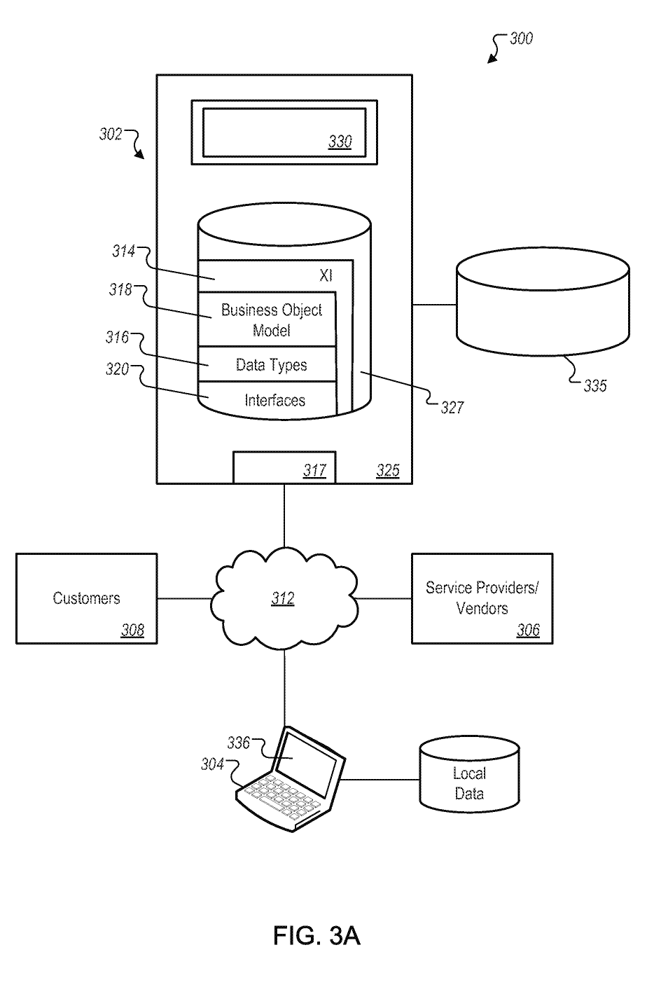

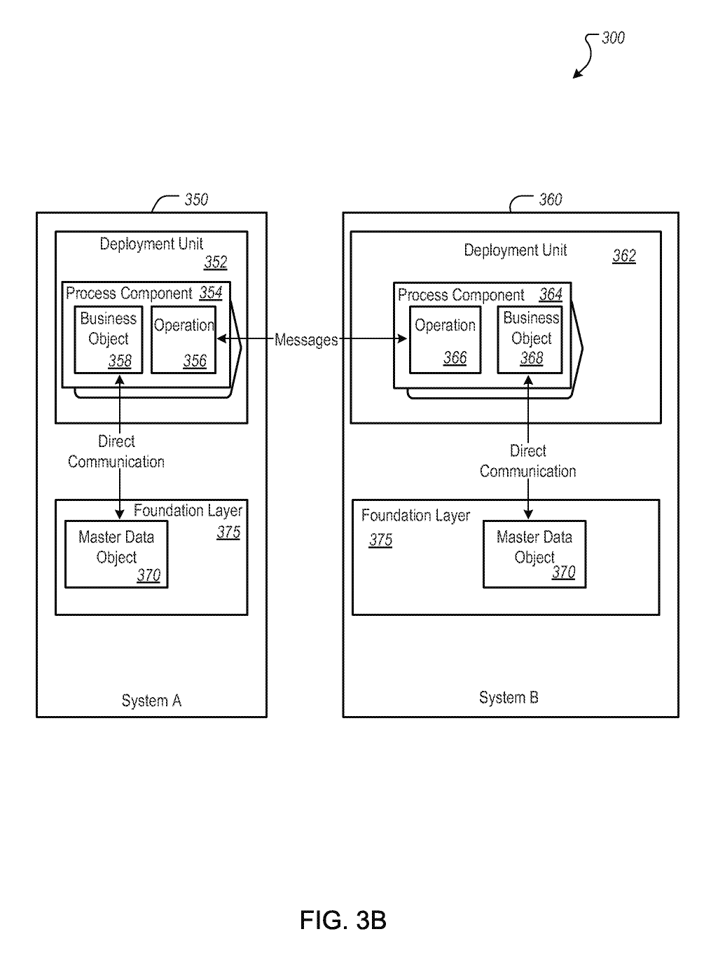

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

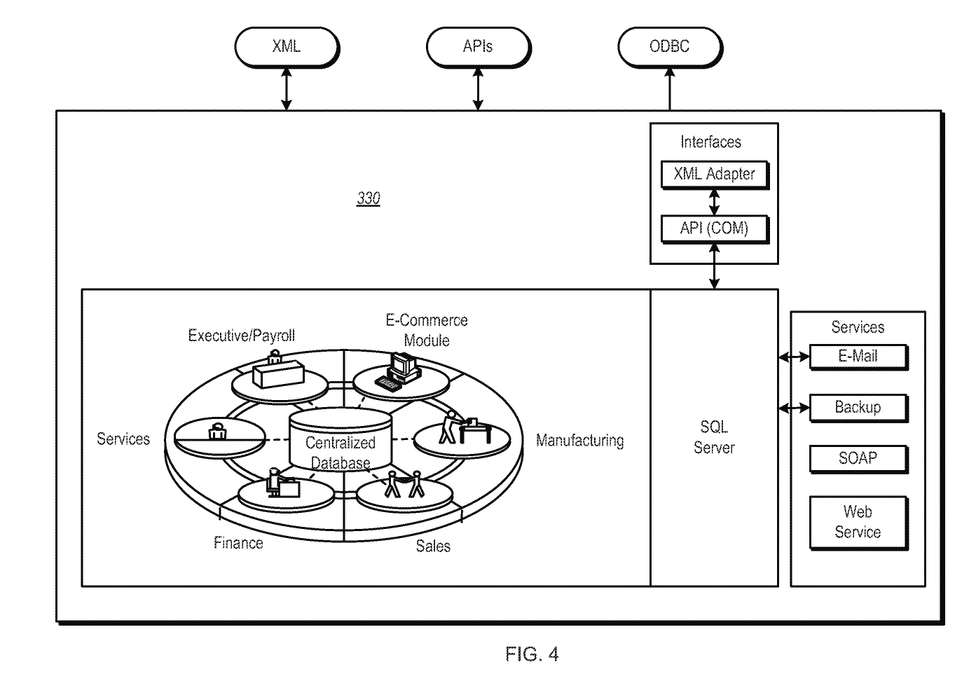

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 306 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

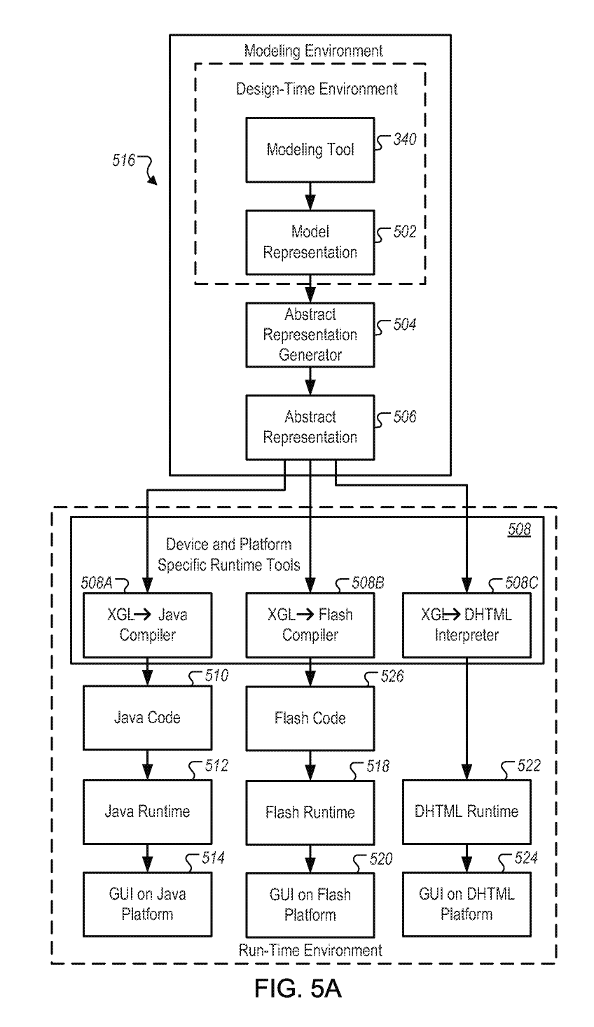

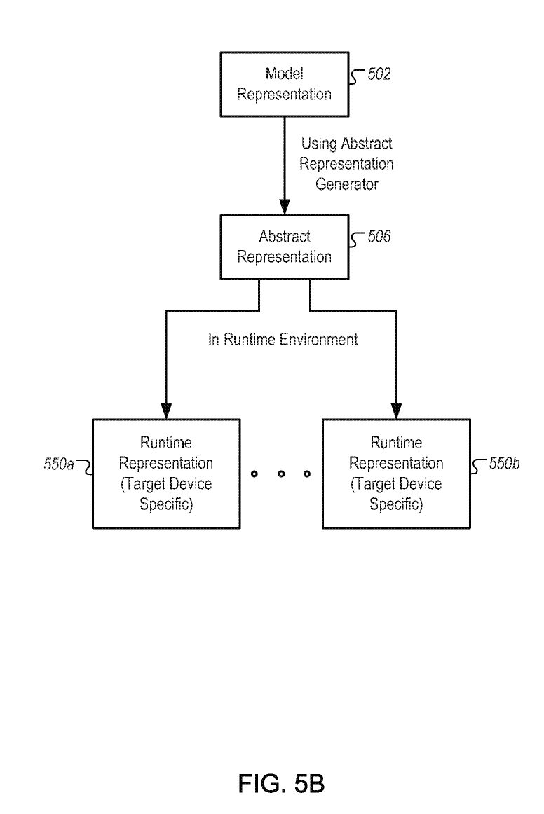

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

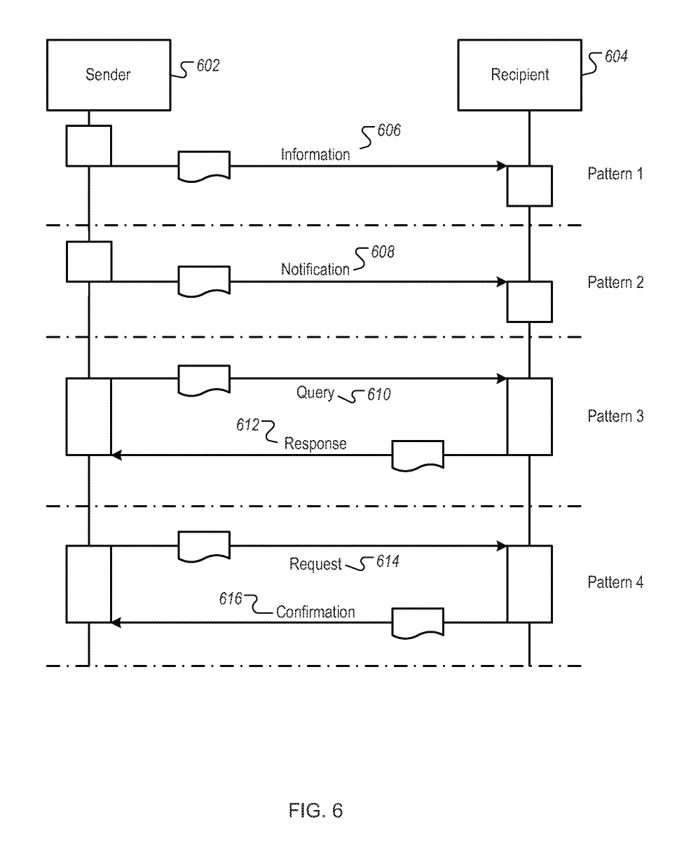

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

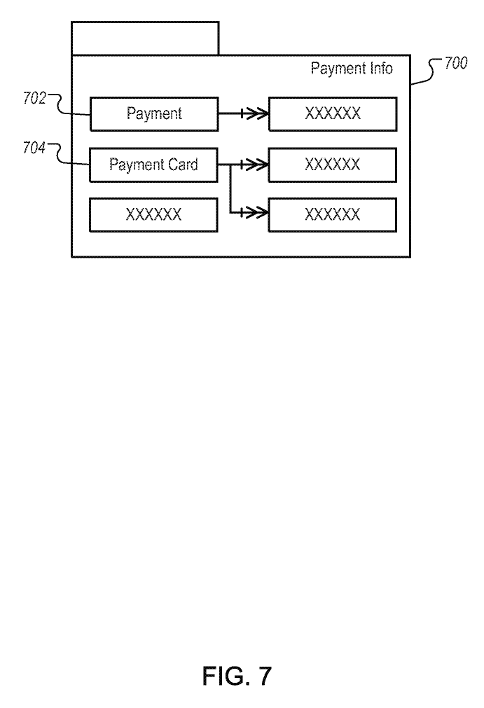

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

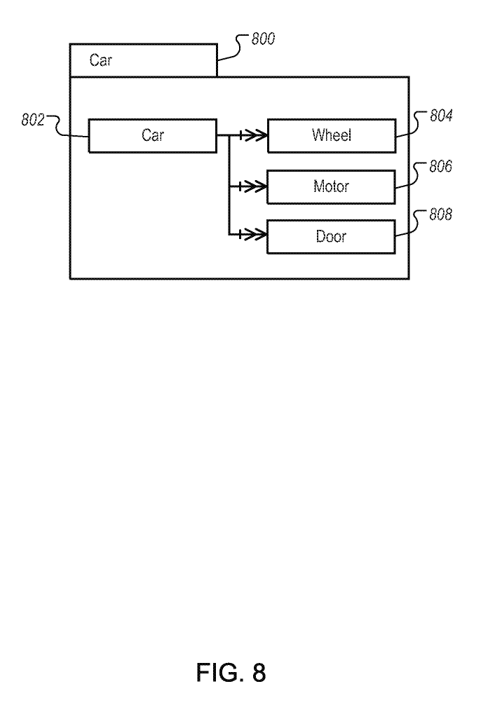

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

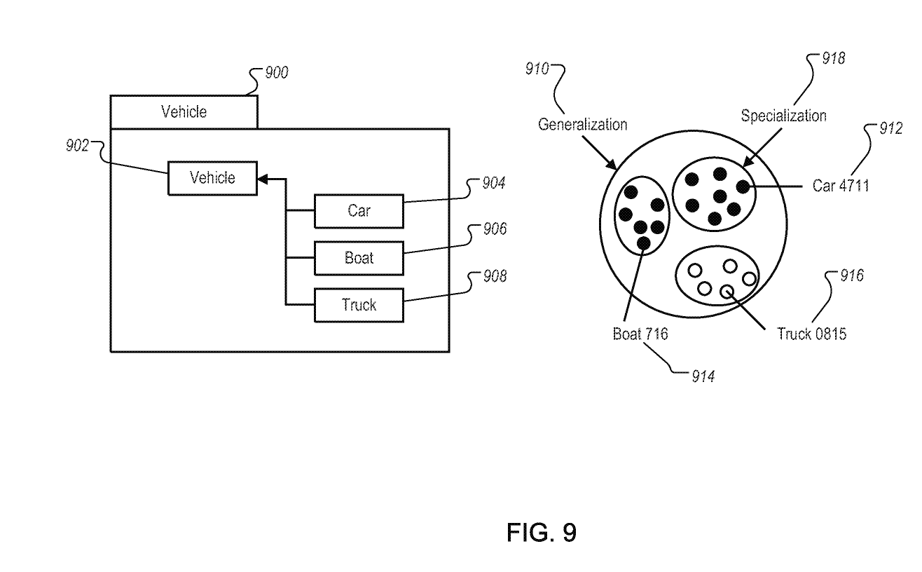

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

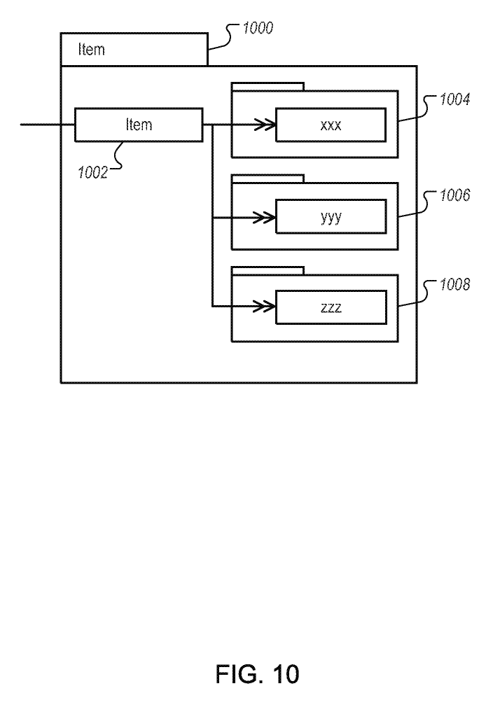

Packages also may be used to represent hierarchy levels. For example, as depicted in FIG. 10, the Item Package 1000 includes Item 1002 with subitem xxx 1004, subitem yyy 1006, and subitem zzz 1008.

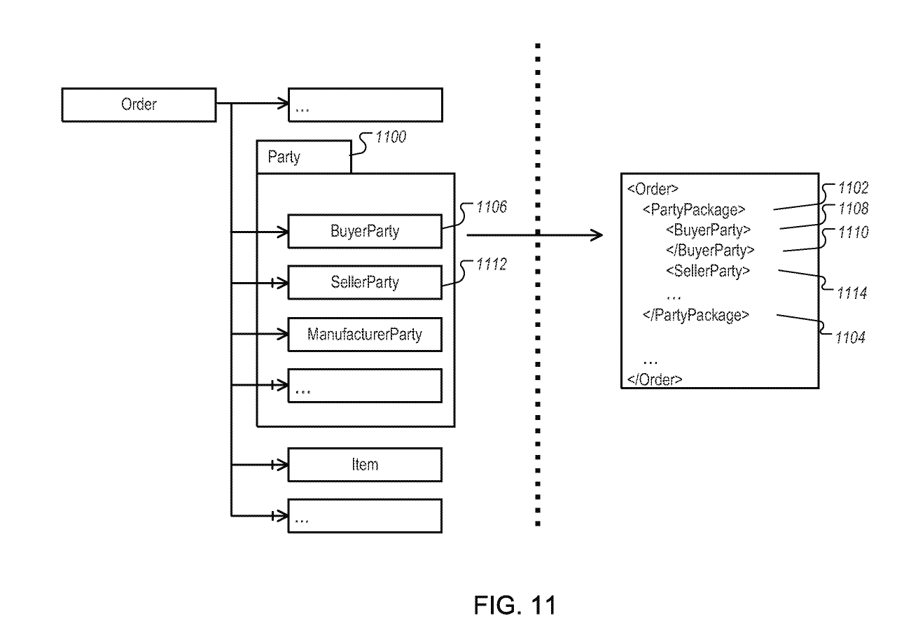

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

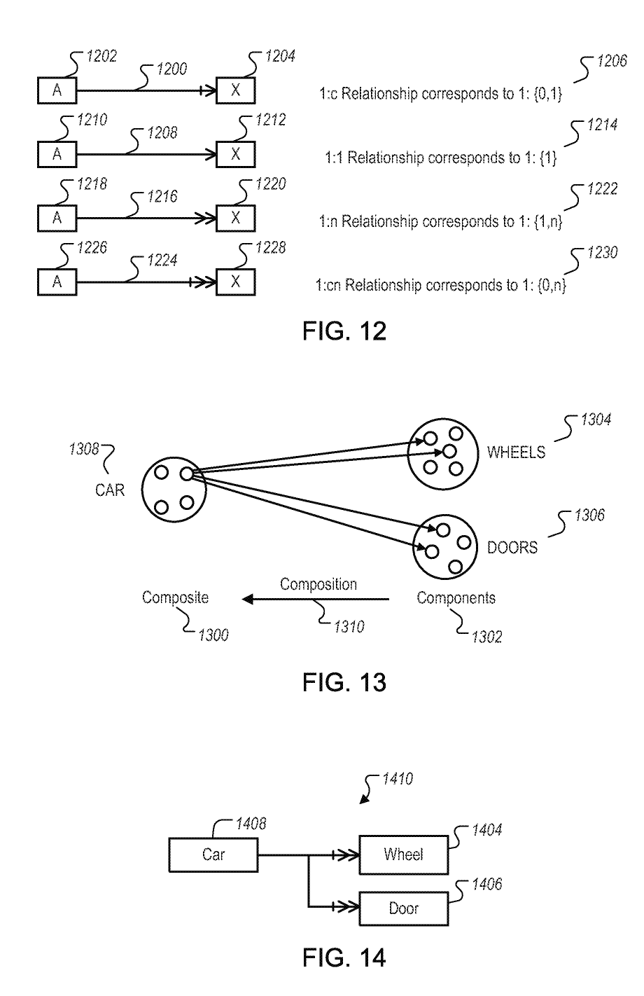

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

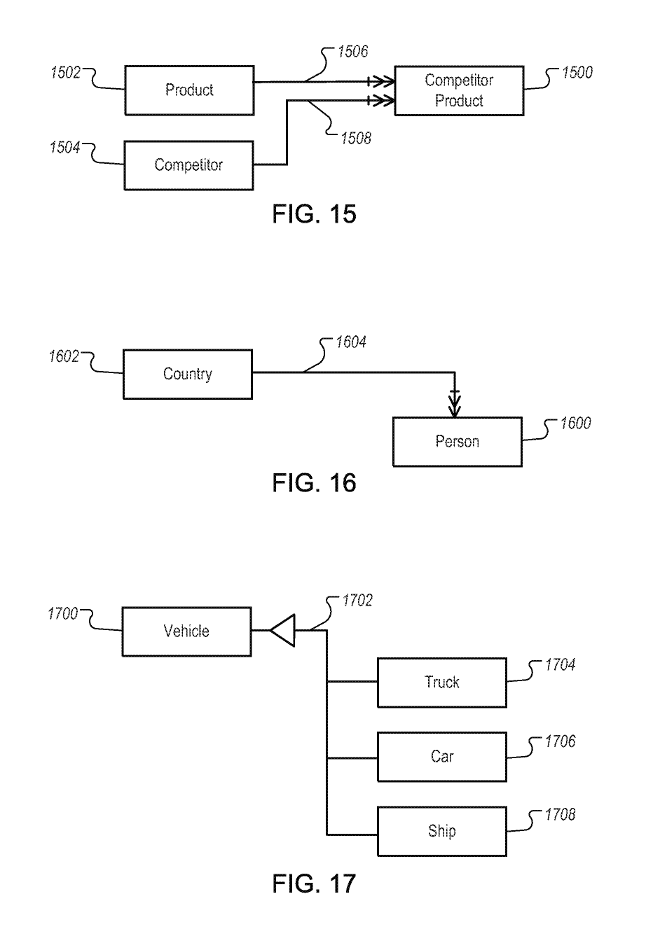

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

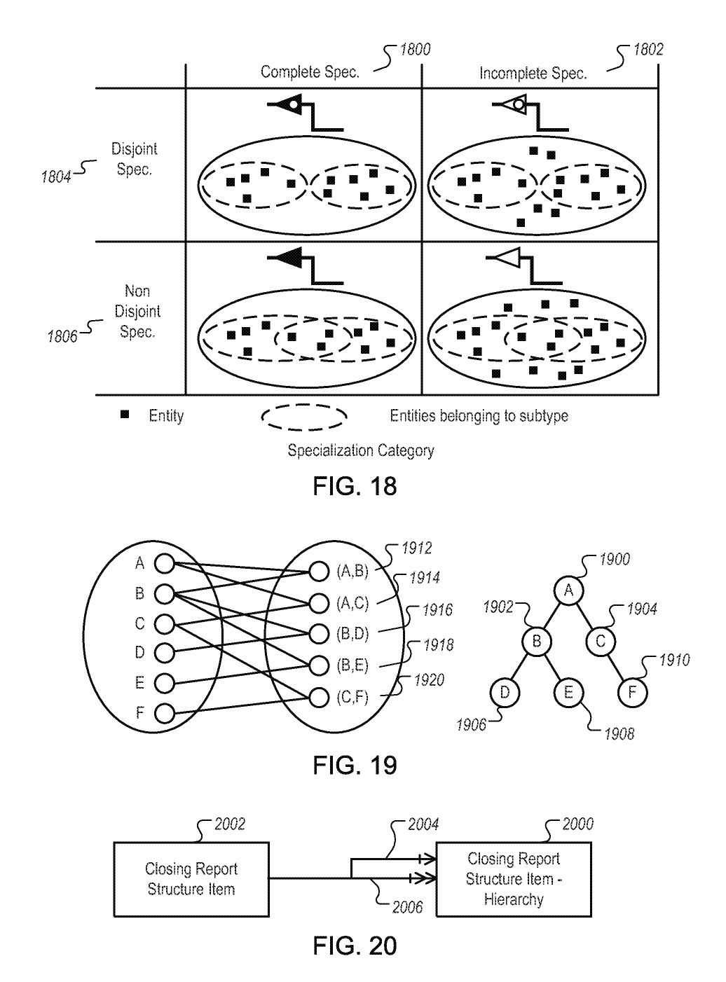

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

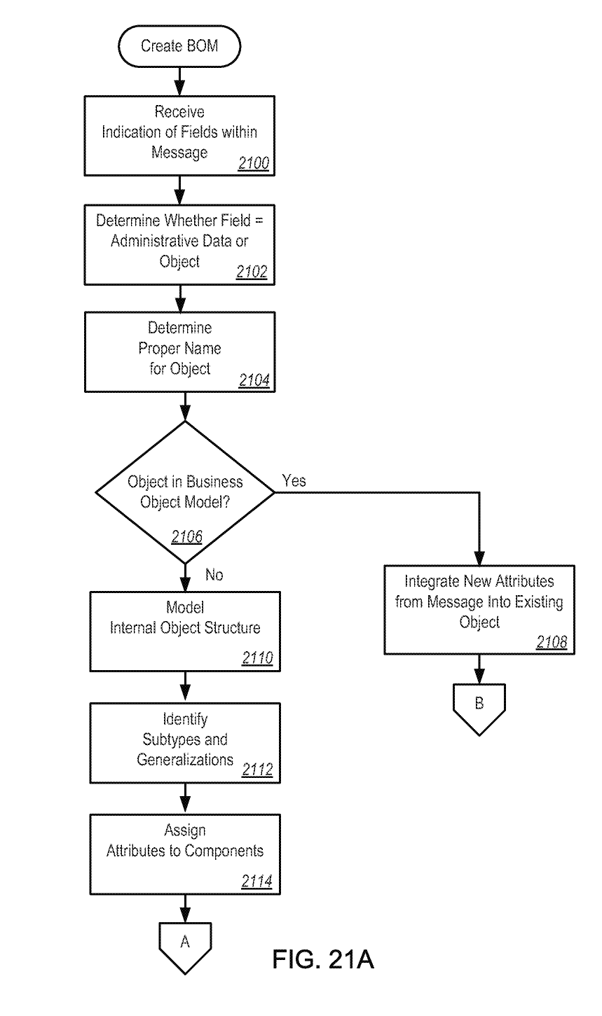

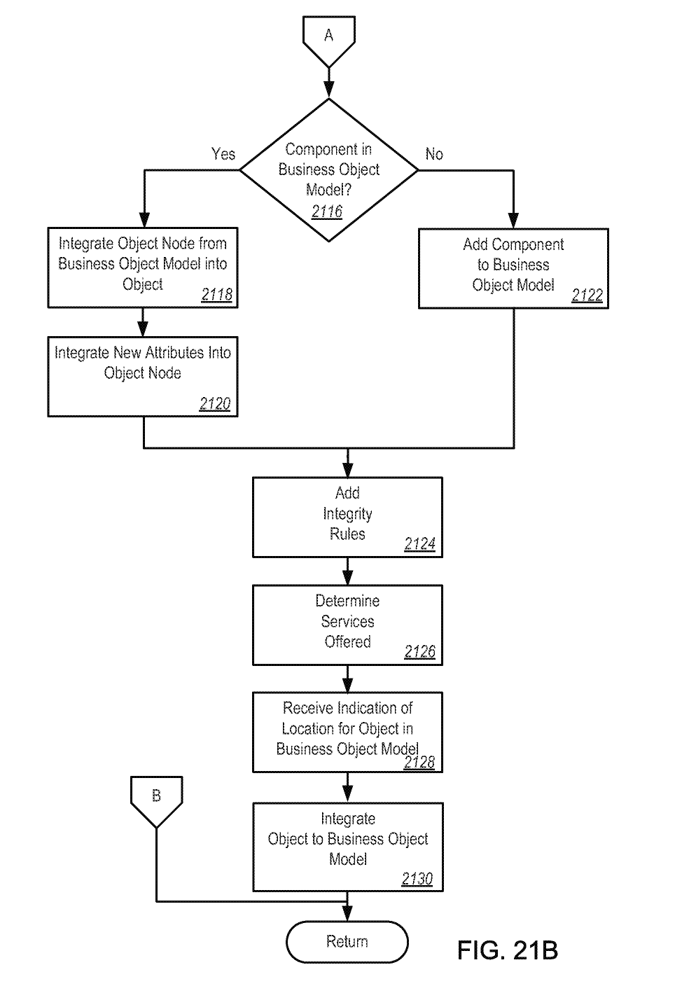

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although to some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Pur- | | |
| AdditionalID | chase | | |
| PostingDate | Order | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

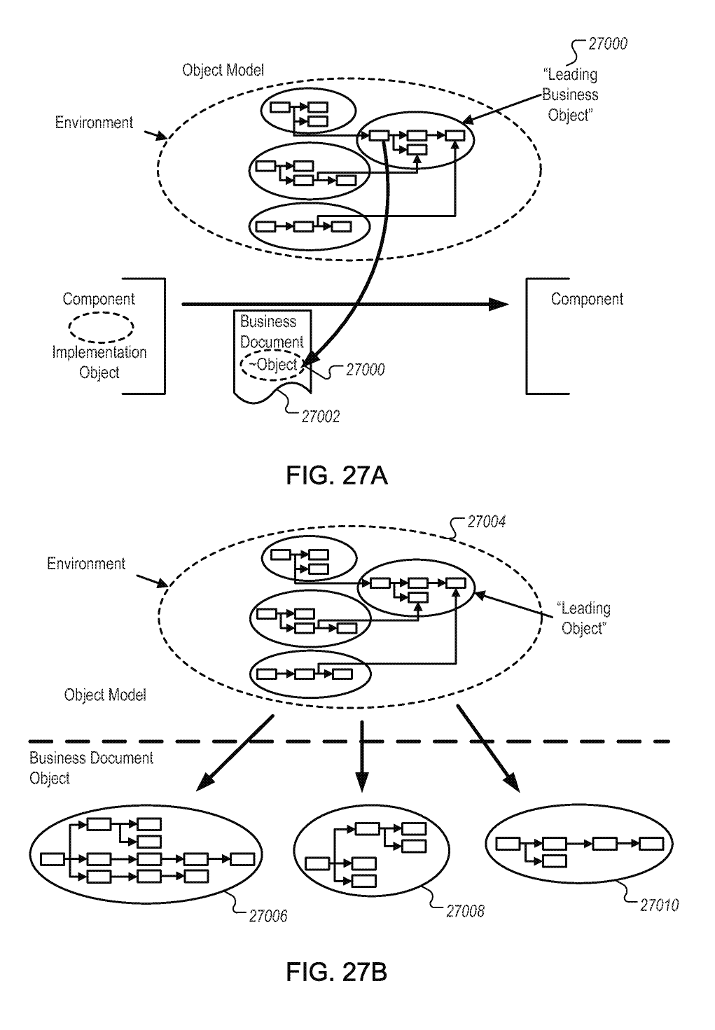

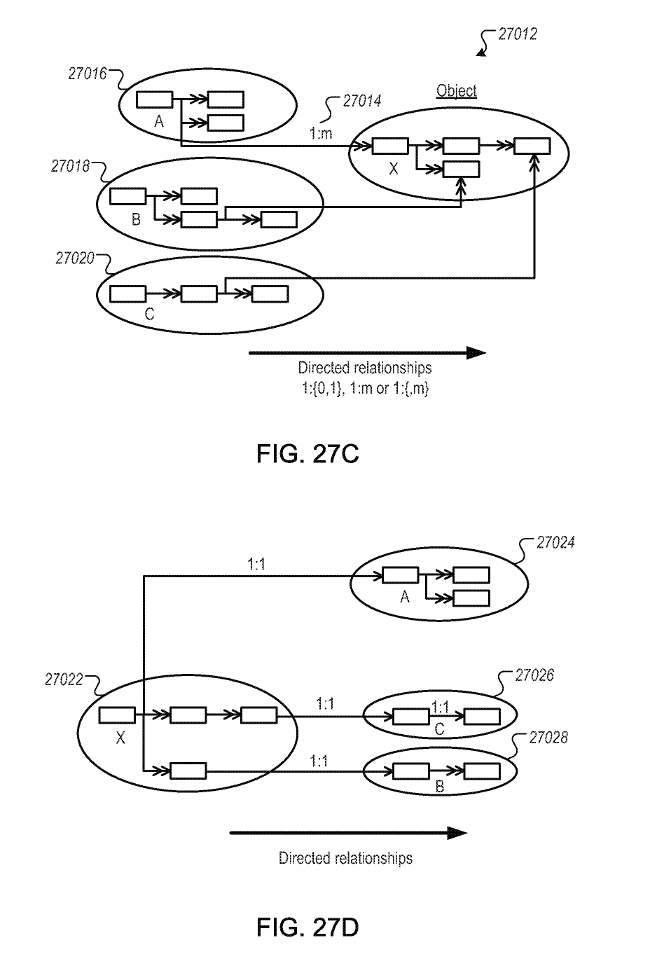

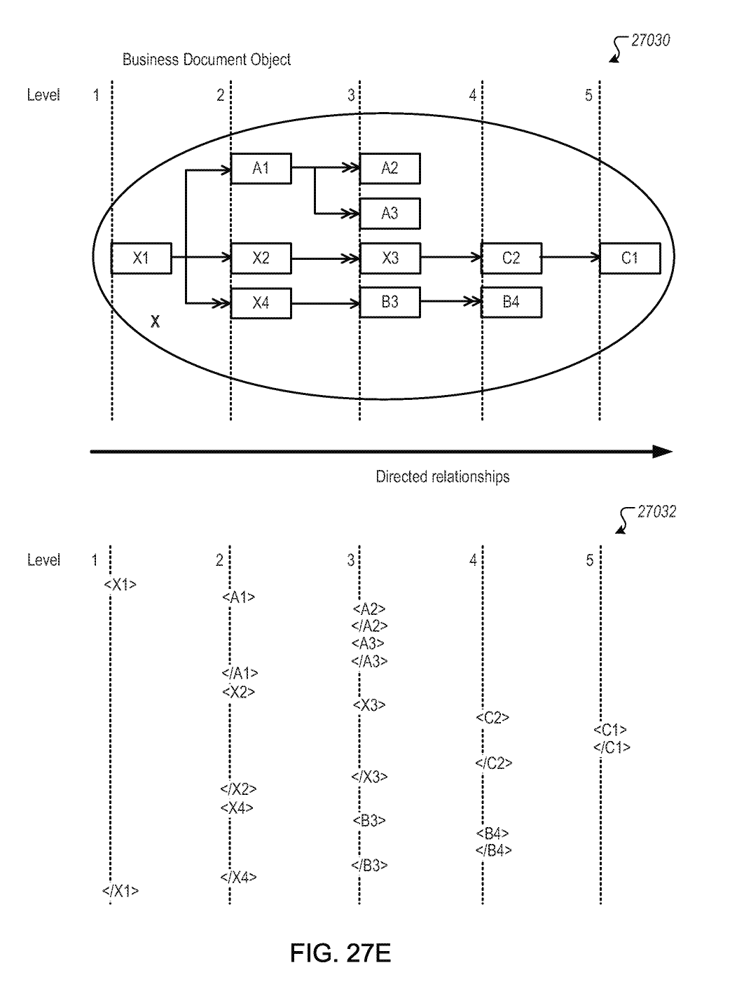

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

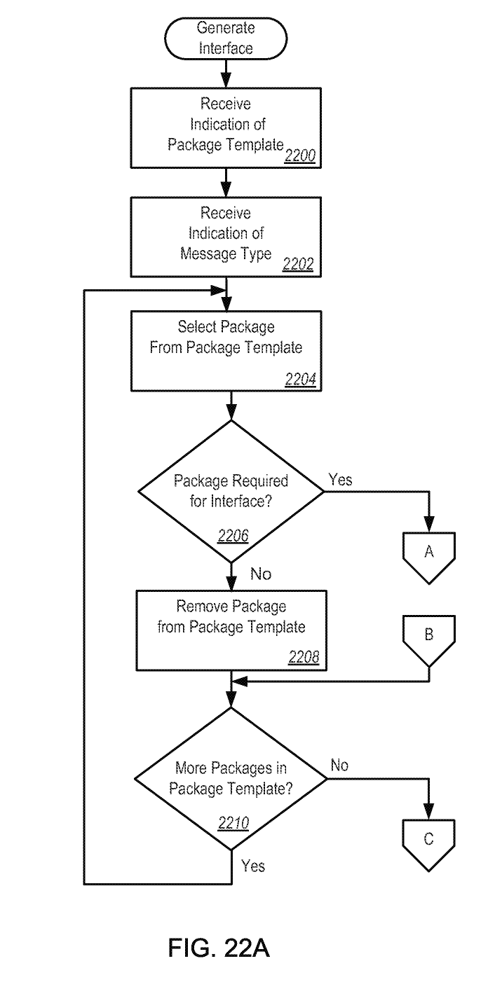

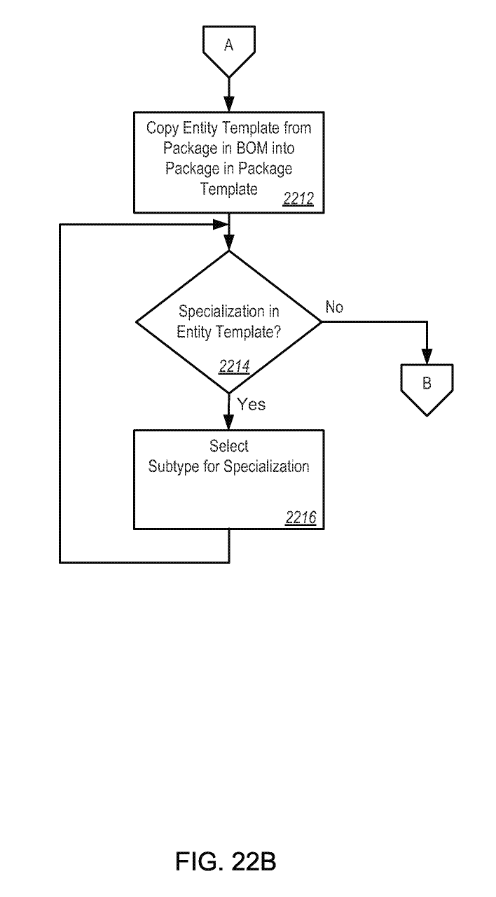

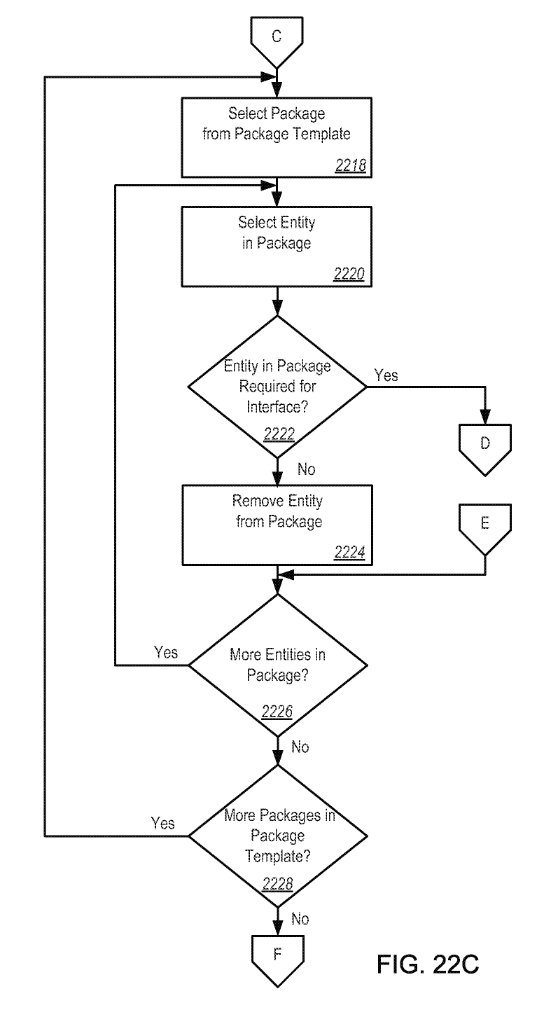

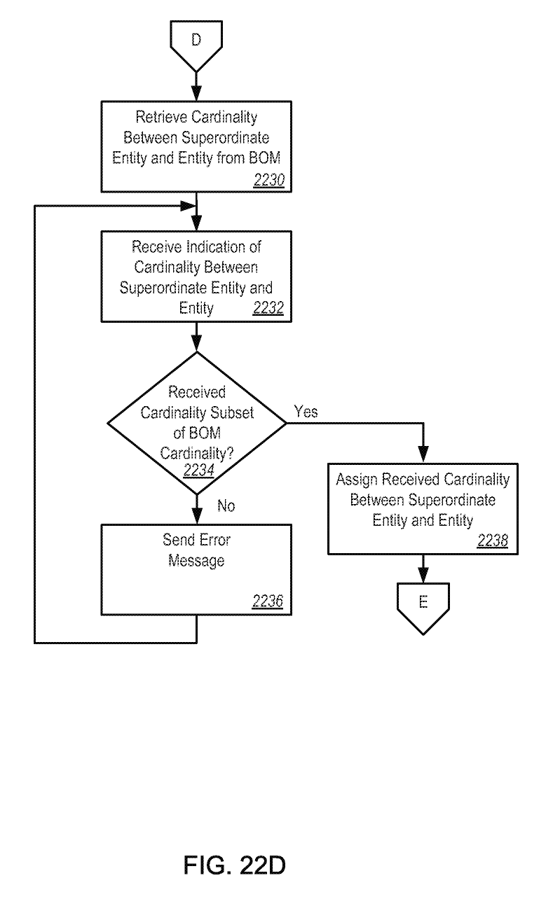

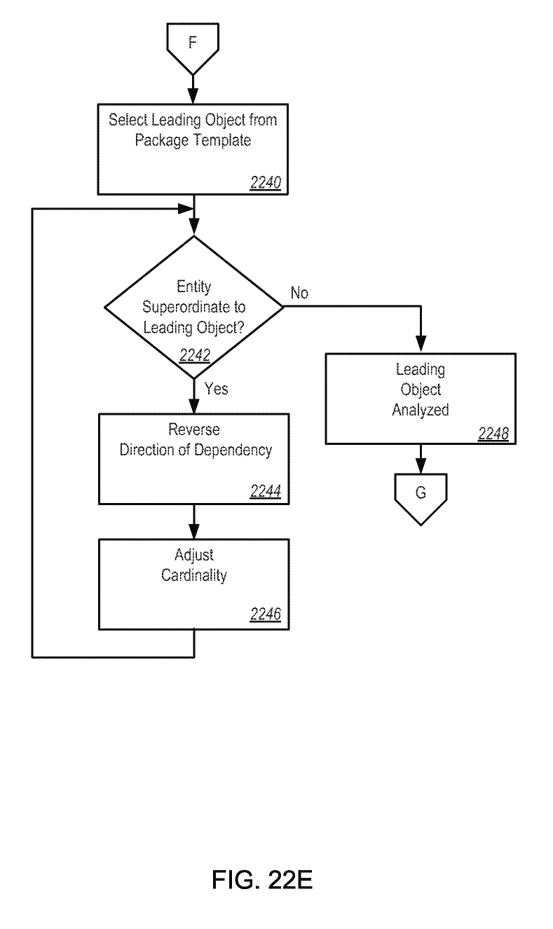

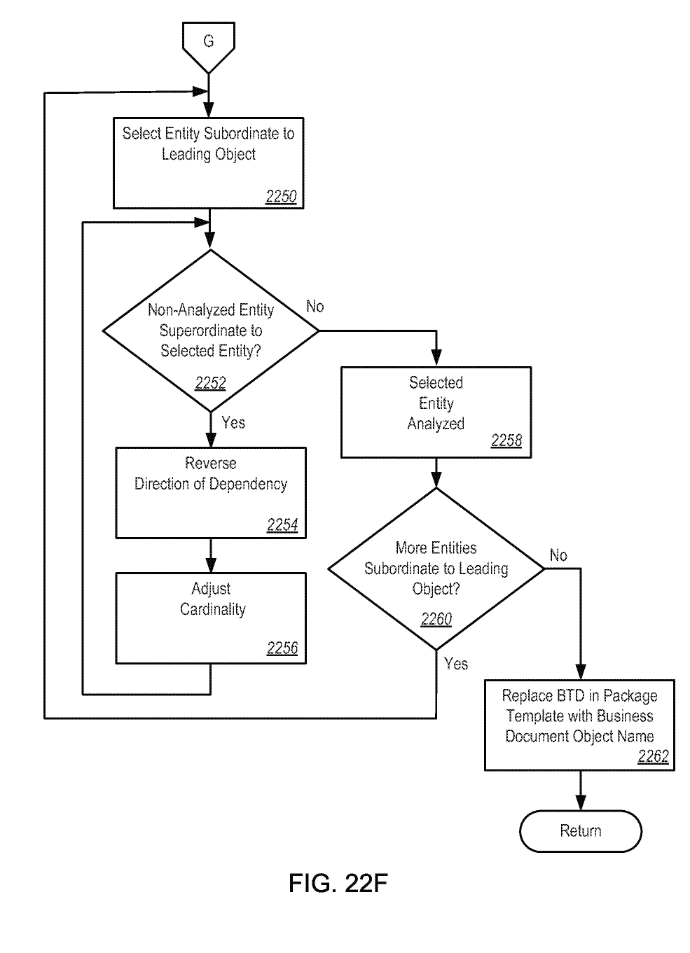

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

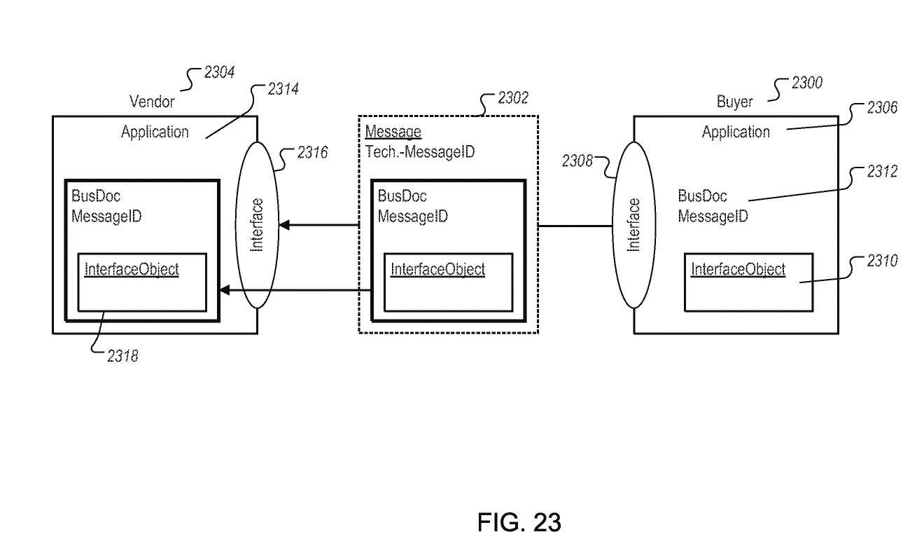

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

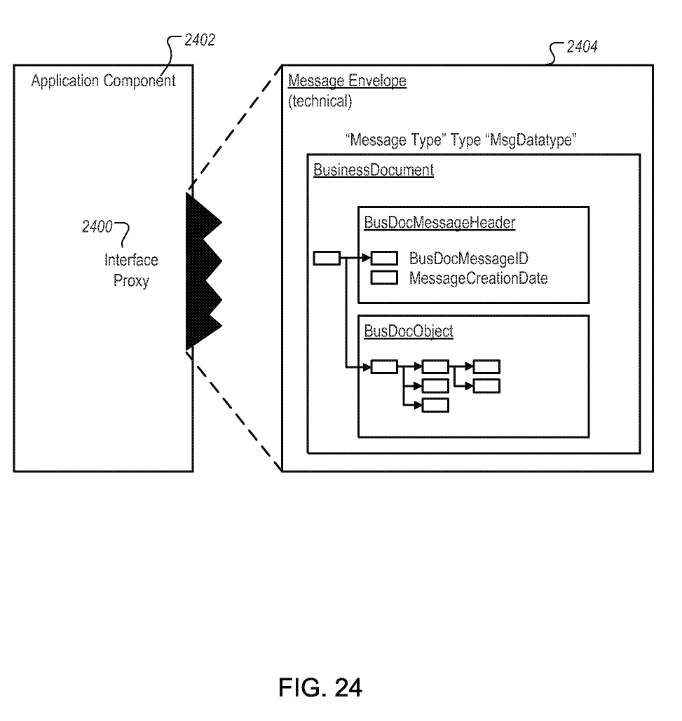

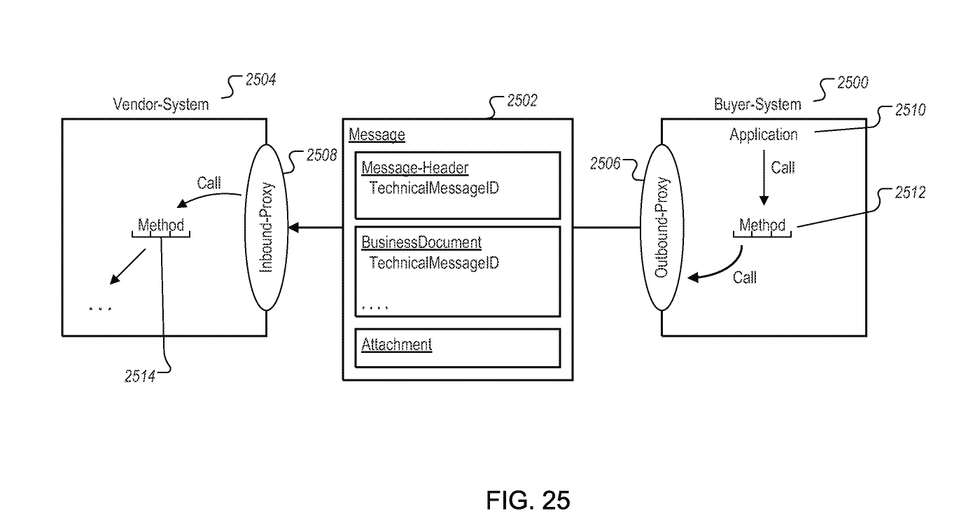

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

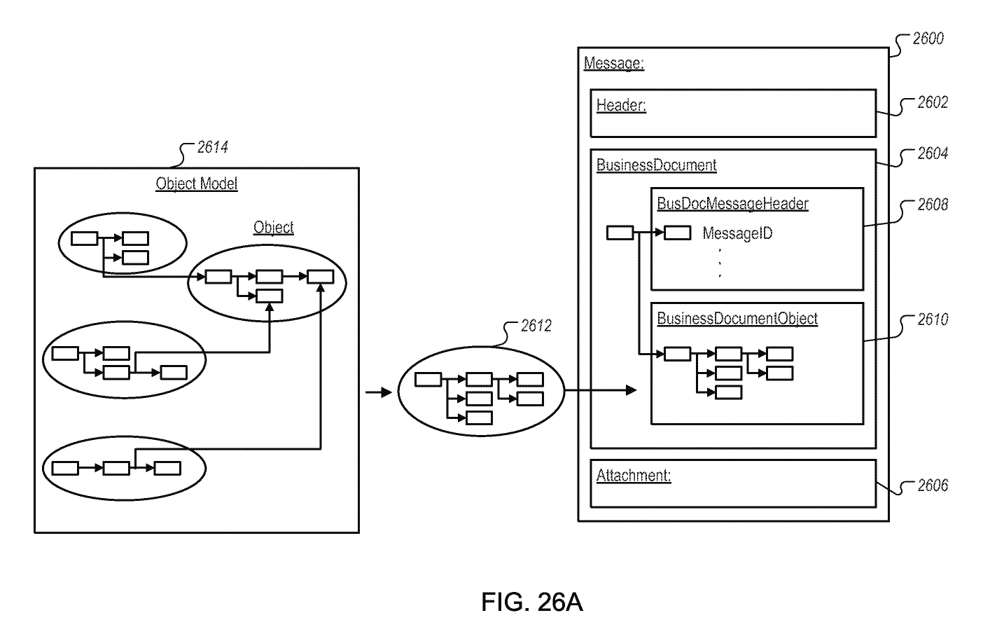

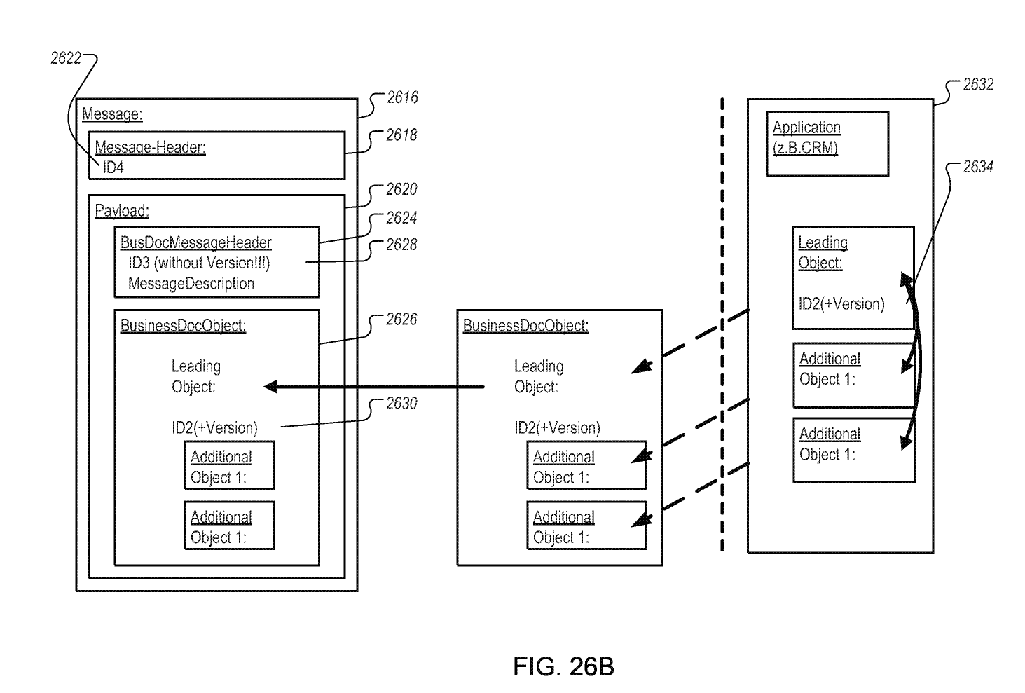

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

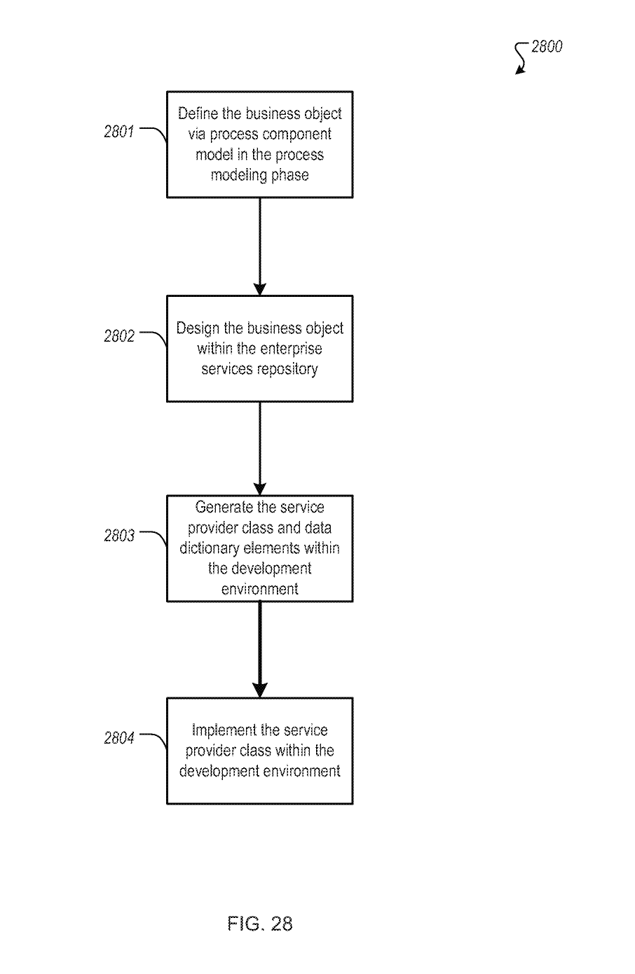

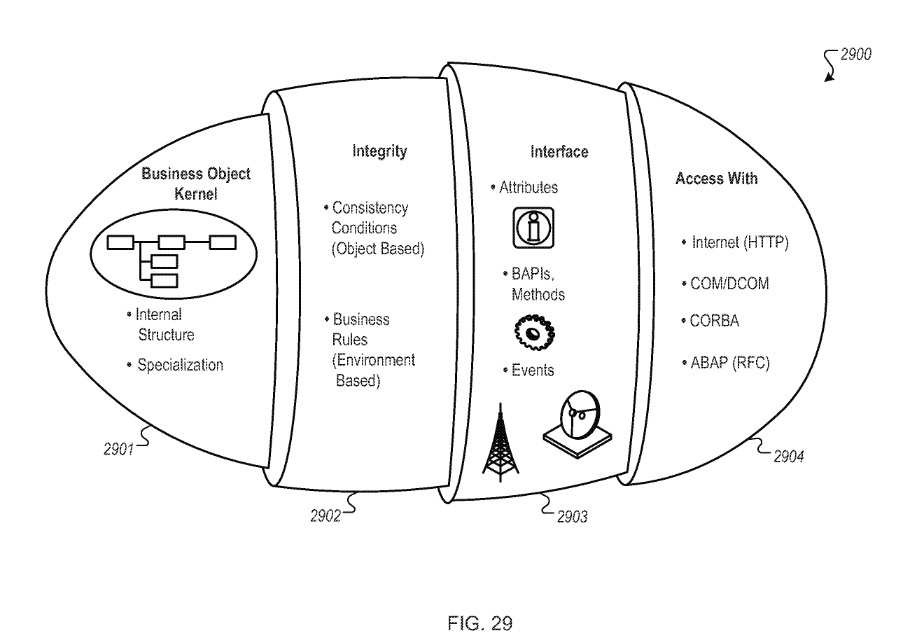

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

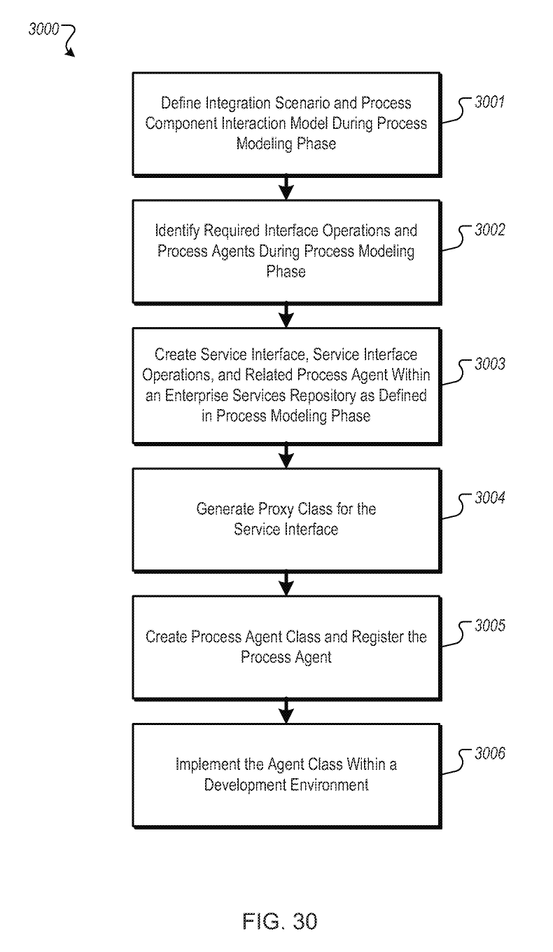

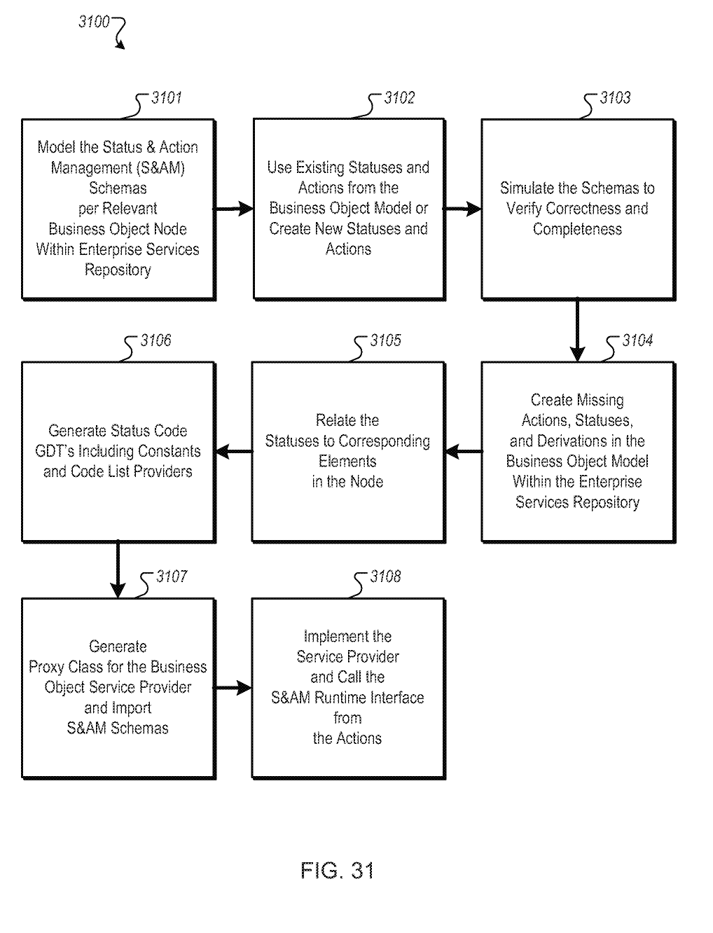

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

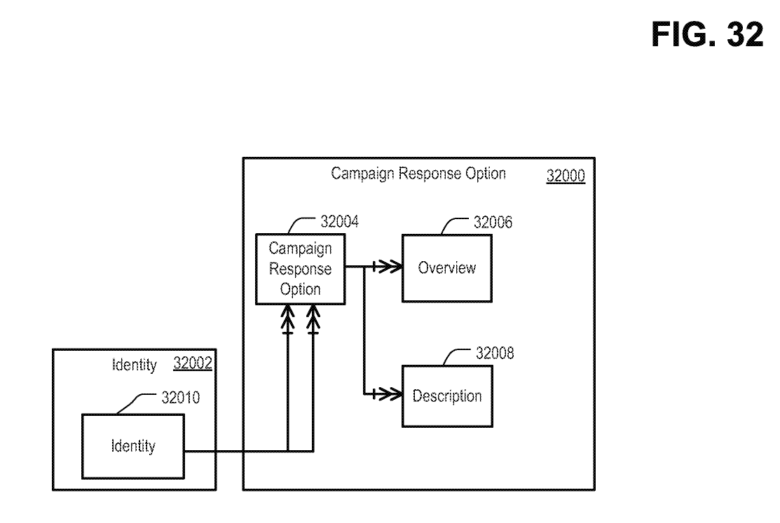

FIG. 32 illustrates an example object model for a Campaign Response Option business object 32000. Specifically, the object model depicts interactions among various components of the Campaign Response Option business object 32000, as well as external components that interact with the Campaign Response Option business object 32000 (shown here as 32002 and 32010). The Campaign Response Option business object 32000 includes elements 32004 through 32008. The elements 32004 through 32008 can be hierarchical, as depicted. For example, the Campaign Response Option entity 32004 hierarchically includes entities Overview 32006 and Description 32008. Some or all of the entities 32006 through 32008 can correspond to packages and/or entities in the message data types described below.

The business object Campaign Response Option is an option that specifies how a customer who has been contacted as part of a campaign can respond to that campaign. The business object Campaign Response Option includes identifying and administrative information as well as possible options to respond to a campaign. The Campaign Response

Option business object belongs to the process component Campaign Management. The Campaign Response Option business object belongs to the deployment unit Customer Relationship Management. A response option includes information that applies to an entire response option. The business object Campaign Response Option has an object category of Master Data Object and a technical category of Standard Business Object.

The business object Campaign Response Option includes a Root node. The elements located directly at the node Root are defined by the data type CampaignResponseOptionElements. These elements include: UUID, ID, CategoryCode, SystemAdministrativeData, and Status. Status may include Status/LifeCycleStatusCode. UUID may be an alternative key, is a globally unique identifier for a response option, and may be based on datatype GDT: UUID. ID may be an alternative key, is an identifier for a response option, and may be based on datatype GDT: ResponseOptionID. CategoryCode may be optional, is a coded representation of a response option category, and may be based on datatype GDT: ResponseOptionCategoryCode. SystemAdministrativeData may be optional, includes administrative data that is stored in a system, such as system users and change date/times, and may be based on datatype GDT: SystemAdministrativeData. Status is a status of a response option, and may be based on datatype BOIDT: Status. Status/LifeCycleStatusCode is a coded representation of the stages of the life cycle of a response option, and may be based on datatype GDT: ResponseOptionLifeCycleStatusCode.

The following composition relationships to subordinate nodes may exist: Overview, with a cardinality of 1:CN, in which composition may be disabled; and Description, with a cardinality of 1:CN, which may be a Text Composition. The following composition relationships to dependent objects exist: Text Collection, with a cardinality of 1:C, which is a collection of natural-language texts with additional information about a response option. The following inbound association relationships may exist: Creation Identity, from the business object Identity/node Identity, with a cardinality of 1:CN, which is an identity that has created a response option; and LastChangeIdentity, from the business object Identity/node Identity, with a cardinality of 1:CN, which is an identity that has changed a response option.

A Revoke Obsolescence action may be used to revoke the obsolence of a response option. In some implementations, the Response Option Life Cycle Status is “Obsolete” to enable the Revoke Obsolescence action. The action “Revoke Obsolence” sets the response option life cycle status from “Obsolete” to “Active”. The Revoke Obsolescence action may be called from a user interface or from another business object.

A Flag as Obsolete action may be used to mark a response option as obsolete. In some implementations, the Response Option Life Cycle Status is “Active” to enable the Flag as Obsolete action. The action “Flag as obsolete” sets the response option life cycle status from “Active” to “Obsolete”. The Flag as Obsolete action may be called from a user interface or from another business object.

A SelectAll query may be used to return the node identifiers of all instances of the root node and may be used to enable an initial load of data for a Fast Search Infrastructure. A Query By Elements query may be used to return a list of all response options according to specified selection elements. The query elements are defined by the data type ResponseOptionElementsQueryElements. These elements include: UUID, ID, CampaignID, CategoryCode, Description, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, LifeCycleStatusCode, and SearchText. UUID is a globally unique identifier for a response option, and may be based on datatype GDT: UUID. ID is an identifier for a response option, and may be based on datatype GDT: ResponseOptionID. CampaignID is an identifier for a campaign, and may be based on datatype GDT: BusinessTransactionDocumentID. CategoryCode is a coded representation of a response option category, and may be based on datatype GDT: ResponseOptionCategoryCode. Description is a description of a response option, and may be based on datatype GDT: MEDIUM_Description. SystemAdministrativeData includes administrative data that is stored in a system, such as system users and change date/times, and may be based on datatype GDT: SystemAdministrativeData. CreationBusinessPartnerCommonPersonNameGivenName is a given name of a business partner that created a response option, and may be based on datatype GDT: MEDIUM_Name. CreationBusinessPartnerCommonPersonNameFamilyName is a family name of a business partner that created a response option, and may be based on datatype GDT: MEDIUM_Name. LastChangeBusinessPartnerCommonPersonNameGivenName is a given name of a business partner that last changed a response option, and may be based on datatype GDT: MEDIUM_Name. LastChangeBusinessPartnerCommonPersonNameFamilyName is a family name of a business partner that last changed a response option, and may be based on datatype GDT: MEDIUM_Name. LifeCycleStatusCode is a coded representation of the stages of the life cycle of a response option, and may be based on datatype GDT: ResponseOptionLifeCycleStatusCode. SearchText includes free text including one or more words which may be used to search for information about a response option, and may be based on datatype GDT: SearchText.

The Overview Query Response Transformation node is an overview of a response option. The elements located directly at the node Overview are defined by the data type Campaign Response Option Overview Elements. These elements include: UUID, ID, CategoryCode, Description, CreationBusinessPartnerCommonPersonNameFormattedName, CreationBusinessPartnerUUID, CreationDateTime, LastChangeBusinessPartnerCommonPersonNameFormattedName, LastChangeBusinessPartnerUUID, LastChangeDateTime, and LifeCycleStatusCode. UUID is a globally unique identifier for a response option, and may be based on datatype GDT: UUID. ID may be optional, is an identifier for a response option, and may be based on datatype GDT: ResponseOptionID. CategoryCode may be optional, is a coded representation of a response option category, and may be based on datatype GDT: ResponseOptionCategoryCode. Description may be optional, is a description of a response option, and may be based on datatype GDT: MEDIUM_Description. CreationBusinessPartnerCommonPersonNameFormattedName may be optional, is a formatted name of a business partner who created a response option, and may be based on datatype GDT: LANGUAGEINDEPENDENT_LONG_Name. CreationBusinessPartnerUUID may be optional, is a globally unique identifier for a business partner who created a response option, and may be based on datatype GDT: UUID. CreationDateTime may be optional, is a point in time when a response option was created, and may be based on datatype GDT: GLOBAL_DateTime. LastChangeBusinessPartnerCommonPersonNameFormattedName may be optional, is a formatted name of a business partner who last changed a response option, and may be based on datatype GDT: LANGUAGEINDEPENDENT_LONG_Name. LastChangeBusinessPartnerUUID may be optional, is a globally unique identifier for a business partner who last changed a response option, and may be based on datatype GDT: UUID. LastChangeDateTime may be optional, is a point in time when a response option was last changed, and may be based on datatype GDT: GLOBAL_DateTime. LifeCycleStatusCode may be optional, is a coded representation of the stages of the life cycle of a response option, and may be based on datatype GDT: ResponseOptionLifeCycleStatusCode.

The following specialization associations for navigation may exist to the node Root: Parent, with a target cardinality of 1; and Root, with a target cardinality of 1. A QueryByElements query may be used to return a list of all response option overviews according to specified selection elements. The query elements are defined by the data type ResponseOptionOverviewElementsQueryElements. These elements include: UUID, ID, CampaignID, CategoryCode, Description, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, LifeCycleStatusCode, and SearchText.

UUID is a globally unique identifier for a response option overview, and may be based on datatype GDT: UUID. ID is an identifier for a response option overview, and may be based on datatype GDT: ResponseOptionID. CampaignID is an identifier for a campaign, and may be based on datatype GDT: BusinessTransactionDocumentID. CategoryCode is a coded representation of a response option category, and may be based on datatype GDT: ResponseOptionCategoryCode. Description is a description for a response option, and may be based on datatype GDT: MEDIUM_Description. SystemAdministrativeData includes administrative data that is stored in a system, such as system users and change date/times, and may be based on datatype GDT: SystemAdministrativeData. CreationBusinessPartnerCommonPersonNameGivenName is a given name of a business partner that created a response option, and may be based on datatype GDT: MEDIUM_Name. CreationBusinessPartnerCommonPersonNameFamilyName is a family name of a business partner that created a response option, and may be based on datatype GDT: MEDIUM_Name. LastChangeBusinessPartnerCommonPersonNameGivenName is a given name of a business partner that last changed a response option, and may be based on datatype GDT: MEDIUM_Name. LastChangeBusinessPartnerCommonPersonNameFamilyName is a family name of a business partner that last changed a response option, and may be based on datatype GDT: MEDIUM_Name. LifeCycleStatusCode is a coded representation of the stages of the life cycle of a response option, and may be based on datatype GDT: ResponseOptionLifeCycleStatusCode. SearchText includes free text including one or more words which may be used to search for information about a response option, and may be based on datatype GDT: SearchText.

The Description Text node includes language dependent descriptions for a response option. The elements located directly at the node Description are defined by the data type Campaign Response Option Description Elements. These elements include: Description. Description may be optional, is a description of a response option, and may be based on datatype GDT: MEDIUM_Description. The following specialization associations for navigation may exist to the node Root: Parent, with a target cardinality of 1; and Root, with a target cardinality of 1.

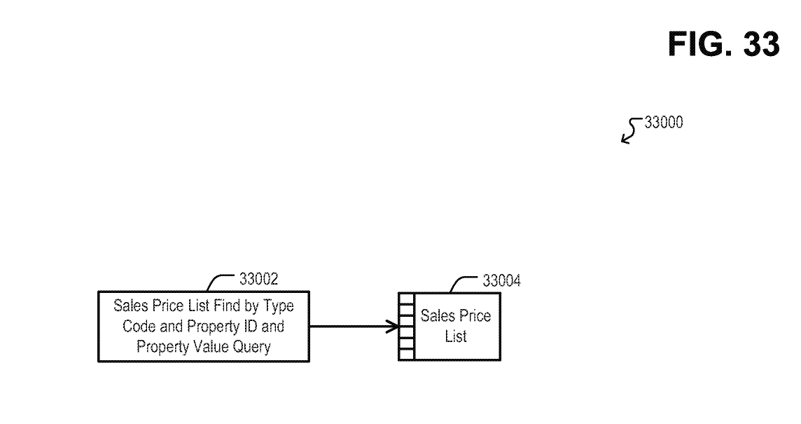

FIG. 33 illustrates one example logical configuration of a Sales Price List Find by Type Code and Property ID and Property Value Query message 33000. Specifically, this figure depicts the arrangement and hierarchy of various components such as one or more levels of packages, entities, and datatypes, shown here as 33002 through 33004. As described above, packages may be used to represent hierarchy levels. Entities are discrete business elements that are used during a business transaction. Data types are used to type object entities and interfaces with a structure. For example, the Sales Price List Find by Type Code and Property ID and Property Value Query message 33000 includes, among other things, a Sales Price List entity 33004. Accordingly, heterogeneous applications may communicate using this consistent message configured as such.

The message type Sales Price List Find by Type Code and Property ID and Property Value Query_sync is derived from the business object Sales Price List as a leading object together with its operation signature. The message type Sales Price List Find by Type Code and Property ID and Property Value Query_sync is a synchronous request for finding the sales price list by its type code and property ID and property value. The structure of the message type Sales Price List Find by Type Code and Property ID and Property Value Query_sync is determined by the message data type SalesPriceListFindByTypeCodeAndPropertyIDAndPropertyValueMessage. The message data type SalesPriceListFindByTypeCodeAndPropertyIDAndPropertyValueMessage includes the SalesPriceList package. The package SalesPriceList includes the entity SalesPriceList. SalesPriceList includes the following non-node elements: ID, ReleaseStatusCode, PriceSpecificationListReleaseStatusCode, ApprovalStatusCode, ConsistencyStatusCode, ValidityPeriod, CreationDateTimeInterval, LowerBoundaryDateTime, UpperBoundaryDateTime, LastChangedDatetimeInterval, TypeCode, PropertyValuationPriceSpecificationElementPropertyValuation1, PropertyValuationPriceSpecificationElementPropertyValuation2, PropertyValuationPriceSpecificationElementPropertyValuation3, PropertyValuationPriceSpecificationElementPropertyValuation4, PropertyValuationPriceSpecificationElementPropertyValuation5, PropertyValuationPriceSpecificationElementPropertyValuation6, PropertyValuationPriceSpecificationElementPropertyValuation7, PropertyValuationPriceSpecificationElementPropertyValuation8, PropertyValuationPriceSpecificationElementPropertyValuation9, PropertyValuationPriceSpecificationElementPropertyValuation10, PriceSpecificationPropertyValuationPriceSpecificationElementPropertyValuation 1, PriceSpecificationPropertyValuationPriceSpecificationElementPropertyValuation2, PriceSpecificationPropertyValuationPriceSpecificationElementPropertyValuation3, PriceSpecificationPropertyValuationPriceSpecificationElementPropertyValuation4, PriceSpecificationPropertyValuationPriceSpecificationElementPropertyValuation5, PriceSpecificationPropertyValuationPriceSpecificationElementPropertyValuation6, PriceSpecificationPropertyValuationPriceSpecificationElementPropertyValuation7, PriceSpecificationPropertyValuationPriceSpecificationElementPropertyValuation8, PriceSpecificationPropertyValuationPriceSpecificationElementPropertyValuation9, and PriceSpecificationPropertyValuationPriceSpecificationElementPropertyValuation10. CreationDateTimeInterval and LastChangedDatetimeInterval may each include LowerBoundaryDateTime and UpperBoundaryDateTime.

ID may have a multiplicity of 0 . . . 1 and may be based on datatype BGDT:SalesPriceListID. ReleaseStatusCode may have a multiplicity of 0 . . . 1 and may be based on datatype BGDT:ReleaseStatusCode. PriceSpecificationListReleaseStatusCode may have a multiplicity of 0 . . . 1 and may be based on datatype BGDT:ReleaseStatusCode. ApprovalStatusCode may have a multiplicity of 0 . . . 1 and may be based on datatype BGDT:ApprovalStatusCode. ConsistencyStatusCode may have a multiplicity of 0 . . . 1 and may be based on datatype BGDT:ConsistencyStatusCode. ValidityPeriod may have a multiplicity of 0 . . . 1 and may be based on datatype AGDT:TimePointPeriod. CreationDateTimeInterval may have a multiplicity of 0 . . . 1 and may be based on datatype MIDT:DateTimeInterval. LowerBoundaryDateTime may have a multiplicity of 0 . . . 1 and may be based on datatype CDT:GLOBAL_DateTime. UpperBoundaryDateTime may have a multiplicity of 0 . . . 1 and may be based on datatype CDT:GLOBAL_DateTime. LastChangedDatetimeInterval may have a multiplicity of 0 . . . 1 and may be based on datatype MIDT:DateTimeInterval. LowerBoundaryDateTime may have a multiplicity of 0 . . . 1 and may be based on datatype CDT:GLOBAL_DateTime. UpperBoundaryDateTime may have a multiplicity of 0 . . . 1 and may be based on datatype CDT:GLOBALDateTime. TypeCode may have a multiplicity of 0 . . . 1 and may be based on datatype BGDT:SalesPriceListTypeCode. PropertyValuationPriceSpecificationElementPropertyValuation1 may have a multiplicity of 0 . . . 1 and may be based on datatype AGDT:PriceSpecificationElementPropertyValuation. PropertyValuationPriceSpecificationElementPropertyValuation2 may have a multiplicity of 0 . . . 1 and may be based on datatype AGDT:PriceSpecificationElementPropertyValuation. PropertyValuationPriceSpecificationElementPropertyValuation3 may have a multiplicity of 0 . . . 1 and may be based on datatype AGDT:PriceSpecificationElementPropertyValuation. PropertyValuationPriceSpecificationElementPropertyValuation4 may have a multiplicity of 0 . . . 1 and may be based on datatype AGDT:PriceSpecificationElementPropertyValuation. PropertyValuationPriceSpecificationElementPropertyValuation5 may have a multiplicity of 0 . . . 1 and may be based on datatype AGDT:PriceSpecificationElementPropertyValuation. PropertyValuationPriceSpecificationElementPropertyValuation6 may have a multiplicity of 0 . . . 1 and may be based on datatype AGDT:PriceSpecificationElementPropertyValuation. PropertyValuationPriceSpecificationElementPropertyValuation7 may have a multiplicity of 0 . . . 1 and may be based on datatype AGDT:PriceSpecificationElementPropertyValuation. PropertyValuationPriceSpecificationElementPropertyValuation8 may have a multiplicity of 0 . . . 1 and may be based on datatype AGDT:PriceSpecificationElementPropertyValuation. PropertyValuationPriceSpecificationElementPropertyValuation9 may have a multiplicity of 0 . . . 1 and may be based on datatype AGDT:PriceSpecificationElementPropertyValuation. PropertyValuationPriceSpecificationElementPropertyValuation10 may have a multiplicity of 0 . . . 1 and may be based on datatype AGDT:PriceSpecificationElementPropertyValuation. PriceSpecificationPropertyValuationPriceSpecificationElementPropertyValuation1 may have a multiplicity of 0 . . . 1 and may be based on datatype AGDT:PriceSpecificationElementPropertyValuation. PriceSpecificationPropertyValuationPriceSpecificationElementPropertyValuation2 may have a multiplicity of 0 . . . 1 and may be based on datatype AGDT:PriceSpecificationElementPropertyValuation. PriceSpecificationPropertyValuationPriceSpecificationElementPropertyValuation3 may have a multiplicity of 0 . . . 1 and may be based on datatype AGDT:PriceSpecificationElementPropertyValuation. PriceSpecificationPropertyValuationPriceSpecificationElementPropertyValuation4 may have a multiplicity of 0 . . . 1 and may be based on datatype AGDT:PriceSpecificationElementPropertyValuation. PriceSpecificationPropertyValuationPriceSpecificationElementPropertyValuation5 may have a multiplicity of 0 . . . 1 and may be based on datatype AGDT:PriceSpecificationElementPropertyValuation. PriceSpecificationPropertyValuationPriceSpecificationElementPropertyValuation6 may have a multiplicity of 0 . . . 1 and may be based on datatype AGDT:PriceSpecificationElementPropertyValuation. PriceSpecificationPropertyValuationPriceSpecificationElementPropertyValuation7 may have a multiplicity of 0 . . . 1 and may be based on datatype AGDT:PriceSpecificationElementPropertyValuation. PriceSpecificationPropertyValuationPriceSpecificationElementPropertyValuation8 may have a multiplicity of 0 . . . 1 and may be based on datatype AGDT:PriceSpecificationElementPropertyValuation. PriceSpecificationPropertyValuationPriceSpecificationElementPropertyValuation9 may have a multiplicity of 0 . . . 1 and may be based on datatype AGDT:PriceSpecificationElementPropertyValuation. PriceSpecificationPropertyValuationPriceSpecificationElementPropertyValuation10 may have a multiplicity of 0 . . . 1 and may be based on datatype AGDT:PriceSpecificationElementPropertyValuation.

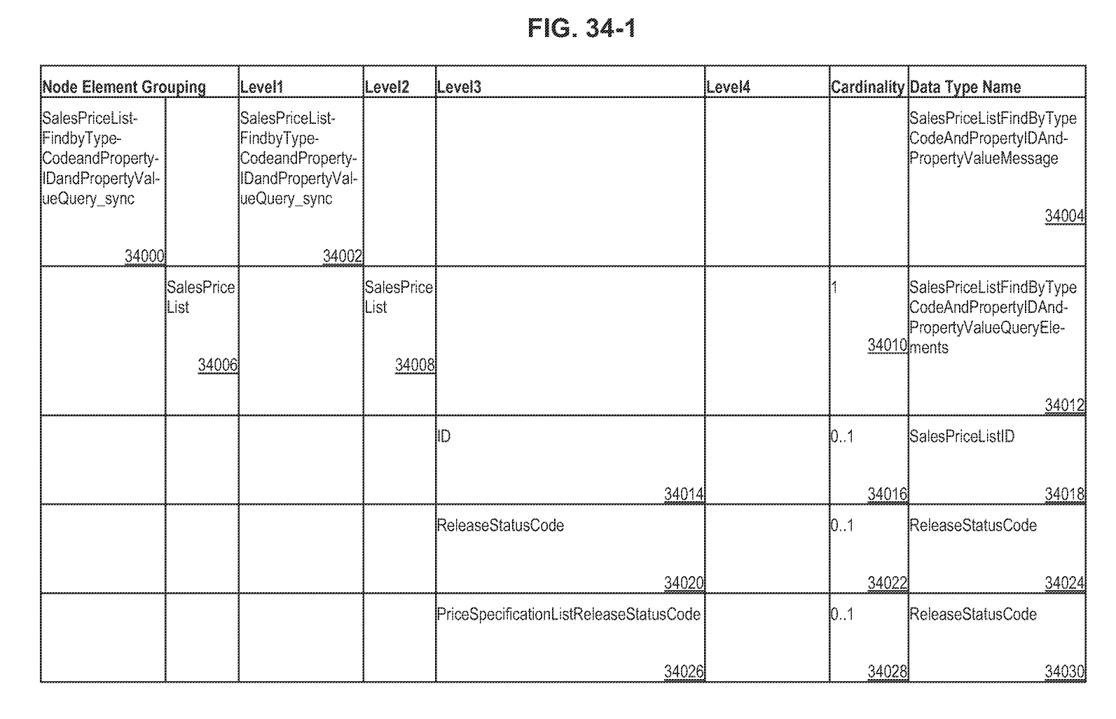

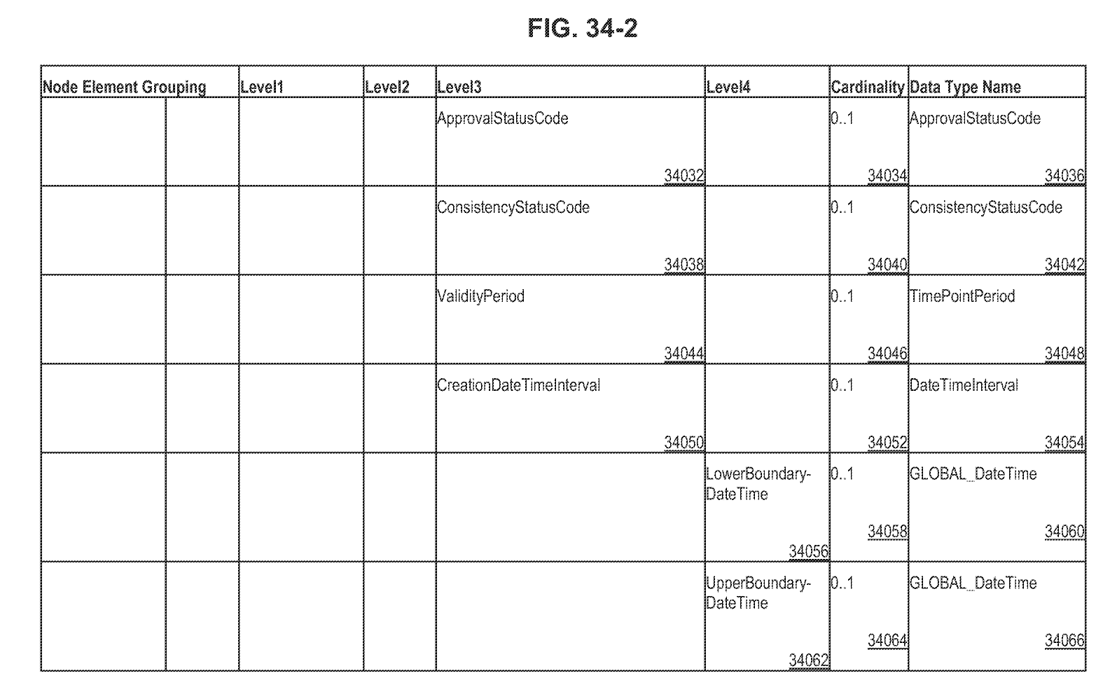

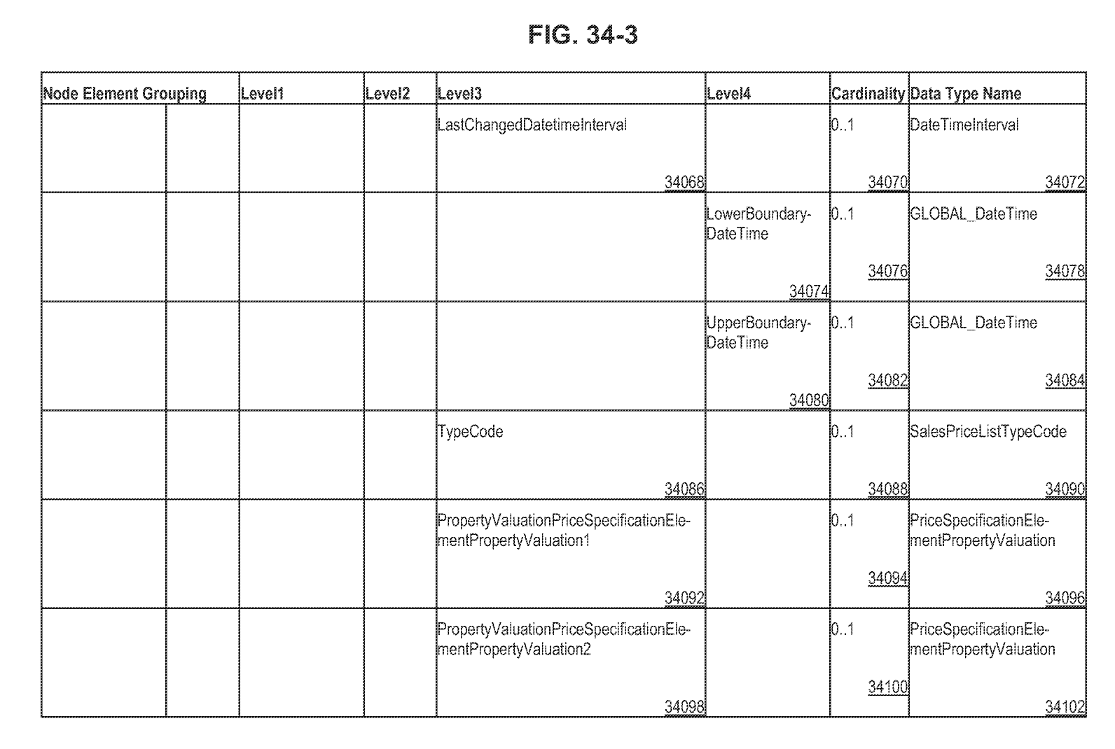

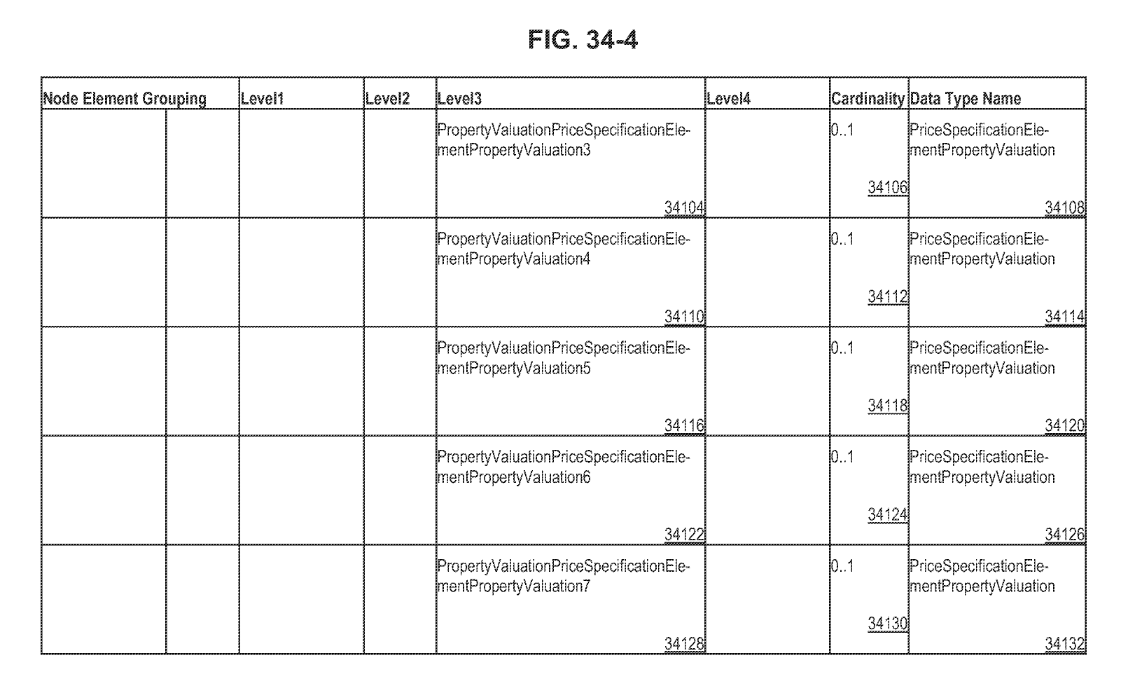

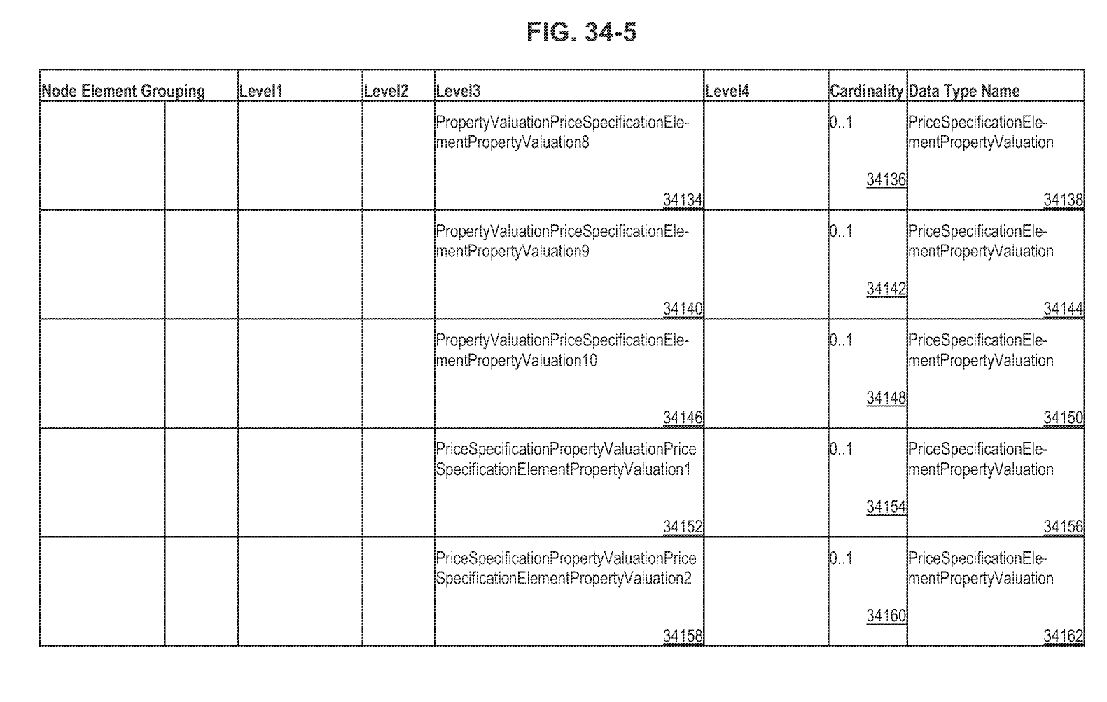

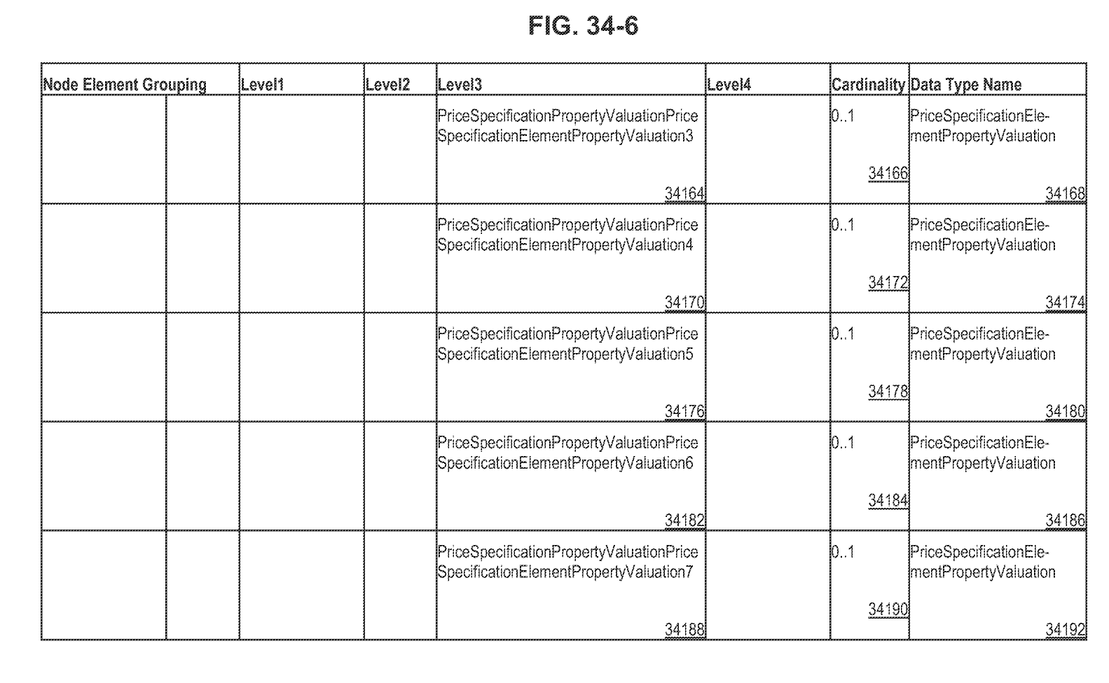

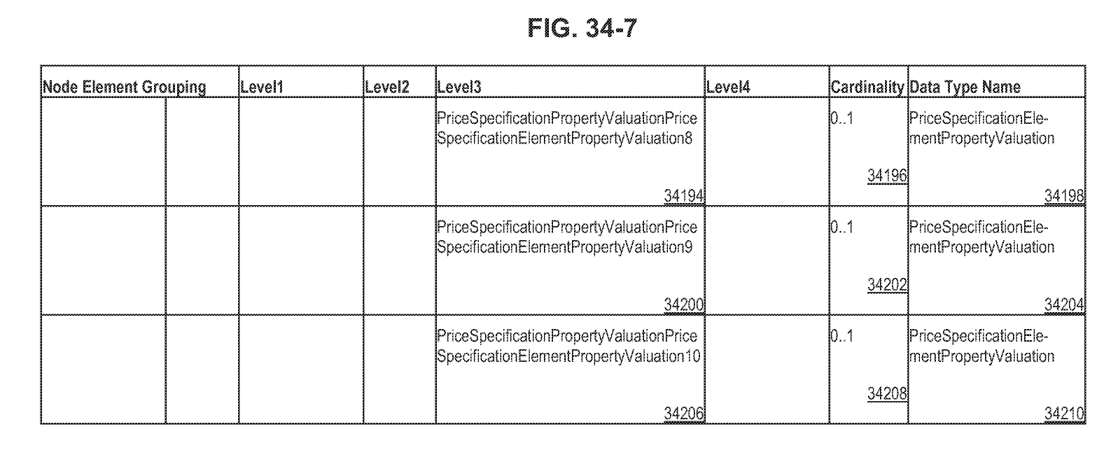

FIGS. 34-1 through 34-7 show an example configuration of an Element Structure that includes a SalesPriceListFindbyTypeCodeandPropertyIDandPropertyValueQuerysync 34000 node element grouping. Specifically, these figures depict the arrangement and hierarchy of various components such as one or more levels of node element groupings, entities, and datatypes, shown here as 34000 through 34210. As described above, node element groupings may be used to represent hierarchy levels. Entities are discrete business elements that are used during a business transaction. Data types are used to type object entities and interfaces with a structure. For example, the SalesPriceListFindbyTypeCodeandPropertyIDandPropertyValueQuerysync 34000 includes, among other things, a SalesPriceListFindbyTypeCodeandPropertyIDandPropertyValueQuerysync 34002. Accordingly, heterogeneous applications may communicate using this consistent message configured as such. The SalesPriceListFindbyTypeCodeandPropertyIDandPropertyValueQuerysync 34000 node element grouping is a SalesPriceListFindByTypeCodeAndPropertyIDAndPropertyValueMessage 34004 data type. The SalesPriceListFindbyTypeCodeandPropertyIDandPropertyValueQuery_sync 34000 node element grouping includes a SalesPriceListFindbyTypeCodeandPropertyIDandPropertyValueQuery_sync 34002 entity. The SalesPriceListFindbyTypeCodeandPropertyIDandPropertyValueQuery_sync 34000 node element grouping includes a SalesPriceList 34006 node element grouping.

The SalesPriceList 34006 node element grouping is a SalesPriceListFindByTypeCodeAndPropertyIDAndPropertyValueQueryElements 34012 data type. The SalesPriceList 34006 node element grouping includes a SalesPriceList 34008 entity.

The SalesPriceList 34008 entity has a cardinality of 1 34010 meaning that for each instance of the SalesPriceList 34006 node element grouping there is one SalesPriceList 34008 entity. The SalesPriceList 34008 entity includes various attributes, namely an ID 34014, a ReleaseStatusCode 34020, a PriceSpecificationListReleaseStatusCode 34026, an ApprovalStatusCode 34032, a ConsistencyStatusCode 34038, a ValidityPeriod 34044, a TypeCode 34086, a PropertyValuationPriceSpecificationElementPropertyValuation1 34092, a PropertyValuationPriceSpecificationElementPropertyValuation2 34098, a PropertyValuationPriceSpecificationElementPropertyValuation3 34104, a PropertyValuationPriceSpecificationElementPropertyValuation4 34110, a PropertyValuationPriceSpecificationElementPropertyValuation5 34116, a PropertyValuationPriceSpecificationElementPropertyValuation6 34122, a PropertyValuationPriceSpecificationElementPropertyValuation7 34128, a PropertyValuationPriceSpecificationElementPropertyValuation8 34134, a PropertyValuationPriceSpecificationElementPropertyValuation9 34140, a PropertyValuationPriceSpecificationElementPropertyValuation10 34146, a PriceSpecificationPropertyValuationPriceSpecificationElementPropertyValuation1 34152, a PriceSpecificationPropertyValuationPriceSpecificationElementPropertyValuation2 34158, a PriceSpecificationPropertyValuationPriceSpecificationElementPropertyValuation3 34164, a PriceSpecificationPropertyValuationPriceSpecificationElementPropertyValuation4 34170, a PriceSpecificationPropertyValuationPriceSpecificationElementPropertyValuation5 34176, a PriceSpecificationPropertyValuationPriceSpecificationElementPropertyValuation6 34182, a PriceSpecificationPropertyValuationPriceSpecificationElementPropertyValuation7 34188, a PriceSpecificationPropertyValuationPriceSpecificationElementPropertyValuation8 34194, a PriceSpecificationPropertyValuationPriceSpecificationElementPropertyValuation9 34200 and a PriceSpecificationPropertyValuationPriceSpecificationElementPropertyValuation10 34206. The SalesPriceList 34008 entity includes various subordinate entities, namely a CreationDateTimeInterval 34050 and a LastChangedDatetimeInterval 34068.

The ID 34014 attribute is a SalesPriceListID 34018 data type. The ID 34014 attribute has a cardinality of 0 . . . 1 34016 meaning that for each instance of the SalesPriceList 34008 entity there may be one ID 34014 attribute.

The ReleaseStatusCode 34020 attribute is a ReleaseStatusCode 34024 data type. The ReleaseStatusCode 34020 attribute has a cardinality of 0 . . . 1 34022 meaning that for each instance of the SalesPriceList 34008 entity there may be one ReleaseStatusCode 34020 attribute.

The PriceSpecificationListReleaseStatusCode 34026 attribute is a ReleaseStatusCode 34030 data type. The PriceSpecificationListReleaseStatusCode 34026 attribute has a cardinality of 0 . . . 1 34028 meaning that for each instance of the SalesPriceList 34008 entity there may be one PriceSpecificationListReleaseStatusCode 34026 attribute.

The ApprovalStatusCode 34032 attribute is an ApprovalStatusCode 34036 data type. The ApprovalStatusCode 34032 attribute has a cardinality of 0 . . . 1 34034 meaning that for each instance of the SalesPriceList 34008 entity there may be one ApprovalStatusCode 34032 attribute.

The ConsistencyStatusCode 34038 attribute is a ConsistencyStatusCode 34042 data type. The ConsistencyStatusCode 34038 attribute has a cardinality of 0 . . . 1 34040 meaning that for each instance of the SalesPriceList 34008 entity there may be one ConsistencyStatusCode 34038 attribute.

The ValidityPeriod 34044 attribute is a TimePointPeriod 34048 data type. The ValidityPeriod 34044 attribute has a cardinality of 0 . . . 1 34046 meaning that for each instance of the SalesPriceList 34008 entity there may be one ValidityPeriod 34044 attribute.

The TypeCode 34086 attribute is a SalesPriceListTypeCode 34090 data type. The TypeCode 34086 attribute has a cardinality of 0 . . . 1 34088 meaning that for each instance of the SalesPriceList 34008 entity there may be one TypeCode 34086 attribute.

The PropertyValuationPriceSpecificationElementPropertyValuation1 34092 attribute is a PriceSpecificationElementPropertyValuation 34096 data type. The PropertyValuationPriceSpecificationElementPropertyValuation1 34092 attribute has a cardinality of 0 . . . 1 34094 meaning that for each instance of the SalesPriceList 34008 entity there may be one PropertyValuationPriceSpecificationElementPropertyValuation1 34092 attribute.

The PropertyValuationPriceSpecificationElementPropertyValuation2 34098 attribute is a PriceSpecificationElementPropertyValuation 34102 data type. The PropertyValuationPriceSpecificationElementPropertyValuation2 34098 attribute has a cardinality of 0 . . . 1 34100 meaning that for each instance of the SalesPriceList 34008 entity there may be one PropertyValuationPriceSpecificationElementPropertyValuation2 34098 attribute.

The PropertyValuationPriceSpecificationElementPropertyValuation3 34104 attribute is a PriceSpecificationElementPropertyValuation 34108 data type. The PropertyValuationPriceSpecificationElementPropertyValuation3 34104 attribute has a cardinality of 0 . . . 1 34106 meaning that for each instance of the SalesPriceList 34008 entity there may be one PropertyValuationPriceSpecificationElementPropertyValuation3 34104 attribute.

The PropertyValuationPriceSpecificationElementPropertyValuation4 34110 attribute is a PriceSpecificationElementPropertyValuation 34114 data type. The PropertyValuationPriceSpecificationElementPropertyValuation4 34110 attribute has a cardinality of 0 . . . 1 34112 meaning that for each instance of the SalesPriceList 34008 entity there may be one PropertyValuationPriceSpecificationElementPropertyValuation4 34110 attribute.

The PropertyValuationPriceSpecificationElementPropertyValuation5 34116 attribute is a PriceSpecificationElementPropertyValuation 34120 data type. The PropertyValuationPriceSpecificationElementPropertyValuation5 34116 attribute has a cardinality of 0 . . . 1 34118 meaning that for each instance of the SalesPriceList 34008 entity there may be one PropertyValuationPriceSpecificationElementPropertyValuation5 34116 attribute.

The PropertyValuationPriceSpecificationElementPropertyValuation6 34122 attribute is a PriceSpecificationElementPropertyValuation 34126 data type. The PropertyValuationPriceSpecificationElementPropertyValuation6 34122 attribute has a cardinality of 0 . . . 1 34124 meaning that for each instance of the SalesPriceList 34008 entity there may be one PropertyValuationPriceSpecificationElementPropertyValuation6 34122 attribute.

The PropertyValuationPriceSpecificationElementPropertyValuation7 34128 attribute is a PriceSpecificationElementPropertyValuation 34132 data type. The PropertyValuationPriceSpecificationElementPropertyValuation7 34128 attribute has a cardinality of 0 . . . 1 34130 meaning that for each instance of the SalesPriceList 34008 entity there may be one PropertyValuationPriceSpecificationElementPropertyValuation7 34128 attribute.

The PropertyValuationPriceSpecificationElementPropertyValuation8 34134 attribute is a PriceSpecificationElementPropertyValuation 34138 data type. The PropertyValuationPriceSpecificationElementPropertyValuation8 34134 attribute has a cardinality of 0 . . . 1 34136 meaning that for each instance of the SalesPriceList 34008 entity there may be one PropertyValuationPriceSpecificationElementPropertyValuation8 34134 attribute.

The PropertyValuationPriceSpecificationElementPropertyValuation9 34140 attribute is a PriceSpecificationElementPropertyValuation 34144 data type. The PropertyValuationPriceSpecificationElementPropertyValuation9 34140 attribute has a cardinality of 0 . . . 1 34142 meaning that for each instance of the SalesPriceList 34008 entity there may be one PropertyValuationPriceSpecificationElementPropertyValuation9 34140 attribute.

The PropertyValuationPriceSpecificationElementPropertyValuation10 34146 attribute is a PriceSpecificationElementPropertyValuation 34150 data type. The PropertyValuationPriceSpecificationElementPropertyValuation10 34146 attribute has a cardinality of 0 . . . 1 34148 meaning that for each instance of the SalesPriceList 34008 entity there may be one PropertyValuationPriceSpecificationElementPropertyValuation10 34146 attribute.

The PriceSpecificationPropertyValuationPriceSpecificationElementPropertyValuation1 34152 attribute is a PriceSpecificationElementPropertyValuation 34156 data type. The PriceSpecificationPropertyValuationPriceSpecificationElementPropertyValuation1 34152 attribute has a cardinality of 0 . . . 1 34154 meaning that for each instance of the SalesPriceList 34008 entity there may be one PriceSpecificationPropertyValuationPriceSpecificationElementPropertyValuation1 34152 attribute.

The PriceSpecificationPropertyValuationPriceSpecificationElementPropertyValuation2 34158 attribute is a PriceSpecificationElementPropertyValuation 34162 data type. The PriceSpecificationPropertyValuationPriceSpecificationElementPropertyValuation2 34158 attribute has a cardinality of 0 . . . 1 34160 meaning that for each instance of the SalesPriceList 34008 entity there may be one PriceSpecificationPropertyValuationPriceSpecificationElementPropertyValuation2 34158 attribute.

The PriceSpecificationPropertyValuationPriceSpecificationElementPropertyValuation3 34164 attribute is a PriceSpecificationElementPropertyValuation 34168 data type. The PriceSpecificationPropertyValuationPriceSpecificationElementPropertyValuation3 34164 attribute has a cardinality of 0 . . . 1 34166 meaning that for each instance of the SalesPriceList 34008 entity there may be one PriceSpecificationPropertyValuationPriceSpecificationElementPropertyValuation3 34164 attribute.

The PriceSpecificationPropertyValuationPriceSpecificationElementPropertyValuation4 34170 attribute is a PriceSpecificationElementPropertyValuation 34174 data type. The PriceSpecificationPropertyValuationPriceSpecificationElementPropertyValuation4 34170 attribute has a cardinality of 0 . . . 1 34172 meaning that for each instance of the SalesPriceList 34008 entity there may be one PriceSpecificationPropertyValuationPriceSpecificationElementPropertyValuation4 34170 attribute.

The PriceSpecificationPropertyValuationPriceSpecificationElementPropertyValuation5 34176 attribute is a PriceSpecificationElementPropertyValuation 34180 data type. The PriceSpecificationPropertyValuationPriceSpecificationElementPropertyValuation5 34176 attribute has a cardinality of 0 . . . 1 34178 meaning that for each instance of the SalesPriceList 34008 entity there may be one PriceSpecificationPropertyValuationPriceSpecificationElementPropertyValuation5 34176 attribute.

The PriceSpecificationPropertyValuationPriceSpecificationElementPropertyValuation6 34182 attribute is a PriceSpecificationElementPropertyValuation 34186 data type. The PriceSpecificationPropertyValuationPriceSpecificationElementPropertyValuation6 34182 attribute has a cardinality of 0 . . . 1 34184 meaning that for each instance of the SalesPriceList 34008 entity there may be one PriceSpecificationPropertyValuationPriceSpecificationElementPropertyValuation6 34182 attribute.

The PriceSpecificationPropertyValuationPriceSpecificationElementPropertyValuation7 34188 attribute is a PriceSpecificationElementPropertyValuation 34192 data type. The PriceSpecificationPropertyValuationPriceSpecificationElementPropertyValuation7 34188 attribute has a cardinality of 0 . . . 1 34190 meaning that for each instance of the SalesPriceList 34008 entity there may be one PriceSpecificationPropertyValuationPriceSpecificationElementPropertyValuation7 34188 attribute.

The PriceSpecificationPropertyValuationPriceSpecificationElementPropertyValuation8 34194 attribute is a PriceSpecificationElementPropertyValuation 34198 data type. The PriceSpecificationPropertyValuationPriceSpecificationElementPropertyValuation8 34194 attribute has a cardinality of 0 . . . 1 34196 meaning that for each instance of the SalesPriceList 34008 entity there may be one PriceSpecificationPropertyValuationPriceSpecificationElementPropertyValuation8 34194 attribute.

The PriceSpecificationPropertyValuationPriceSpecificationElementPropertyValuation9 34200 attribute is a PriceSpecificationElementPropertyValuation 34204 data type. The PriceSpecificationPropertyValuationPriceSpecificationElementPropertyValuation9 34200 attribute has a cardinality of 0 . . . 1 34202 meaning that for each instance of the SalesPriceList 34008 entity there may be one PriceSpecificationPropertyValuationPriceSpecificationElementPropertyValuation9 34200 attribute.

The PriceSpecificationPropertyValuationPriceSpecificationElementPropertyValuation10 34206 attribute is a PriceSpecificationElementPropertyValuation 34210 data type. The PriceSpecificationPropertyValuationPriceSpecificationElementPropertyValuation10 34206 attribute has a cardinality of 0 . . . 1 34208 meaning that for each instance of the SalesPriceList 34008 entity there may be one PriceSpecificationPropertyValuationPriceSpecificationElementPropertyValuation10 34206 attribute.

The CreationDateTimeInterval 34050 entity has a cardinality of 0 . . . 1 34052 meaning that for each instance of the SalesPriceList 34008 entity there may be one CreationDateTimeInterval 34050 entity. The CreationDateTimeInterval 34050 entity includes various attributes, namely a LowerBoundaryDateTime 34056 and an UpperBoundaryDateTime 34062.

The LowerBoundaryDateTime 34056 attribute is a GLOBAL_DateTime 34060 data type. The LowerBoundaryDateTime 34056 attribute has a cardinality of 0 . . . 1 34058 meaning that for each instance of the CreationDateTimeInterval 34050 entity there may be one LowerBoundaryDateTime 34056 attribute.

The UpperBoundaryDateTime 34062 attribute is a GLOBAL_DateTime 34066 data type. The UpperBoundaryDateTime 34062 attribute has a cardinality of 0 . . . 1 34064 meaning that for each instance of the CreationDateTimeInterval 34050 entity there may be one UpperBoundaryDateTime 34062 attribute.

The LastChangedDatetimeInterval 34068 entity has a cardinality of 0 . . . 1 34070 meaning that for each instance of the SalesPriceList 34008 entity there may be one LastChangedDatetimeInterval 34068 entity. The LastChangedDatetimeInterval 34068 entity includes various attributes, namely a LowerBoundaryDateTime 34074 and an UpperBoundaryDateTime 34080.

The LowerBoundaryDateTime 34074 attribute is a GLOBAL_DateTime 34078 data type. The LowerBoundaryDateTime 34074 attribute has a cardinality of 0 . . . 1 34076 meaning that for each instance of the LastChangedDatetimeInterval 34068 entity there may be one LowerBoundaryDateTime 34074 attribute.

The UpperBoundaryDateTime 34080 attribute is a GLOBAL_DateTime 34084 data type. The UpperBoundaryDateTime 34080 attribute has a cardinality of 0 . . . 1 34082 meaning that for each instance of the LastChangedDatetimeInterval 34068 entity there may be one UpperBoundaryDateTime 34080 attribute.

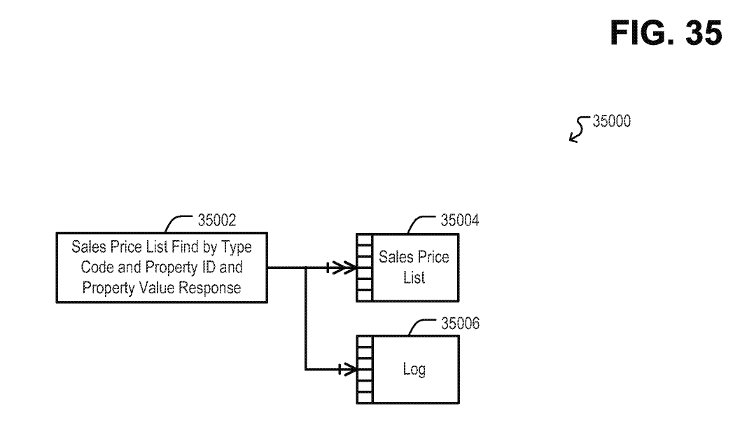

FIG. 35 illustrates one example logical configuration of a Sales Price List Find by Type Code and Property ID and Property Value Response message 35000. Specifically, this figure depicts the arrangement and hierarchy of various components such as one or more levels of packages, entities, and datatypes, shown here as 35002 through 35006. As described above, packages may be used to represent hierarchy levels. Entities are discrete business elements that are used during a business transaction. Data types are used to type object entities and interfaces with a structure. For example, the Sales Price List Find by Type Code and Property ID and Property Value Response message 35000 includes, among other things, Sales Price List entity 35004. Accordingly, heterogeneous applications may communicate using this consistent message configured as such.

The message type Sales Price List Find by Type Code and Property ID and Property Value Response_sync is derived from the business object Sales Price List as a leading object together with its operation signature. The message type Sales Price List Find by Type Code and Property ID and Property Value Response_sync is a synchronous response for finding a sales price list by its type code and property ID and property value. The structure of the message type Sales Price List Find by Type Code and Property ID and Property Value Response_sync is determined by the message data type SalesPriceListFindByTypeCodeAndPropertyIDAndPropertyValueResponseMessage. The message data type SalesPriceListFindByTypeCodeAndPropertyIDAndPropertyValueResponseMessage includes the SalesPriceList package and the Log package.

The package SalesPriceList includes the entity SalesPriceList. SalesPriceList includes the following non-node elements: UUID, ID, Status, ReleaseStatusCode, Release, PriceSpecificationListReleaseStatusCode, ConsistencyStatusCode, ApprovalStatusCode, PropertyValueSearchText, TypeCode, CurrencyCode, ValidityPeriod, SystemAdministrativeData, and NotReleasedPriceSpecificationElementslntegerValue. UUID may have a multiplicity of 1 and may be based on datatype BGDT:UUID. ID may have a multiplicity of 1 and may be based on datatype BGDT:SalesPriceListID. Status may have a multiplicity of 1 and may be based on datatype BOIDT:SalesPriceListStatus. ReleaseStatusCode may have a multiplicity of 1, is a release status, and may be based on datatype BGDT:ReleaseStatusCode. PriceSpecificationListReleaseStatusCode may have a multiplicity of 1, is a release status of a price specification, and may be based on datatype BGDT:ReleaseStatusCode. ConsistencyStatusCode may have a multiplicity of 1, is an error status, and may be based on datatype BGDT:ConsistencyStatusCode. ApprovalStatusCode may have a multiplicity of 1, is an approval status, and may be based on datatype BGDT:ApprovalStatusCode. PropertyValueSearchText may have a multiplicity of 0 . . . 1 and may be based on datatype BGDT:SearchText. TypeCode may have a multiplicity of 1 and may be based on datatype BGDT:SalesPriceListTypeCode. CurrencyCode may have a multiplicity of 1 and may be based on datatype BGDT:CurrencyCode. ValidityPeriod may have a multiplicity of 1 and may be based on datatype AGDT:TimePointPeriod. SystemAdministrativeData may have a multiplicity of 1 and may be based on datatype AGDT:SystemAdministrativeData. NotReleasedPriceSpecificationElementsIntegerValue may have a multiplicity of 1 and may be based on datatype BGDT:IntegerValue. The package Log includes the entity Log, which may be typed by datatype Log.

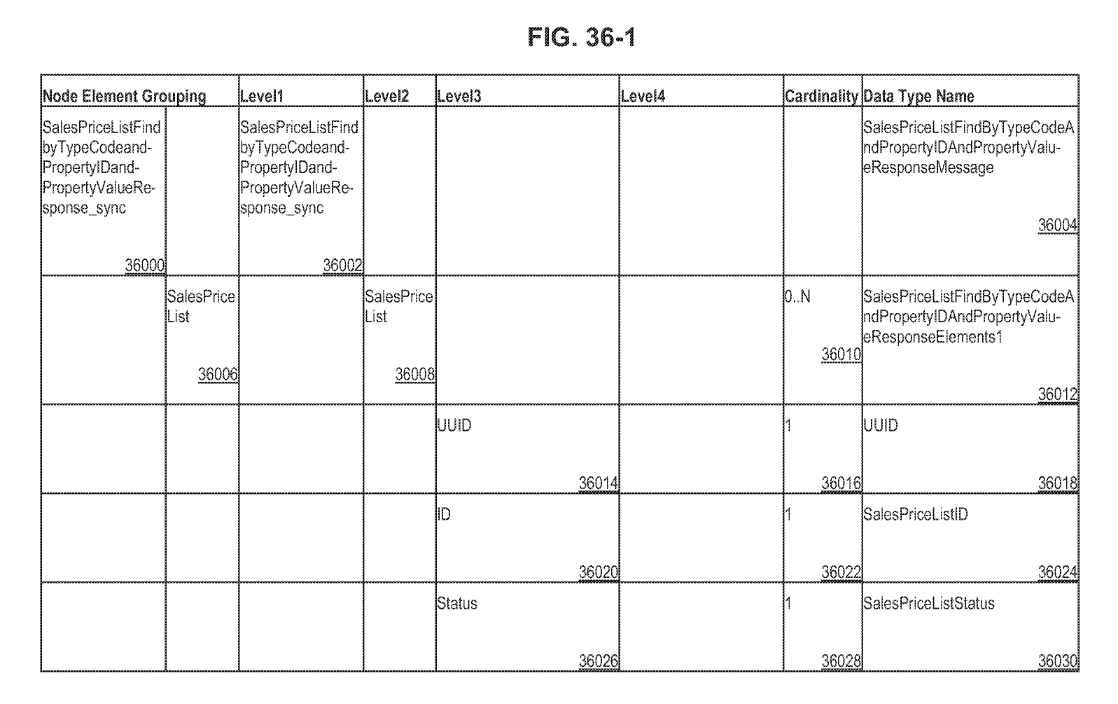

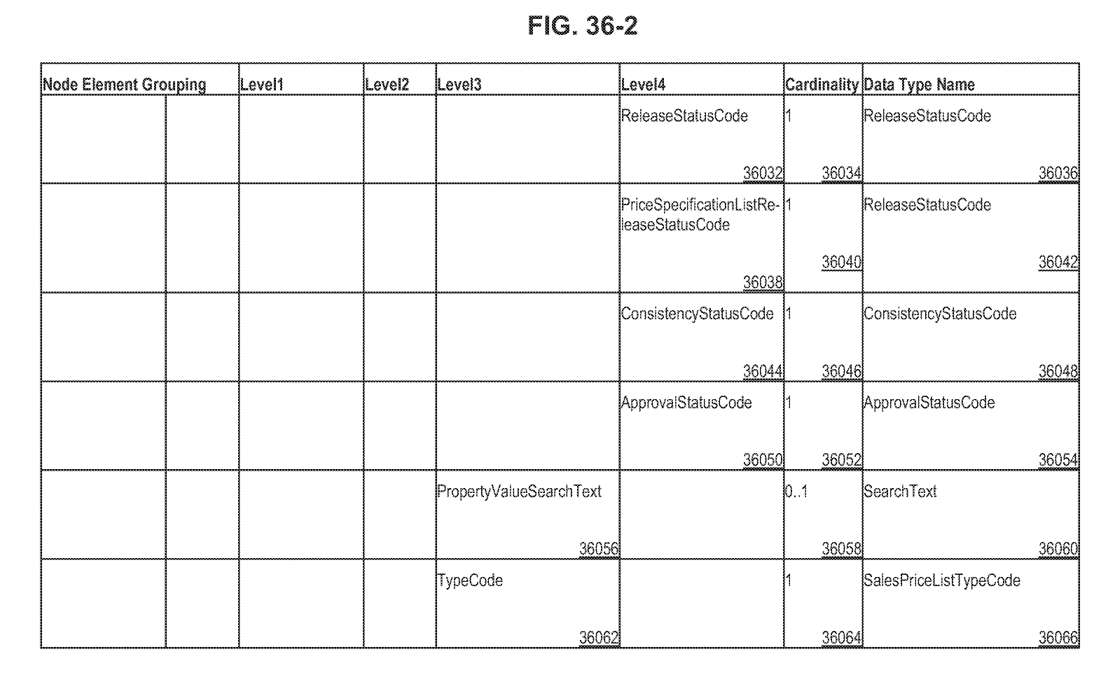

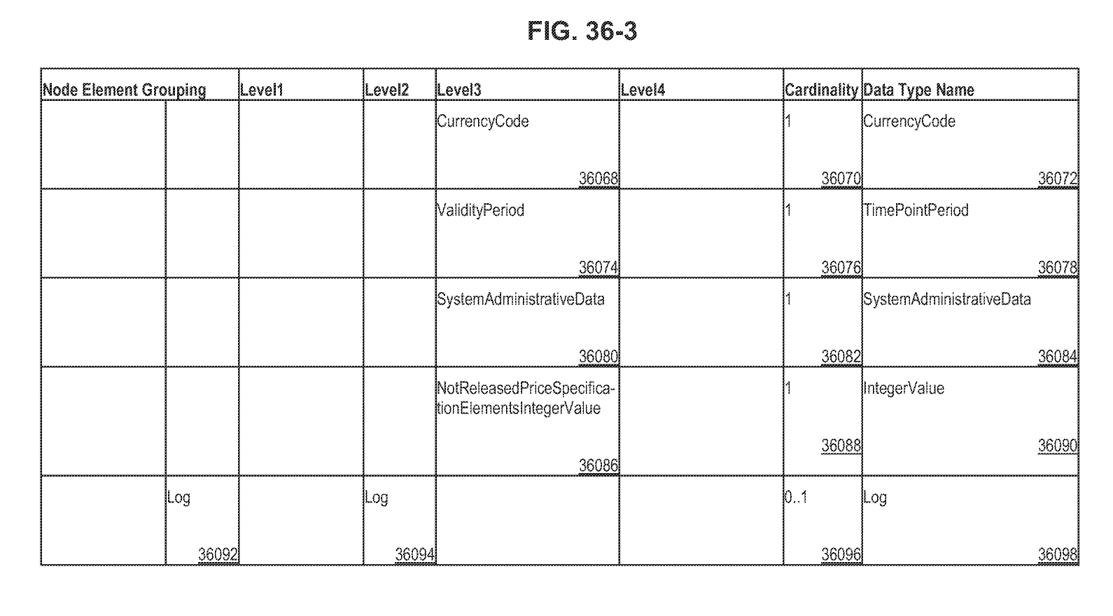

FIGS. 36-1 through 36-3 show an example configuration of an Element Structure that includes a SalesPriceListFindbyTypeCodeandPropertyIDandPropertyValueResponse_sync 36000 node element grouping. Specifically, these figures depict the arrangement and hierarchy of various components such as one or more levels of node element groupings, entities, and datatypes, shown here as 36000 through 36098. As described above, node element groupings may be used to represent hierarchy levels. Entities are discrete business elements that are used during a business transaction. Data types are used to type object entities and interfaces with a structure. For example, the SalesPriceListFindbyTypeCodeandPropertyIDandPropertyValueResponse_sync 36000 includes, among other things, a SalesPriceListFindbyTypeCodeandPropertyIDandPropertyValueResponse_sync 36002. Accordingly, heterogeneous applications may communicate using this consistent message configured as such.

The SalesPriceListFindbyTypeCodeandPropertyIDandPropertyValueResponse_sync 36000 node element grouping is a SalesPriceListFindByTypeCodeAndPropertyIDAndPropertyValueResponseMessage 36004 data type. The SalesPriceListFindbyTypeCodeandPropertyIDandPropertyValueResponse_sync 36000 node element grouping includes a SalesPriceListFindbyTypeCodeandPropertyIDandPropertyValueResponse_sync 36002 entity. The SalesPriceListFindbyTypeCodeandPropertyIDandPropertyValueResponse_sync 36000 node element grouping includes various node element groupings, namely a SalesPriceList 36006 and a Log 36092.

The SalesPriceList 36006 node element grouping is a SalesPriceListFindByTypeCodeAndPropertyIDAndPropertyValueResponseElements1 36012 data type. The SalesPriceList 36006 node element grouping includes a SalesPriceList 36008 entity.

The SalesPriceList 36008 entity has a cardinality of 0 . . . N 36010 meaning that for each instance of the SalesPriceList 36006 node element grouping there may be one or more SalesPriceList 36008 entities. The SalesPriceList 36008 entity includes various attributes, namely an UUID 36014, an ID 36020, a PropertyValueSearchText 36056, a TypeCode 36062, a CurrencyCode 36068, a ValidityPeriod 36074, a SystemAdministrativeData 36080 and a NotReleasedPriceSpecificationElementslntegerValue 36086. The SalesPriceList 36008 entity includes a Status 36026 subordinate entity.

The UUID 36014 attribute is an UUID 36018 data type. The UUID 36014 attribute has a cardinality of 1 36016 meaning that for each instance of the SalesPriceList 36008 entity there is one UUID 36014 attribute.

The ID 36020 attribute is a SalesPriceListID 36024 data type. The ID 36020 attribute has a cardinality of 1 36022 meaning that for each instance of the SalesPriceList 36008 entity there is one ID 36020 attribute.

The PropertyValueSearchText 36056 attribute is a SearchText 36060 data type. The PropertyValueSearchText 36056 attribute has a cardinality of 0 . . . 1 36058 meaning that for each instance of the SalesPriceList 36008 entity there may be one PropertyValueSearchText 36056 attribute.

The TypeCode 36062 attribute is a SalesPriceListTypeCode 36066 data type. The TypeCode 36062 attribute has a cardinality of 1 36064 meaning that for each instance of the SalesPriceList 36008 entity there is one TypeCode 36062 attribute.

The CurrencyCode 36068 attribute is a CurrencyCode 36072 data type. The CurrencyCode 36068 attribute has a cardinality of 1 36070 meaning that for each instance of the SalesPriceList 36008 entity there is one CurrencyCode 36068 attribute.

The ValidityPeriod 36074 attribute is a TimePointPeriod 36078 data type. The ValidityPeriod 36074 attribute has a cardinality of 1 36076 meaning that for each instance of the SalesPriceList 36008 entity there is one ValidityPeriod 36074 attribute.

The SystemAdministrativeData 36080 attribute is a SystemAdministrativeData 36084 data type. The SystemAdministrativeData 36080 attribute has a cardinality of 1 36082 meaning that for each instance of the SalesPriceList 36008 entity there is one SystemAdministrativeData 36080 attribute.

The NotReleasedPriceSpecificationElementsIntegerValue 36086 attribute is an IntegerValue 36090 data type. The NotReleasedPriceSpecificationElementslntegerValue 36086 attribute has a cardinality of 1 36088 meaning that for each instance of the SalesPriceList 36008 entity there is one NotReleasedPriceSpecificationElementslntegerValue 36086 attribute.

The Status 36026 entity has a cardinality of 1 36028 meaning that for each instance of the SalesPriceList 36008 entity there is one Status 36026 entity. The Status 36026 entity includes various attributes, namely a ReleaseStatusCode 36032, a PriceSpecificationListReleaseStatusCode 36038, a ConsistencyStatusCode 36044 and an ApprovalStatusCode 36050.

The ReleaseStatusCode 36032 attribute is a ReleaseStatusCode 36036 data type. The ReleaseStatusCode 36032 attribute has a cardinality of 1 36034 meaning that for each instance of the Status 36026 entity there is one ReleaseStatusCode 36032 attribute.

The PriceSpecificationListReleaseStatusCode 36038 attribute is a ReleaseStatusCode 36042 data type. The PriceSpecificationListReleaseStatusCode 36038 attribute has a cardinality of 1 36040 meaning that for each instance of the Status 36026 entity there is one PriceSpecificationListReleaseStatusCode 36038 attribute.

The ConsistencyStatusCode 36044 attribute is a ConsistencyStatusCode 36048 data type. The ConsistencyStatusCode 36044 attribute has a cardinality of 1 36046 meaning that for each instance of the Status 36026 entity there is one ConsistencyStatusCode 36044 attribute.

The ApprovalStatusCode 36050 attribute is an ApprovalStatusCode 36054 data type. The ApprovalStatusCode 36050 attribute has a cardinality of 1 36052 meaning that for each instance of the Status 36026 entity there is one ApprovalStatusCode 36050 attribute.

The Log 36092 node element grouping is a Log 36098 data type. The Log 36092 node element grouping includes a Log 36094 entity.

The Log 36094 entity has a cardinality of 0 . . . 1 36096 meaning that for each instance of the Log 36092 node element grouping there may be one Log 36094 entity.

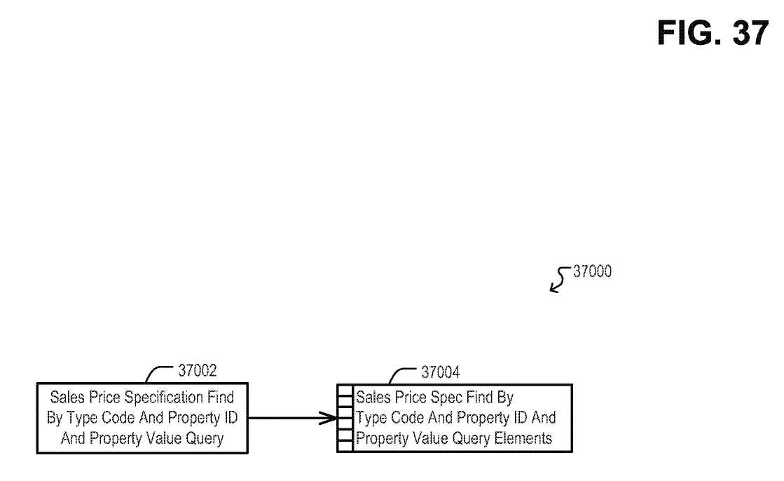

FIG. 37 illustrates one example logical configuration of a Sales Price Specification Find By Type Code And Property ID And Property Value Query message 37000. Specifically, this figure depicts the arrangement and hierarchy of various components such as one or more levels of packages, entities, and datatypes, shown here as 37002 through 37004. As described above, packages may be used to represent hierarchy levels. Entities are discrete business elements that are used during a business transaction. Data types are used to type object entities and interfaces with a structure. For example, the Sales Price Specification Find By Type Code And Property ID And Property Value Query message 37000 includes, among other things, a Sales Price Spec Find By Type Code And Property ID And Property Value Query Elements entity 37004. Accordingly, heterogeneous applications may communicate using this consistent message configured as such.

The message type Sales PriceSpecification Find by Type Code and Property ID and Property Value Query_sync is derived from the business object Sales PriceSpecification as a leading object together with its operation signature. The message type Sales Price Specification Find by Type Code and Property ID and Property Value Query_sync is a synchronous request for finding a sales price specification by its type code and property ID and property value. The structure of the message type Sales PriceSpecification Find by Type Code and Property ID and Property Value Query_sync is determined by the message data type SalesPriceSpecificationFindByTypeCodeAndPropertyIDAndPropertyValueMess age. The message data type SalesPriceSpecificationFindByTypeCodeAndPropertyIDAndPropertyValueMessage includes the SalesPriceSpecFindByTypeCodeAndPropertyIDAndPropertyValueQueryElements package.

The package SalesPriceSpecFindByTypeCodeAndPropertyIDAndPropertyValueQueryElements includes the entity SalesPriceSpecFindByTypeCodeAndPropertyIDAndPropertyValueQueryElements. SalesPriceSpecFindByTypeCodeAndPropertyIDAndPropertyValueQueryElements includes the following non-node elements: PriceSpecificationElementTypeCode, ReleaseStatusCode, ConsistencyStatusCode, ValidityPeriod, CreationDateTimeInterval, LastChangedDatetimeInterval, PriceSpecificationElementPropertyValuation1, PriceSpecificationElementPropertyValuation2, PriceSpecificationElementPropertyValuation3, PriceSpecificationElementPropertyValuation4, PriceSpecificationElementPropertyValuation5, PriceSpecificationElementPropertyValuation6, PriceSpecificationElementPropertyValuation7, PriceSpecificationElementPropertyValuation8, PriceSpecificationElementPropertyValuation9, and PriceSpecificationElementPropertyValuation10. LastChangedDatetimeInterval and CreationDateTimeInterval may each include LowerBoundaryDateTime and UpperBoundaryDateTime.

PriceSpecificationElementTypeCode may have a multiplicity of 0 . . . 1 and may be based on datatype BGDT:PriceSpecificationElementTypeCode. ReleaseStatusCode may have a multiplicity of 0 . . . 1 and may be based on datatype BGDT:ReleaseStatusCode. ConsistencyStatusCode may have a multiplicity of 0 . . . 1 and may be based on datatype BGDT:ConsistencyStatusCode. ValidityPeriod may have a multiplicity of 0 . . . 1 and may be based on datatype AGDT:TimePointPeriod. CreationDateTimeInterval may have a multiplicity of 0 . . . 1 and may be based on datatype MIDT:DateTimeInterval. LowerBoundaryDateTime may have a multiplicity of 0 . . . 1 and may be based on datatype CDT:GLOBAL_DateTime. UpperBoundaryDateTime may have a multiplicity of 0 . . . 1 and may be based on datatype CDT:GLOBAL_DateTime. LastChangedDatetimeInterval may have a multiplicity of 0 . . . 1 and may be based on datatype MIDT:DateTimeInterval. PriceSpecificationElementPropertyValuation1 may have a multiplicity of 0 . . . 1 and may be based on datatype AGDT:PriceSpecificationElementPropertyValuation. PriceSpecificationElementPropertyValuation2 may have a multiplicity of 0 . . . 1 and may be based on datatype AGDT:PriceSpecificationElementPropertyValuation.

PriceSpecificationElementPropertyValuation3 may have a multiplicity of 0 . . . 1 and may be based on datatype AGDT:PriceSpecificationElementPropertyValuation. PriceSpecificationElementPropertyValuation4 may have a multiplicity of 0 . . . 1 and may be based on datatype AGDT:PriceSpecificationElementPropertyValuation. PriceSpecificationElementPropertyValuation5 may have a multiplicity of 0 . . . 1 and may be based on datatype AGDT:PriceSpecificationElementPropertyValuation. PriceSpecificationElementPropertyValuation6 may have a multiplicity of 0 . . . 1 and may be based on datatype AGDT:PriceSpecificationElementPropertyValuation. PriceSpecificationElementPropertyValuation7 may have a multiplicity of 0 . . . 1 and may be based on datatype AGDT:PriceSpecificationElementPropertyValuation. PriceSpecificationElementPropertyValuation8 may have a multiplicity of 0 . . . 1 and may be based on datatype AGDT:PriceSpecificationElementPropertyValuation. PriceSpecificationElementPropertyValuation9 may have a multiplicity of 0 . . . 1 and may be based on datatype AGDT:PriceSpecificationElementPropertyValuation. PriceSpecificationElementPropertyValuation10 may have a multiplicity of 0 . . . 1 and may be based on datatype AGDT:PriceSpecificationElementPropertyValuation.

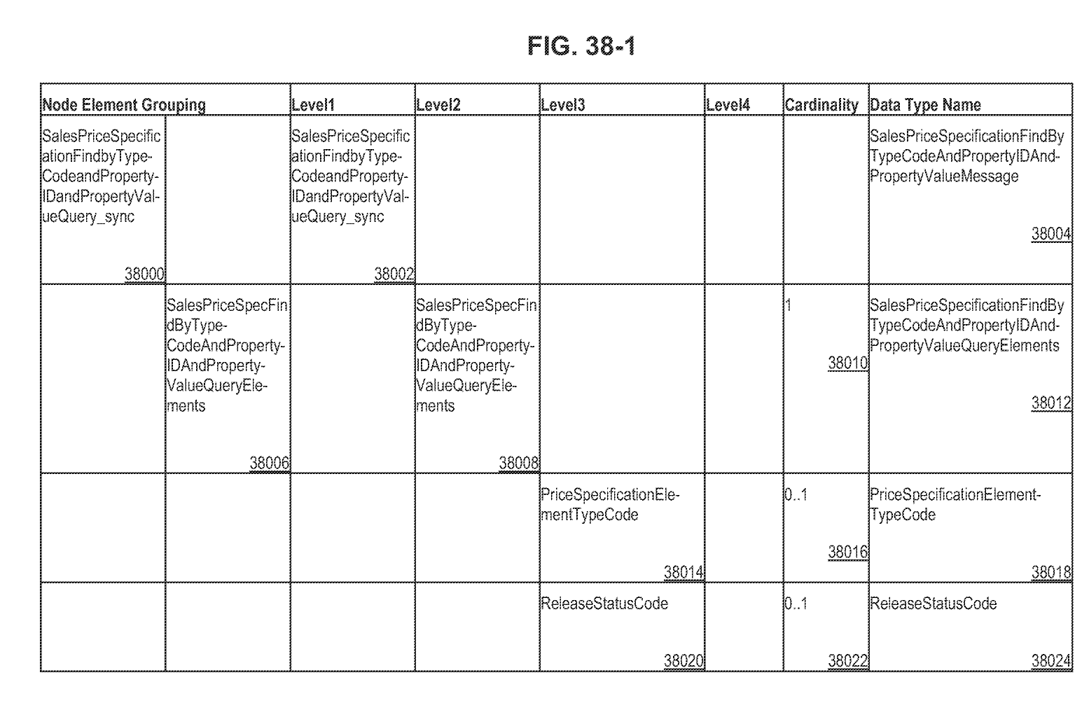

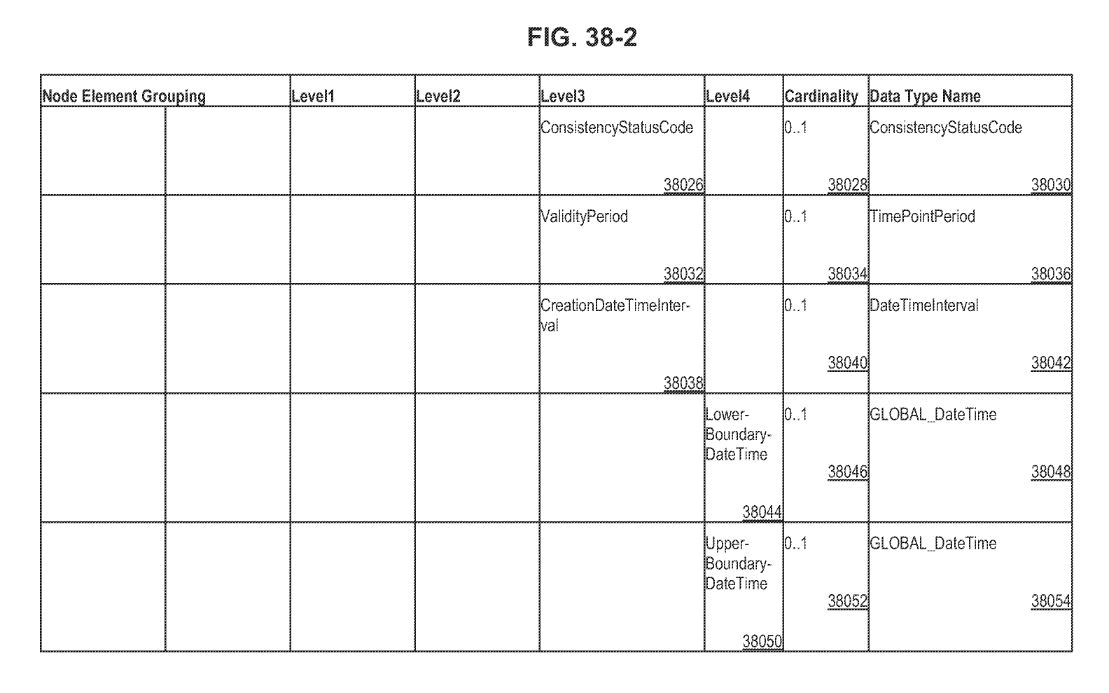

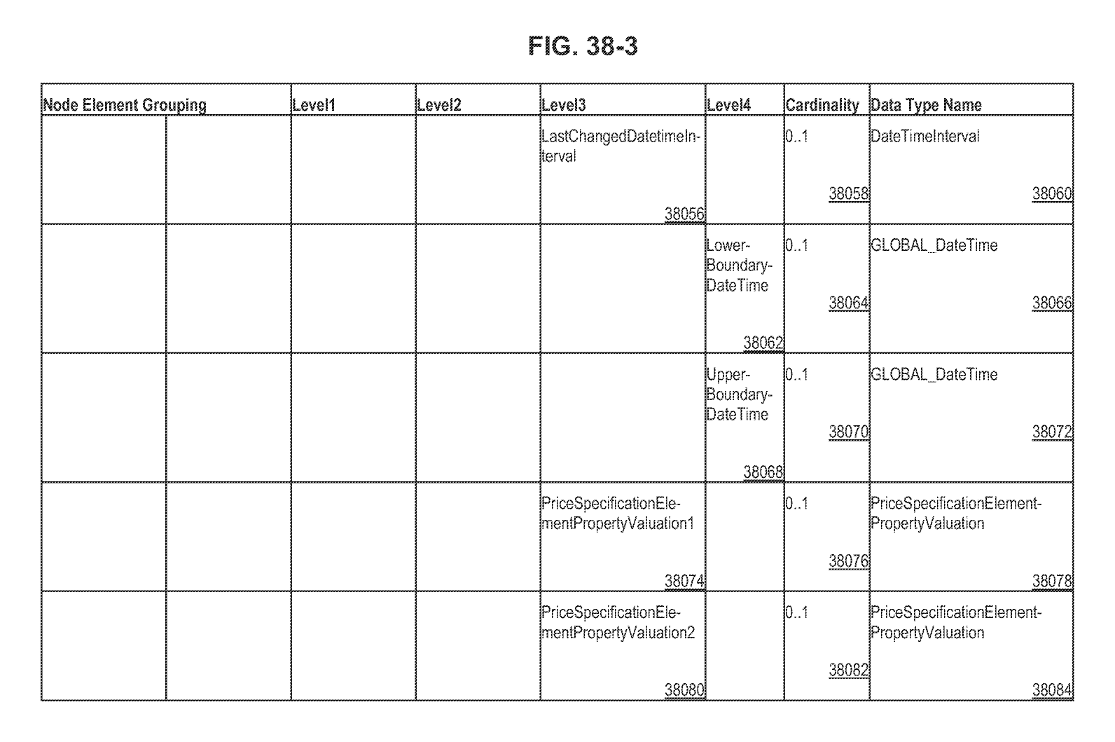

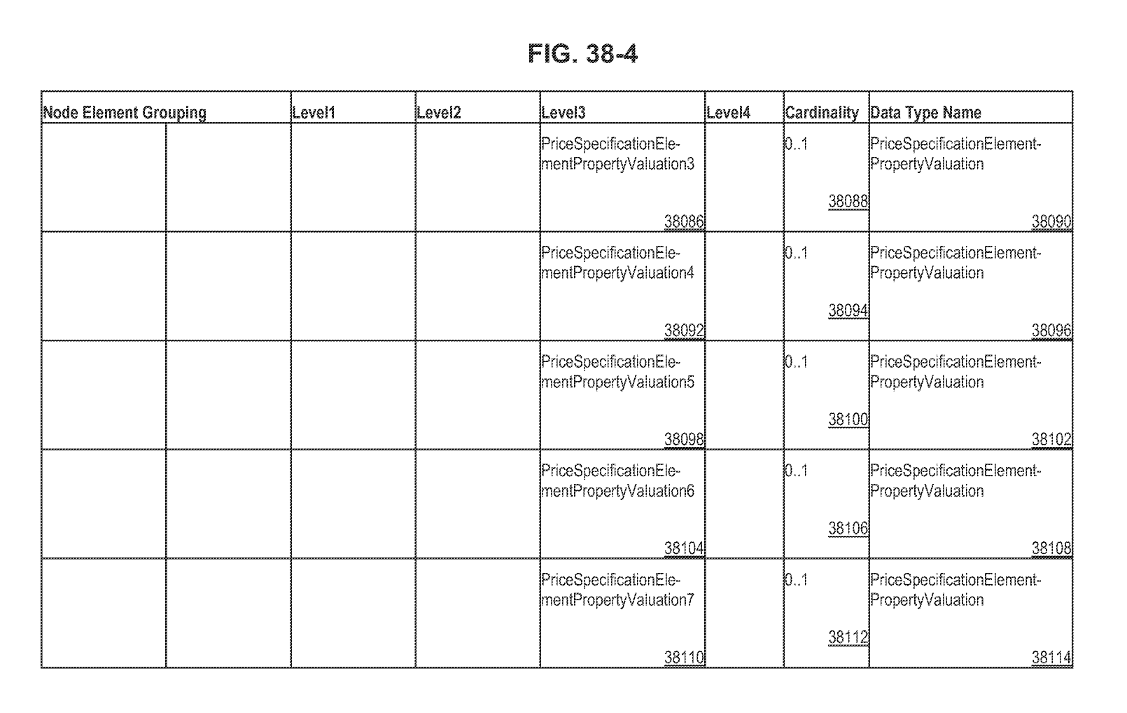

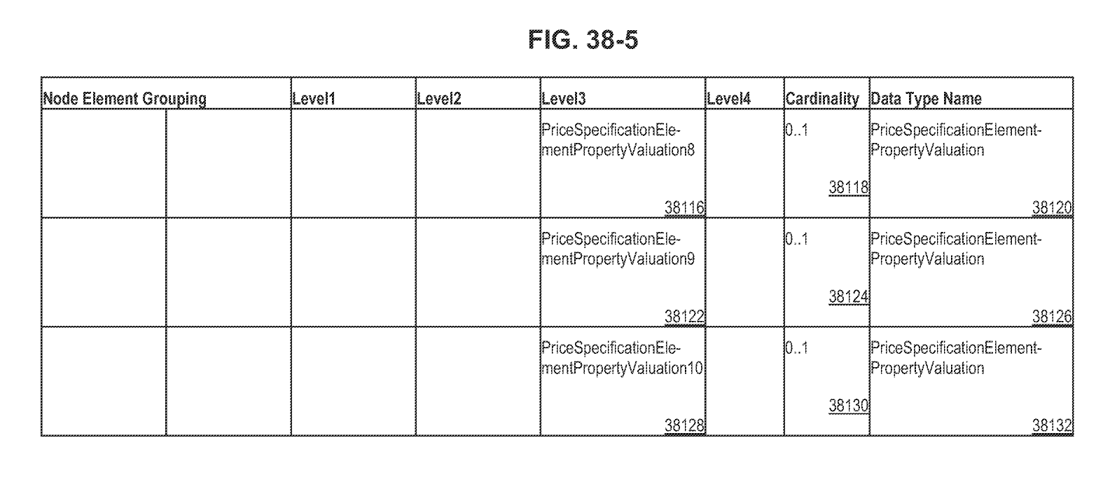

FIGS. 38-1 through 38-5 show an example configuration of an Element Structure that includes a SalesPriceSpecificationFindbyTypeCodeandPropertyIDandPropertyValueQuerysync 38000 node element grouping. Specifically, these figures depict the arrangement and hierarchy of various components such as one or more levels of node element groupings, entities, and datatypes, shown here as 38000 through 38132. As described above, node element groupings may be used to represent hierarchy levels. Entities are discrete business elements that are used during a business transaction. Data types are used to type object entities and interfaces with a structure. For example, the SalesPriceSpecificationFindbyTypeCodeandPropertyIDandPropertyValueQuerysync 38000 includes, among other things, a SalesPriceSpecificationFindbyTypeCodeandPropertyIDandPropertyValueQuery_sync 38002. Accordingly, heterogeneous applications may communicate using this consistent message configured as such. The SalesPriceSpecificationFindbyTypeCodeandPropertyIDandPropertyValueQuerysync 38000 node element grouping is a SalesPriceSpecificationFindByTypeCodeAndPropertyIDAndPropertyValueMessage 38004 data type. The SalesPriceSpecificationFindbyTypeCodeandPropertyIDandPropertyValueQuerysync 38000 node element grouping includes a SalesPriceSpecificationFindbyTypeCodeandPropertyIDandPropertyValueQuerysync 38002 entity. The SalesPriceSpecificationFindbyTypeCodeandPropertyIDandPropertyValueQuerysync 38000 node element grouping includes a SalesPriceSpecFindByTypeCodeAndPropertyIDAndPropertyValueQueryElements 38006 node element grouping.

The SalesPriceSpecFindByTypeCodeAndPropertyIDAndPropertyValueQueryElements 38006 node element grouping is a SalesPriceSpecificationFindByTypeCodeAndPropertyIDAndPropertyValueQueryElements 38012 data type. The SalesPriceSpecFindByTypeCodeAndPropertyIDAndPropertyValueQueryElements 38006 node element grouping includes a SalesPriceSpecFindByTypeCodeAndPropertyIDAndPropertyValueQueryElements 38008 entity.

The SalesPriceSpecFindByTypeCodeAndPropertyIDAndPropertyValueQueryElements 38008 entity has a cardinality of 1 38010 meaning that for each instance of the SalesPriceSpecFindByTypeCodeAndPropertyIDAndPropertyValueQueryElements 38006 node element grouping there is one SalesPriceSpecFindByTypeCodeAndPropertyIDAndPropertyValueQueryElements 38008 entity. The SalesPriceSpecFindByTypeCodeAndPropertyIDAndPropertyValueQueryElements 38008 entity includes various attributes, namely a PriceSpecificationElementTypeCode 38014, a ReleaseStatusCode 38020, a ConsistencyStatusCode 38026, a ValidityPeriod 38032, a PriceSpecificationElementPropertyValuation1 38074, a PriceSpecificationElementPropertyValuation2 38080, a PriceSpecificationElementPropertyValuation3 38086, a PriceSpecificationElementPropertyValuation4 38092, a PriceSpecificationElementPropertyValuation5 38098, a PriceSpecificationElementPropertyValuation6 38104, a PriceSpecificationElementPropertyValuation7 38110, a PriceSpecificationElementPropertyValuation8 38116, a PriceSpecificationElementPropertyValuation9 38122 and a PriceSpecificationElementPropertyValuation10 38128. The SalesPriceSpecFindByTypeCodeAndPropertyIDAndPropertyValueQueryElements 38008 entity includes various subordinate entities, namely a CreationDateTimeInterval 38038 and a LastChangedDatetimeInterval 38056.

The PriceSpecificationElementTypeCode 38014 attribute is a PriceSpecificationElementTypeCode 38018 data type. The PriceSpecificationElementTypeCode 38014 attribute has a cardinality of 0 . . . 1 38016 meaning that for each instance of the SalesPriceSpecFindByTypeCodeAndPropertyIDAndPropertyValueQueryElements 38008 entity there may be one PriceSpecificationElementTypeCode 38014 attribute.

The ReleaseStatusCode 38020 attribute is a ReleaseStatusCode 38024 data type. The ReleaseStatusCode 38020 attribute has a cardinality of 0 . . . 1 38022 meaning that for each instance of the SalesPriceSpecFindByTypeCodeAndPropertyIDAndPropertyValueQueryElements 38008 entity there may be one ReleaseStatusCode 38020 attribute.

The ConsistencyStatusCode 38026 attribute is a ConsistencyStatusCode 38030 data type. The ConsistencyStatusCode 38026 attribute has a cardinality of 0 . . . 1 38028 meaning that for each instance of the SalesPriceSpecFindByTypeCodeAndPropertyIDAndPropertyValueQueryElements 38008 entity there may be one ConsistencyStatusCode 38026 attribute.

The ValidityPeriod 38032 attribute is a TimePointPeriod 38036 data type. The ValidityPeriod 38032 attribute has a cardinality of 0 . . . 1 38034 meaning that for each instance of the SalesPriceSpecFindByTypeCodeAndPropertyIDAndPropertyValueQueryElements 38008 entity there may be one ValidityPeriod 38032 attribute.

The PriceSpecificationElementPropertyValuation1 38074 attribute is a PriceSpecificationElementPropertyValuation 38078 data type. The PriceSpecificationElementPropertyValuation1 38074 attribute has a cardinality of 0 . . . 1 38076 meaning that for each instance of the SalesPriceSpecFindByTypeCodeAndPropertyIDAndPropertyValueQueryElements 38008 entity there may be one PriceSpecificationElementPropertyValuation1 38074 attribute.

The PriceSpecificationElementPropertyValuation2 38080 attribute is a PriceSpecificationElementPropertyValuation 38084 data type. The PriceSpecificationElementPropertyValuation2 38080 attribute has a cardinality of 0 . . . 1 38082 meaning that for each instance of the SalesPriceSpecFindByTypeCodeAndPropertyIDAndPropertyValueQueryElements 38008 entity there may be one PriceSpecificationElementPropertyValuation2 38080 attribute.

The PriceSpecificationElementPropertyValuation3 38086 attribute is a PriceSpecificationElementPropertyValuation 38090 data type. The PriceSpecificationElementPropertyValuation3 38086 attribute has a cardinality of 0 . . . 1 38088 meaning that for each instance of the SalesPriceSpecFindByTypeCodeAndPropertyIDAndPropertyValueQueryElements 38008 entity there may be one PriceSpecificationElementPropertyValuation3 38086 attribute.

The PriceSpecificationElementPropertyValuation4 38092 attribute is a PriceSpecificationElementPropertyValuation 38096 data type. The PriceSpecificationElementPropertyValuation4 38092 attribute has a cardinality of 0 . . . 1 38094 meaning that for each instance of the SalesPriceSpecFindByTypeCodeAndPropertyIDAndPropertyValueQueryElements 38008 entity there may be one PriceSpecificationElementPropertyValuation4 38092 attribute.

The PriceSpecificationElementPropertyValuation5 38098 attribute is a PriceSpecificationElementPropertyValuation 38102 data type. The PriceSpecificationElementPropertyValuation5 38098 attribute has a cardinality of 0 . . . 1 38100 meaning that for each instance of the SalesPriceSpecFindByTypeCodeAndPropertyIDAndPropertyValueQueryElements 38008 entity there may be one PriceSpecificationElementPropertyValuation5 38098 attribute.

The PriceSpecificationElementPropertyValuation6 38104 attribute is a PriceSpecificationElementPropertyValuation 38108 data type. The PriceSpecificationElementPropertyValuation6 38104 attribute has a cardinality of 0 . . . 1 38106 meaning that for each instance of the SalesPriceSpecFindByTypeCodeAndPropertyIDAndPropertyValueQueryElements 38008 entity there may be one PriceSpecificationElementPropertyValuation6 38104 attribute.

The PriceSpecificationElementPropertyValuation7 38110 attribute is a PriceSpecificationElementPropertyValuation 38114 data type. The PriceSpecificationElementPropertyValuation7 38110 attribute has a cardinality of 0 . . . 1 38112 meaning that for each instance of the SalesPriceSpecFindByTypeCodeAndPropertyIDAndPropertyValueQueryElements 38008 entity there may be one PriceSpecificationElementPropertyValuation7 38110 attribute.

The PriceSpecificationElementPropertyValuation8 38116 attribute is a PriceSpecificationElementPropertyValuation 38120 data type. The PriceSpecificationElementPropertyValuation8 38116 attribute has a cardinality of 0 . . . 1 38118 meaning that for each instance of the SalesPriceSpecFindByTypeCodeAndPropertyIDAndPropertyValueQueryElements 38008 entity there may be one PriceSpecificationElementPropertyValuation8 38116 attribute.

The PriceSpecificationElementPropertyValuation9 38122 attribute is a PriceSpecificationElementPropertyValuation 38126 data type. The PriceSpecificationElementPropertyValuation9 38122 attribute has a cardinality of 0 . . . 1 38124 meaning that for each instance of the SalesPriceSpecFindByTypeCodeAndPropertyIDAndPropertyValueQueryElements 38008 entity there may be one PriceSpecificationElementPropertyValuation9 38122 attribute.

The PriceSpecificationElementPropertyValuation10 38128 attribute is a PriceSpecificationElementPropertyValuation 38132 data type. The PriceSpecificationElementPropertyValuation10 38128 attribute has a cardinality of 0 . . . 1 38130 meaning that for each instance of the SalesPriceSpecFindByTypeCodeAndPropertyIDAndPropertyValueQueryElements 38008 entity there may be one PriceSpecificationElementPropertyValuation10 38128 attribute.

The CreationDateTimeInterval 38038 entity has a cardinality of 0 . . . 1 38040 meaning that for each instance of the SalesPriceSpecFindByTypeCodeAndPropertyIDAndPropertyValueQueryElements 38008 entity there may be one CreationDateTimeInterval 38038 entity. The CreationDateTimeInterval 38038 entity includes various attributes, namely a LowerBoundaryDateTime 38044 and an UpperBoundaryDateTime 38050.

The LowerBoundaryDateTime 38044 attribute is a GLOBAL_DateTime 38048 data type. The LowerBoundaryDateTime 38044 attribute has a cardinality of 0 . . . 1 38046 meaning that for each instance of the CreationDateTimeInterval 38038 entity there may be one LowerBoundaryDateTime 38044 attribute.

The UpperBoundaryDateTime 38050 attribute is a GLOBAL_DateTime 38054 data type. The UpperBoundaryDateTime 38050 attribute has a cardinality of 0 . . . 1 38052 meaning that for each instance of the CreationDateTimeInterval 38038 entity there may be one UpperBoundaryDateTime 38050 attribute.

The LastChangedDatetimeInterval 38056 entity has a cardinality of 0 . . . 1 38058 meaning that for each instance of the SalesPriceSpecFindByTypeCodeAndPropertyIDAndPropertyValueQueryElements 38008 entity there may be one LastChangedDatetimeInterval 38056 entity. The LastChangedDatetimeInterval 38056 entity includes various attributes, namely a LowerBoundaryDateTime 38062 and an UpperBoundaryDateTime 38068.

The LowerBoundaryDateTime 38062 attribute is a GLOBAL_DateTime 38066 data type. The LowerBoundaryDateTime 38062 attribute has a cardinality of 0 . . . 1 38064 meaning that for each instance of the LastChangedDatetimeInterval 38056 entity there may be one LowerBoundaryDateTime 38062 attribute.

The UpperBoundaryDateTime 38068 attribute is a GLOBAL_DateTime 38072 data type. The UpperBoundaryDateTime 38068 attribute has a cardinality of 0 . . . 1 38070 meaning that for each instance of the LastChangedDatetimeInterval 38056 entity there may be one UpperBoundaryDateTime 38068 attribute.

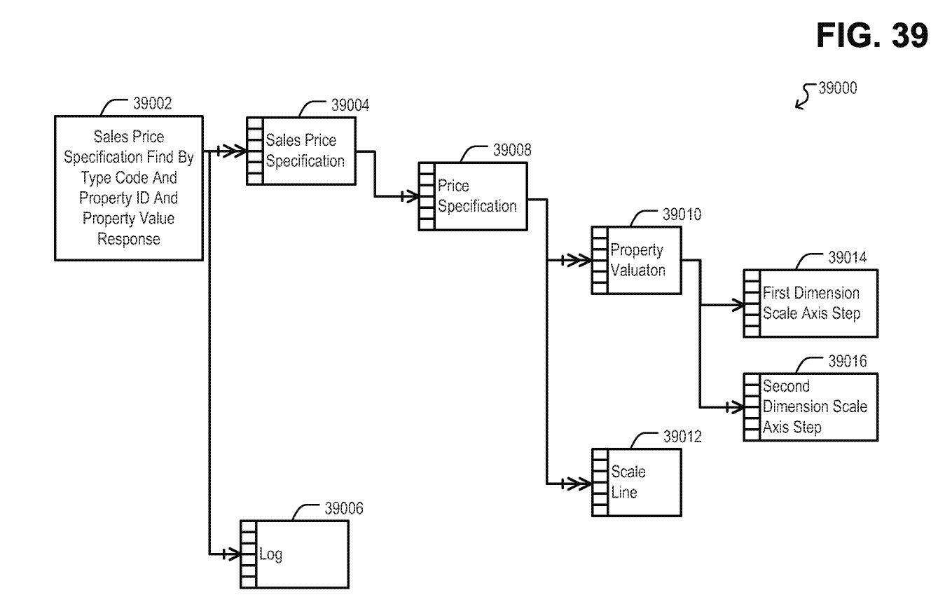

FIG. 39 illustrates one example logical configuration of a Sales Price Specification Find By Type Code And Property ID And Property Value Response message 39000. Specifically, this figure depicts the arrangement and hierarchy of various components such as one or more levels of packages, entities, and datatypes, shown here as 39002 through 39016. As described above, packages may be used to represent hierarchy levels. Entities are discrete business elements that are used during a business transaction. Data types are used to type object entities and interfaces with a structure. For example, the Sales Price Specification Find By Type Code And Property ID And Property Value Response message 39000 includes, among other things, a Sales Price Specification entity 39004. Accordingly, heterogeneous applications may communicate using this consistent message configured as such.

The message type Sales Price Specification Find by Type Code and Property ID and Property Value Response_sync is derived from the business object Sales Price Specification as a leading object together with its operation signature. The message type Sales Price Specification Find by Type Code and Property ID and Property Value Response_sync is a synchronous response for finding a sales price specification by its type code and property ID and property value. The structure of the message type Sales Price Specification Find by Type Code and Property ID and Property Value Response_sync is determined by the message data type SalesPriceSpecificationFindByTypeCodeAndPropertyIDAndPropertyValueResponseMessage. The message data type SalesPriceSpecificationFindByTypeCodeAndPropertyIDAndPropertyValueResponseMessage includes the Sales Price Specification package and the Log package. The package Log includes the entity Log, which may be based on datatype Log.

The package Sales Price Specification includes the entity SalesPriceSpec. SalesPriceSpec includes the following non-node elements: ValidityPeriod, PriceSpecificationDescriptionElements, and Description. ValidityPeriod may have a multiplicity of 1 and may be based on datatype AGDT:TimePointPeriod. PriceSpecificationDescriptionElements may have a multiplicity of 0 . . . 1 and may be based on datatype MIDT:PriceSpecificationDescriptionElements. Description may have a multiplicity of 1 and may be based on datatype BGDT:SHORT_Description. SalesPriceSpec includes the node element PriceSpecification in a 1:C cardinality relationship.

PriceSpecification includes the following non-node elements: PriceSpecificationElementTypeCode, PriceSpecificationElementTypeName, PriceSpecificationElementCategoryCode, PriceSpecificationElementCategoryName, PriceSpecificationElementPurposeCode, PriceSpecificationElementPurposeName, ConsistencyStatusCode, ConsistencyStatusName, ReleaseStatusCode, ReleaseStatusName, BaseQuantity, BaseQuantityTypeCode, BaseQuantityTypeName, Amount, Percent, and ScaleExistsIndicator. PriceSpecificationElementTypeCode may have a multiplicity of 0.1 and may be based on datatype BGDT:PriceSpecificationElementTypeCode. PriceSpecificationElementTypeName may have a multiplicity of 0 . . . 1 and may be based on datatype CDT:MEDIUM_Name. PriceSpecificationElementCategoryCode may have a multiplicity of 0 . . . 1 and may be based on datatype BGDT:PriceSpecificationElementCategoryCode. PriceSpecificationElementCategoryName may have a multiplicity of 0 . . . 1 and may be based on datatype CDT:MEDIUM_Name. PriceSpecificationElementPurposeCode may have a multiplicity of 0 . . . 1 and may be based on datatype BGDT:PriceSpecificationElementPurposeCode. PriceSpecificationElementPurposeName may have a multiplicity of 0 . . . 1 and may be based on datatype CDT:MEDIUM_Name. ConsistencyStatusCode may have a multiplicity of 0 . . . 1 and may be based on datatype BGDT:ConsistencyStatusCode. ConsistencyStatusName may have a multiplicity of 0 . . . 1 and may be based on datatype CDT:MEDIUM_Name. ReleaseStatusCode may have a multiplicity of 0 . . . 1 and may be based on datatype BGDT:ReleaseStatusCode. ReleaseStatusName may have a multiplicity of 0 . . . 1 and may be based on datatype CDT:MEDIUM_Name. BaseQuantity may have a multiplicity of 0 . . . 1 and may be based on datatype CDT:Quantity. BaseQuantityTypeCode may have a multiplicity of 0 . . . 1 and may be based on datatype BGDT:QuantityTypeCode. BaseQuantityTypeName may have a multiplicity of 0 . . . 1 and may be based on datatype CDT:MEDIUM_Name. Amount may have a multiplicity of 0 . . . 1 and may be based on datatype CDT:Amount. Percent may have a multiplicity of 0 . . . 1 and may be based on datatype CDT:Percent. ScaleExistsIndicator may have a multiplicity of 0 . . . 1 and may be based on datatype CDT:Indicator. PriceSpecification includes the node element PropertyValuation in a 1:CN cardinality relationship, and the node element ScaleLine in a 1:CN cardinality relationship.

The package SalesPriceSpecificationPropertyValuation includes the entity PropertyValuation. PropertyValuation includes the following non-node elements: PriceSpecificationElementPropertyValuation and Description. PriceSpecificationElementPropertyValuation may have a multiplicity of 1 and may be based on datatype AGDT:PriceSpecificationElementPropertyValuation. Description may have a multiplicity of 1 and may be based on datatype BGDT:Description.

The package SalesPriceSpecificationScaleLine includes the sub-packages FirstDimensionScaleAxisStep and SecondDimensionScaleAxisStep and the entity ScaleLine. ScaleLine includes the following non-node elements: BaseQuantity, BaseQuantityTypeCode, BaseQuantityTypeName, Amount, and Percent. BaseQuantity may have a multiplicity of 0 . . . 1, is a reference a quantity with a unit of measure, may be based on an amount for quantity-specific prices, discounts or surcharges, and may be based on datatype CDT:Quantity with a qualifier of Base. BaseQuantityTypeCode may have a multiplicity of 0 . . . 1, is a coded representation of a type of BaseQuantity, and may be based on datatype BGDT:QuantityTypeCode with a qualifier of Base. BaseQuantityTypeName may have a multiplicity of 0 . . . 1, is a name of a BaseQuantityTypeCode, and may be based on datatype CDT:MEDIUM_Name. Amount may have a multiplicity of 0 . . . 1, is an amount with a currency unit, and may be based on datatype CDT:Amount. Percent may have a multiplicity of 0 . . . 1, is a percentage for a discount or surcharge, and may be based on datatype CDT:Percent.

ScaleLine includes the node element FirstDimensionScaleAxisStep in a 1:1 cardinality relationship and the node element SecondDimensionScaleAxisStep in a 1:C cardinality relationship. The package SalesPriceSpecificationScaleLineFirstDimensionScaleAxisStep includes the entity FirstDimensionScaleAxisStep. FirstDimensionScaleAxisStep is a step of a scale axis for a first scale dimension. FirstDimensionScaleAxisStep includes the following non-node elements: ScaleAxisBaseCode, ScaleAxisBaseName, ScaleAxisStepintervalBoundaryTypeCode, ScaleAxisStepintervalBoundaryTypeName, Amount, Quantity, QuantityTypeCode, QuantityTypeName, DecimalValue, and IntegerValue. ScaleAxisBaseCode may have a multiplicity of 1, is a ScaleAxisBaseCode of a scale axis step, and may be based on datatype BGDT:ScaleAxisBaseCode. ScaleAxisBaseName may have a multiplicity of 1, is a name of a ScaleAxisBaseCode, and may be based on datatype CDT:MEDIUM_Name. ScaleAxisStepintervalBoundaryTypeCode may have a multiplicity of 1, is a ScaleAxisIntervalBoundaryCode of a scale axis step, and may be based on datatype BGDT:ScaleAxisStepintervalBoundaryTypeCode.

ScaleAxisStepintervalBoundaryTypeName may have a multiplicity of 1, is a name of a ScaleAxisIntervalBoundaryCode, and may be based on datatype CDT:MEDIUM_Name. Amount may have a multiplicity of 0 . . . 1, is an amount with a currency unit, and may be based on datatype CDT:Amount. Quantity may have a multiplicity of 0 . . . 1, is a reference quantity with a unit of measure, may be based on an amount for quantity-specific prices, discounts or surcharges, and may be based on datatype CDT:Quantity. QuantityTypeCode may have a multiplicity of 0 . . . 1, is a coded representation of a type of Quantity, and may be based on datatype BGDT:QuantityTypeCode. QuantityTypeName may have a multiplicity of 0 . . . 1, is a name of a QuantityTypeCode, and may be based on datatype CDT:MEDIUM_Name. DecimalValue may have a multiplicity of 0 . . . 1 and may be based on datatype BGDT:DecimalValue. IntegerValue may have a multiplicity of 0 . . . 1 and may be based on datatype BGDT:IntegerValue.

The package SalesPriceSpecificationScaleLineSecondDimensionScaleAxisStep includes the entity SecondDimensionScaleAxisStep. SecondDimensionScaleAxisStep is a step of a scale axis for a second scale dimension. SecondDimensionScaleAxisStep includes the following non-node elements: ScaleAxisBaseCode, ScaleAxisBaseName, ScaleAxisStepintervalBoundaryTypeCode, ScaleAxisStepintervalBoundaryTypeName, Amount, Quantity, QuantityTypeCode, QuantityTypeName, DecimalValue, and IntegerValue.

ScaleAxisBaseCode may have a multiplicity of 1, is a ScaleAxisBaseCode of a scale axis step, and may be based on datatype BGDT:ScaleAxisBaseCode. ScaleAxisBaseName may have a multiplicity of 1, is a name of a ScaleAxisBaseCode, and may be based on datatype CDT:MEDIUM_Name. ScaleAxisStepintervalBoundaryTypeCode may have a multiplicity of 1, is a ScaleAxisIntervalBoundaryCode of a scale axis step, and may be based on datatype BGDT:ScaleAxisStepintervalBoundaryTypeCode. ScaleAxisStepintervalBoundaryTypeName may have a multiplicity of 1, is a name of a ScaleAxisIntervalBoundaryCode, and may be based on datatype CDT:MEDIUM_Name. Amount may have a multiplicity of 0 . . . 1, is an amount with a currency unit, and may be based on datatype CDT:Amount. Quantity may have a multiplicity of 0 . . . 1, is a reference quantity with a unit of measure, may be based on an amount for quantity-specific prices, discounts or surcharges, and may be based on datatype CDT:Quantity. QuantityTypeCode may have a multiplicity of 0 . . . 1, is a coded representation of a type of Quantity, and may be based on datatype BGDT:QuantityTypeCode. QuantityTypeName may have a multiplicity of 0 . . . 1, is a name of a QuantityTypeCode, and may be based on datatype CDT:MEDIUM_Name. DecimalValue may have a multiplicity of 0 . . . 1 and may be based on datatype BGDT:DecimalValue. IntegerValue may have a multiplicity of 0 . . . 1 and may be based on datatype BGDT:IntegerValue.

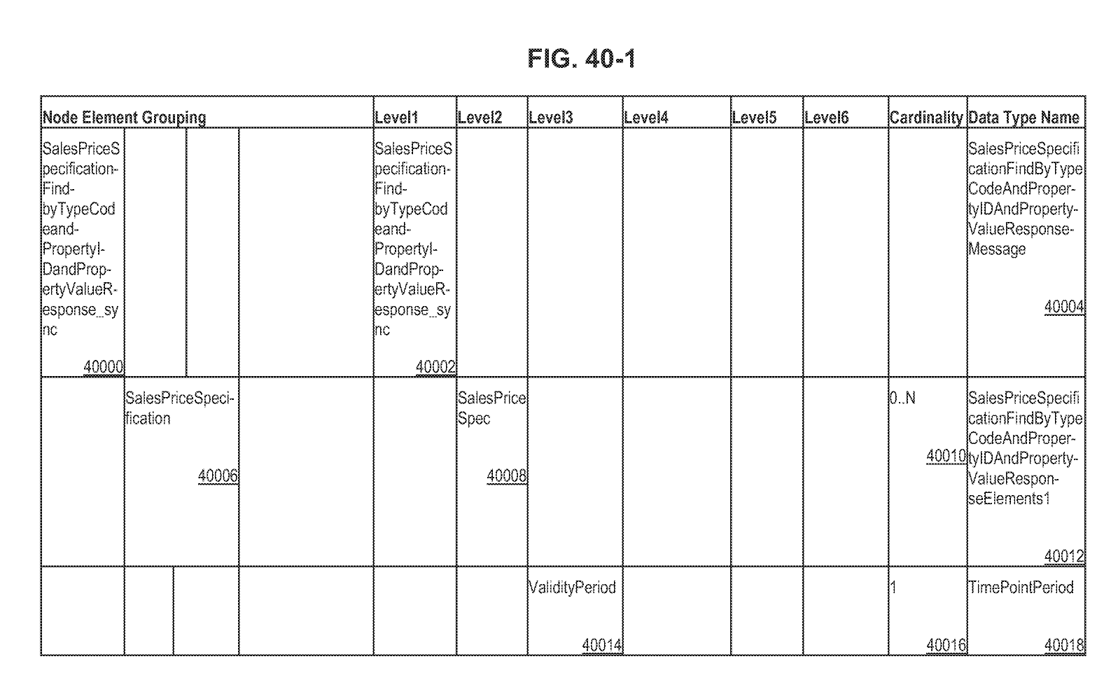

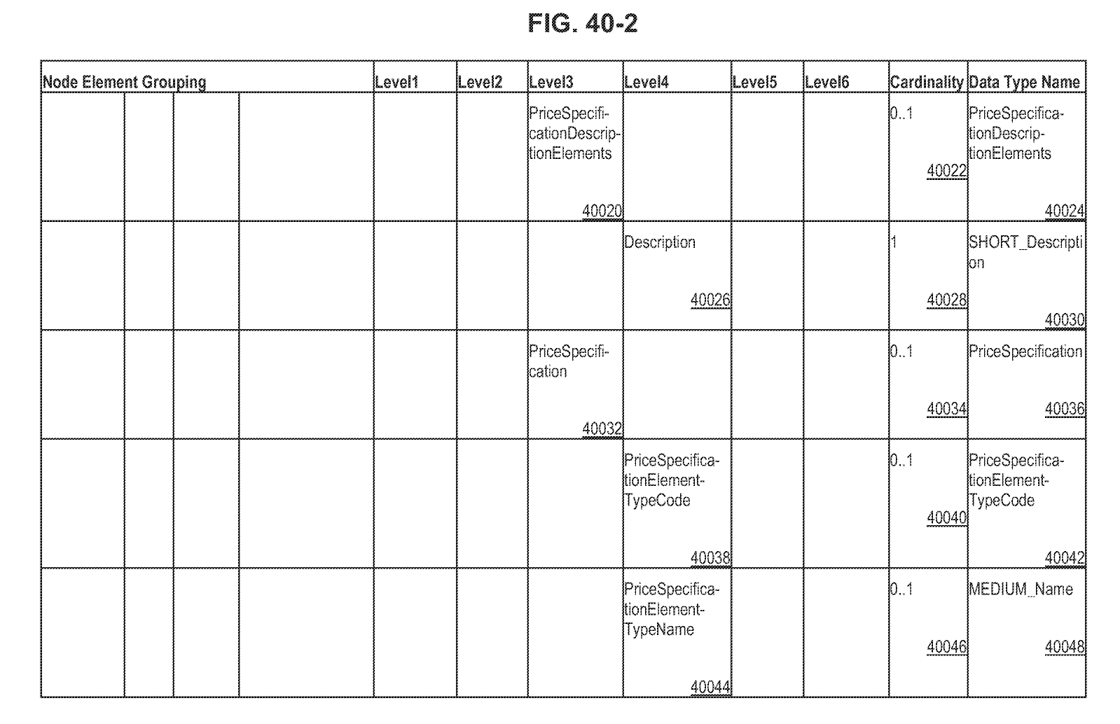

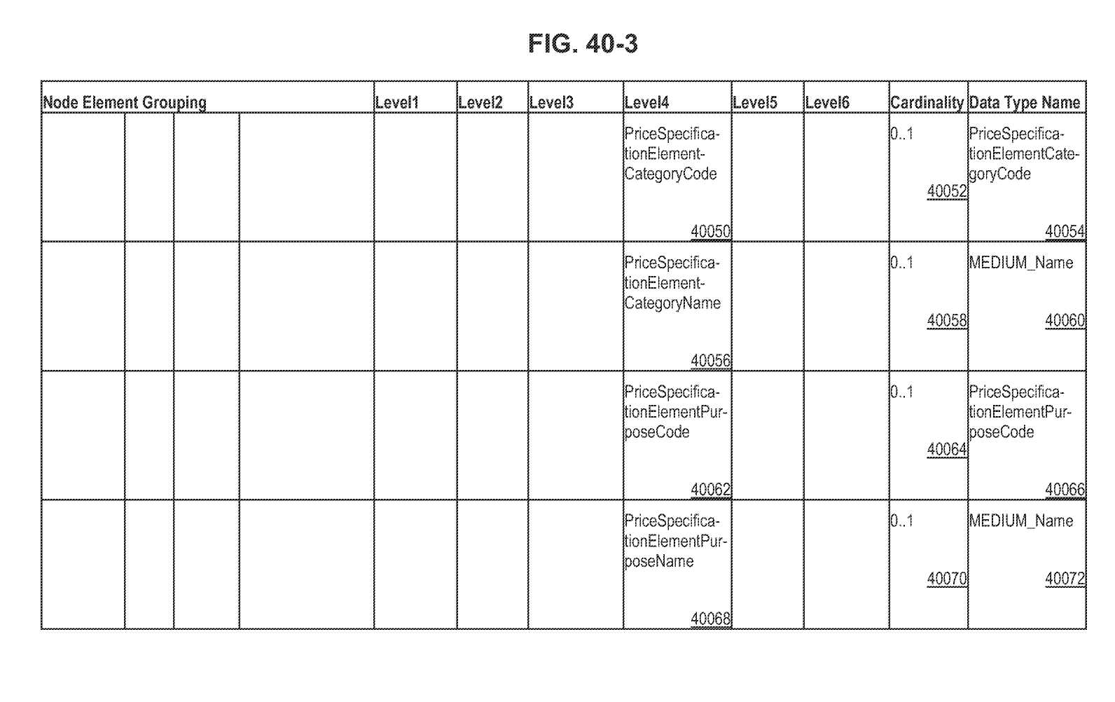

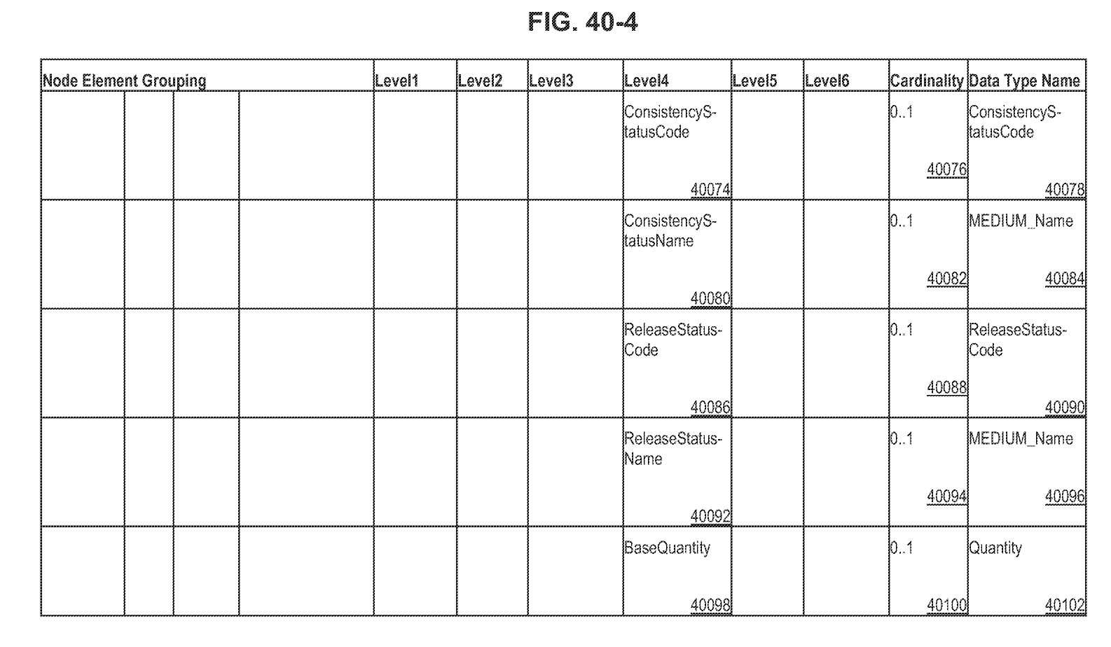

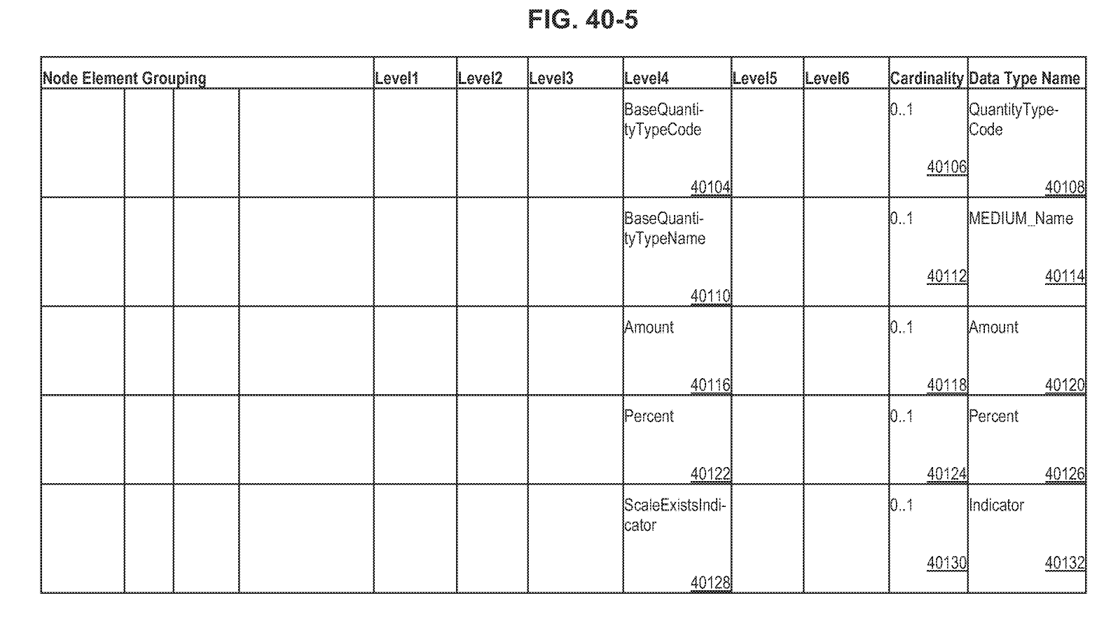

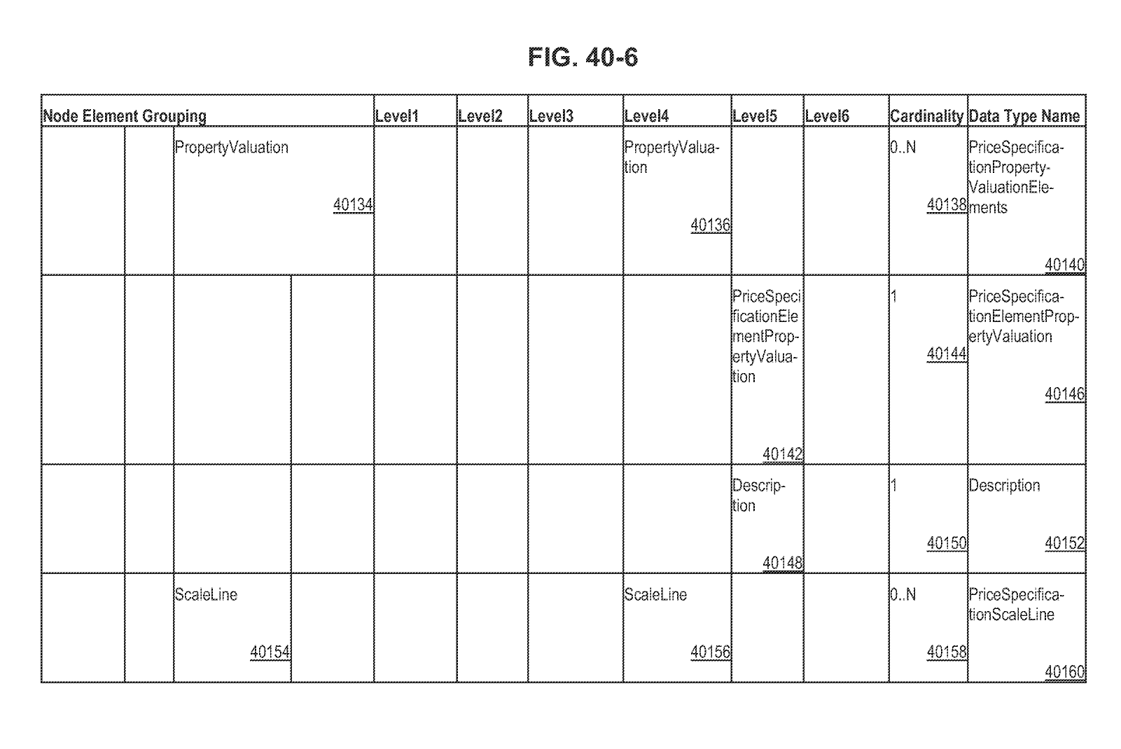

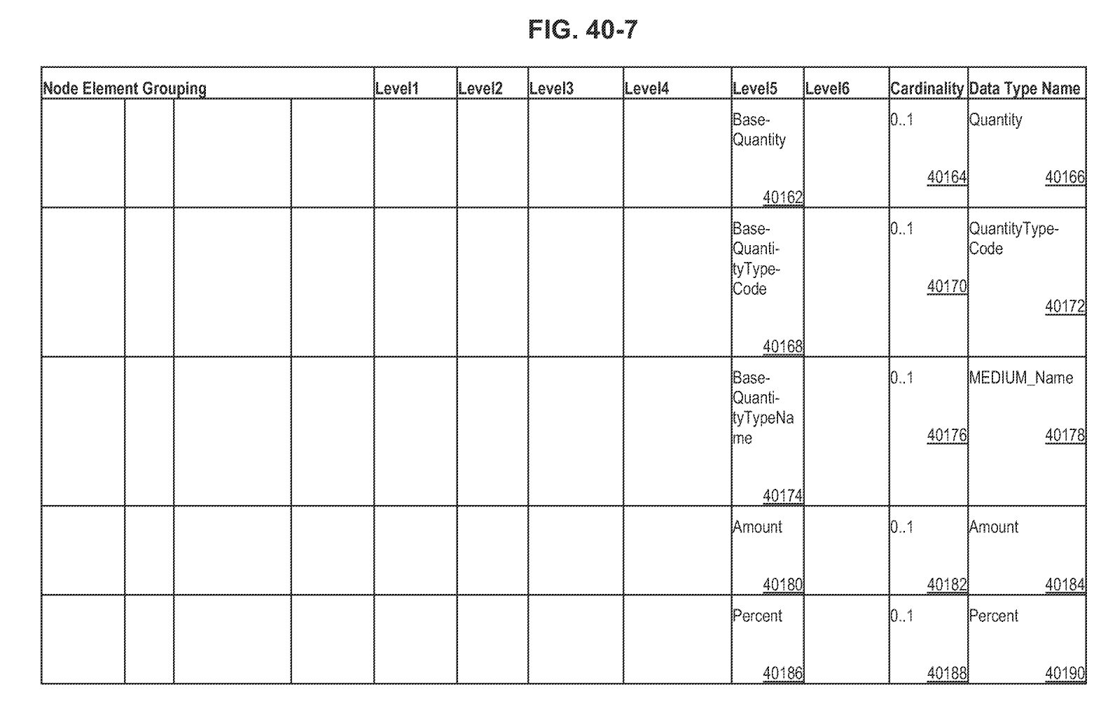

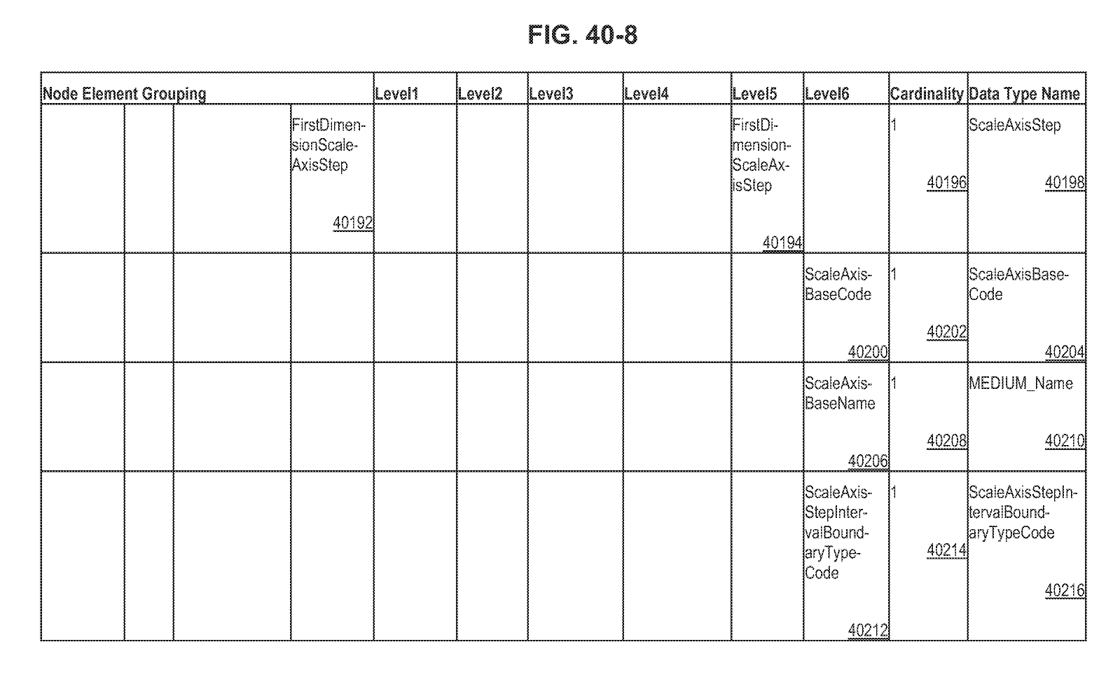

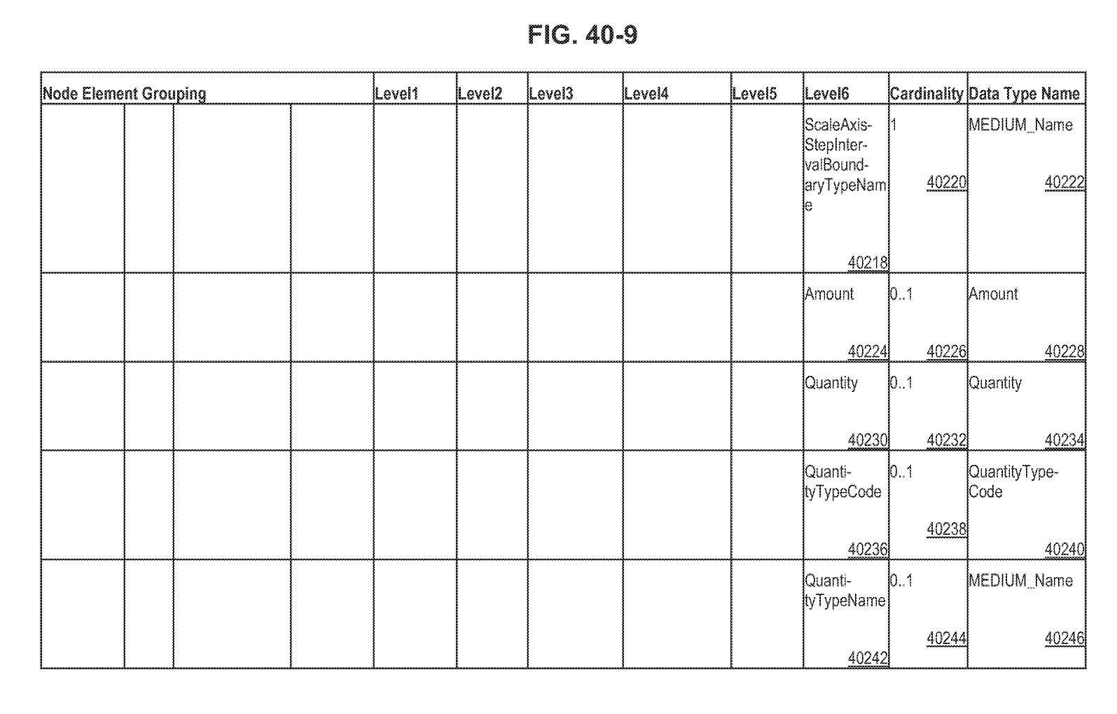

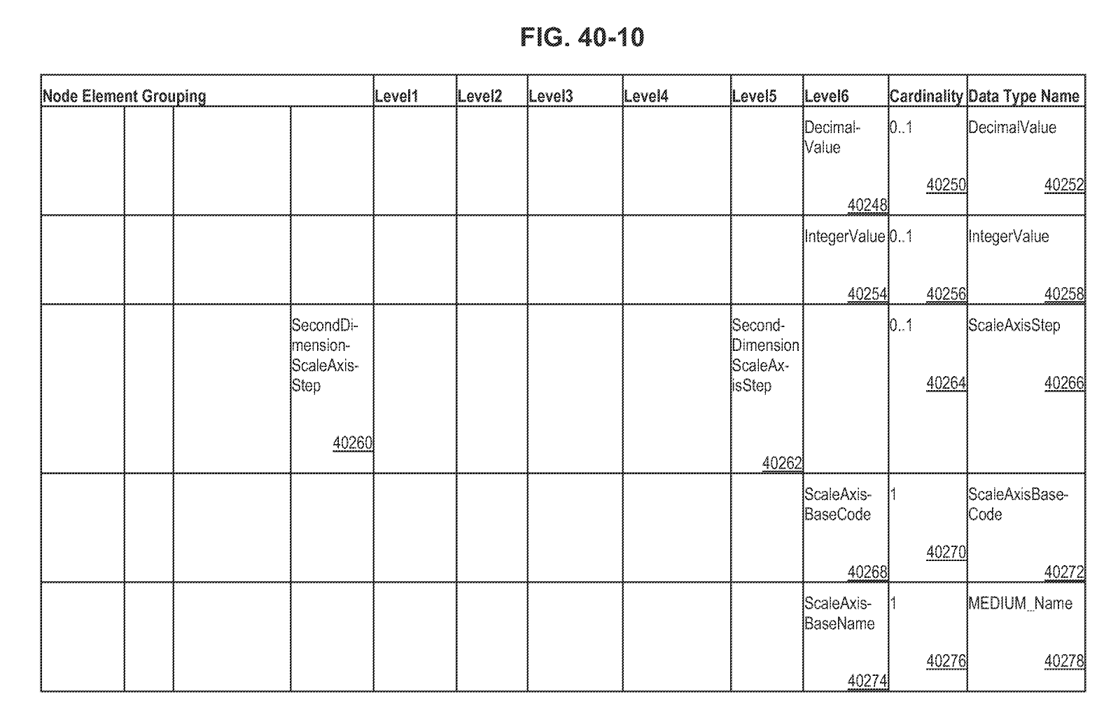

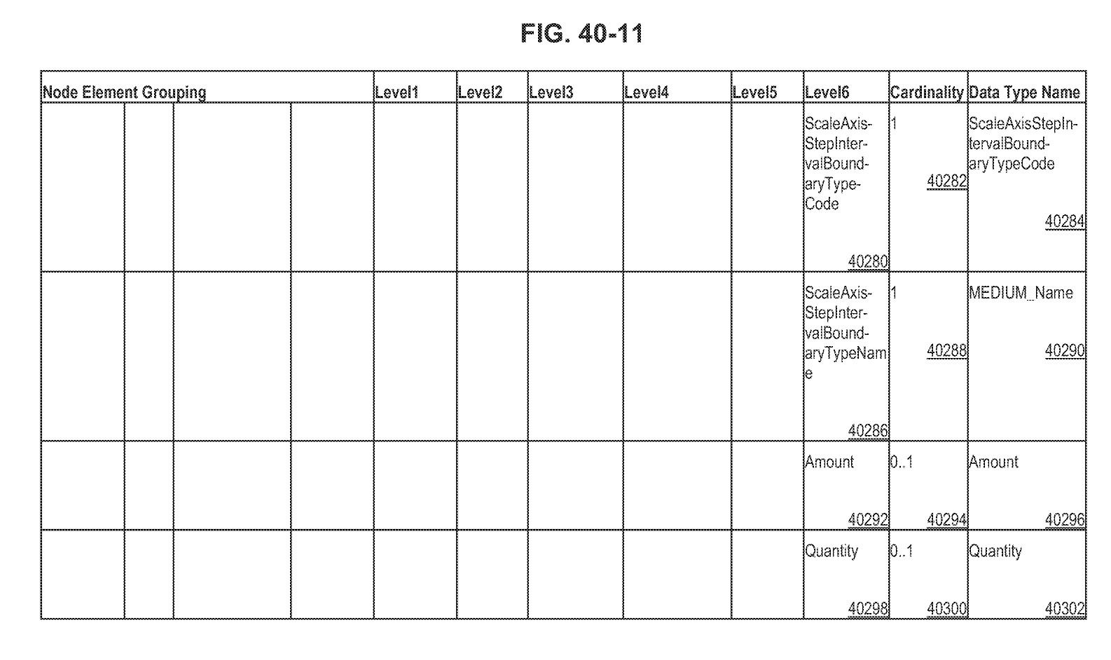

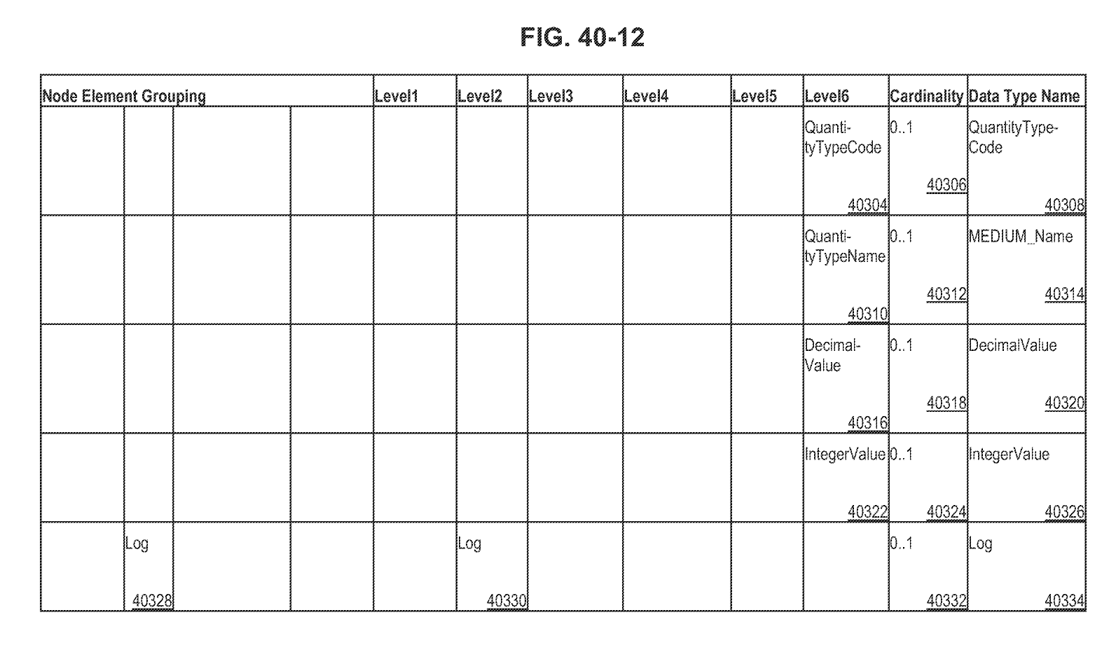

FIGS. 40-1 through 40-12 show an example configuration of an Element Structure that includes a SalesPriceSpecificationFindbyTypeCodeandPropertyIDandPropertyValueResponse_sync 40000 node element grouping. Specifically, these figures depict the arrangement and hierarchy of various components such as one or more levels of node element groupings, entities, and datatypes, shown here as 40000 through 40334. As described above, node element groupings may be used to represent hierarchy levels. Entities are discrete business elements that are used during a business transaction. Data types are used to type object entities and interfaces with a structure. For example, the SalesPriceSpecificationFindbyTypeCodeandPropertyIDandPropertyValueResponse_sync 40000 includes, among other things, a SalesPriceSpecificationFindbyTypeCodeandPropertyIDandPropertyValueResponse_sync 40002. Accordingly, heterogeneous applications may communicate using this consistent message configured as such. The SalesPriceSpecificationFindbyTypeCodeandPropertyIDandPropertyValueResponse_sync 40000 node element grouping is a SalesPriceSpecificationFindByTypeCodeAndPropertyIDAndPropertyValueResponseMessage 40004 data type. The SalesPriceSpecificationFindbyTypeCodeandPropertyIDandPropertyValueResponse_sync 40000 node element grouping includes a SalesPriceSpecificationFindbyTypeCodeandPropertyIDandPropertyValueResponse_sync 40002 entity. The SalesPriceSpecificationFindbyTypeCodeandPropertyIDandPropertyValueResponse_sync 40000 node element grouping includes various node element groupings, namely a SalesPriceSpecification 40006 and a Log 40328.

The Sales Price Specification 40006 node element grouping is a SalesPriceSpecificationFindByTypeCodeAndPropertyIDAndPropertyValueResponseElements1 40012 data type. The Sales Price Specification 40006 node element grouping includes a SalesPriceSpec 40008 entity. The Sales Price Specification 40006 node element grouping includes various node element groupings, namely a PropertyValuation 40134 and a ScaleLine 40154.

The SalesPriceSpec 40008 entity has a cardinality of 0 . . . N 40010 meaning that for each instance of the Sales Price Specification 40006 node element grouping there may be one or more SalesPriceSpec 40008 entities. The SalesPriceSpec 40008 entity includes a ValidityPeriod 40014 attribute. The SalesPriceSpec 40008 entity includes various subordinate entities, namely a PriceSpecificationDescriptionElements 40020 and a PriceSpecification 40032.

The ValidityPeriod 40014 attribute is a TimePointPeriod 40018 data type. The ValidityPeriod 40014 attribute has a cardinality of 1 40016 meaning that for each instance of the SalesPriceSpec 40008 entity there is one ValidityPeriod 40014 attribute.

The PriceSpecificationDescriptionElements 40020 entity has a cardinality of 0 . . . 1 40022 meaning that for each instance of the SalesPriceSpec 40008 entity there may be one PriceSpecificationDescriptionElements 40020 entity. The PriceSpecificationDescriptionElements 40020 entity includes a Description 40026 attribute.

The Description 40026 attribute is a SHORT_Description 40030 data type. The Description 40026 attribute has a cardinality of 1 40028 meaning that for each instance of the PriceSpecificationDescriptionElements 40020 entity there is one Description 40026 attribute.

The PriceSpecification 40032 entity has a cardinality of 0 . . . 1 40034 meaning that for each instance of the SalesPriceSpec 40008 entity there may be one PriceSpecification 40032 entity. The PriceSpecification 40032 entity includes various attributes, namely a PriceSpecificationElementTypeCode 40038, a PriceSpecificationElementTypeName 40044, a PriceSpecificationElementCategoryCode 40050, a PriceSpecificationElementCategoryName 40056, a PriceSpecificationElementPurposeCode 40062, a PriceSpecificationElementPurposeName 40068, a ConsistencyStatusCode 40074, a ConsistencyStatusName 40080, a ReleaseStatusCode 40086, a ReleaseStatusName 40092, a BaseQuantity 40098, a BaseQuantityTypeCode 40104, a BaseQuantityTypeName 40110, an Amount 40116, a Percent 40122 and a ScaleExistsIndicator 40128.

The PriceSpecificationElementTypeCode 40038 attribute is a PriceSpecificationElementTypeCode 40042 data type. The PriceSpecificationElementTypeCode 40038 attribute has a cardinality of 0 . . . 1 40040 meaning that for each instance of the PriceSpecification 40032 entity there may be one PriceSpecificationElementTypeCode 40038 attribute.

The PriceSpecificationElementTypeName 40044 attribute is a MEDIUM_Name 40048 data type. The PriceSpecificationElementTypeName 40044 attribute has a cardinality of 0 . . . 1 40046 meaning that for each instance of the PriceSpecification 40032 entity there may be one PriceSpecificationElementTypeName 40044 attribute.

The PriceSpecificationElementCategoryCode 40050 attribute is a PriceSpecificationElementCategoryCode 40054 data type. The PriceSpecificationElementCategoryCode 40050 attribute has a cardinality of 0 . . . 1 40052 meaning that for each instance of the PriceSpecification 40032 entity there may be one PriceSpecificationElementCategoryCode 40050 attribute.

The PriceSpecificationElementCategoryName 40056 attribute is a MEDIUM_Name 40060 data type. The PriceSpecificationElementCategoryName 40056 attribute has a cardinality of 0 . . . 1 40058 meaning that for each instance of the PriceSpecification 40032 entity there may be one PriceSpecificationElementCategoryName 40056 attribute.

The PriceSpecificationElementPurposeCode 40062 attribute is a PriceSpecificationElementPurposeCode 40066 data type. The PriceSpecificationElementPurposeCode 40062 attribute has a cardinality of 0 . . . 1 40064 meaning that for each instance of the PriceSpecification 40032 entity there may be one PriceSpecificationElementPurposeCode 40062 attribute.

The PriceSpecificationElementPurposeName 40068 attribute is a MEDIUM_Name 40072 data type. The PriceSpecificationElementPurposeName 40068 attribute has a cardinality of 0 . . . 1 40070 meaning that for each instance of the PriceSpecification 40032 entity there may be one PriceSpecificationElementPurposeName 40068 attribute.

The ConsistencyStatusCode 40074 attribute is a ConsistencyStatusCode 40078 data type. The ConsistencyStatusCode 40074 attribute has a cardinality of 0 . . . 1 40076 meaning that for each instance of the PriceSpecification 40032 entity there may be one ConsistencyStatusCode 40074 attribute.

The ConsistencyStatusName 40080 attribute is a MEDIUM_Name 40084 data type. The ConsistencyStatusName 40080 attribute has a cardinality of 0 . . . 1 40082 meaning that for each instance of the PriceSpecification 40032 entity there may be one ConsistencyStatusName 40080 attribute.

The ReleaseStatusCode 40086 attribute is a ReleaseStatusCode 40090 data type. The ReleaseStatusCode 40086 attribute has a cardinality of 0 . . . 1 40088 meaning that for each instance of the PriceSpecification 40032 entity there may be one ReleaseStatusCode 40086 attribute.

The ReleaseStatusName 40092 attribute is a MEDIUM_Name 40096 data type. The ReleaseStatusName 40092 attribute has a cardinality of 0 . . . 1 40094 meaning that for each instance of the PriceSpecification 40032 entity there may be one ReleaseStatusName 40092 attribute.

The BaseQuantity 40098 attribute is a Quantity 40102 data type. The BaseQuantity 40098 attribute has a cardinality of 0 . . . 1 40100 meaning that for each instance of the PriceSpecification 40032 entity there may be one BaseQuantity 40098 attribute.

The BaseQuantityTypeCode 40104 attribute is a QuantityTypeCode 40108 data type. The BaseQuantityTypeCode 40104 attribute has a cardinality of 0 . . . 1 40106 meaning that for each instance of the PriceSpecification 40032 entity there may be one BaseQuantityTypeCode 40104 attribute.

The BaseQuantityTypeName 40110 attribute is a MEDIUM_Name 40114 data type. The BaseQuantityTypeName 40110 attribute has a cardinality of 0 . . . 1 40112 meaning that for each instance of the PriceSpecification 40032 entity there may be one BaseQuantityTypeName 40110 attribute.

The Amount 40116 attribute is an Amount 40120 data type. The Amount 40116 attribute has a cardinality of 0 . . . 1 40118 meaning that for each instance of the PriceSpecification 40032 entity there may be one Amount 40116 attribute.

The Percent 40122 attribute is a Percent 40126 data type. The Percent 40122 attribute has a cardinality of 0 . . . 1 40124 meaning that for each instance of the PriceSpecification 40032 entity there may be one Percent 40122 attribute.

The ScaleExistsIndicator 40128 attribute is an Indicator 40132 data type. The ScaleExistsIndicator 40128 attribute has a cardinality of 0 . . . 1 40130 meaning that for each instance of the PriceSpecification 40032 entity there may be one ScaleExistsIndicator 40128 attribute.

The PropertyValuation 40134 node element grouping is a PriceSpecificationPropertyValuationElements 40140 data type. The PropertyValuation 40134 node element grouping includes a PropertyValuation 40136 entity.

The PropertyValuation 40136 entity has a cardinality of 0 . . . N 40138 meaning that for each instance of the PropertyValuation 40134 node element grouping there may be one or more PropertyValuation 40136 entities. The PropertyValuation 40136 entity includes various attributes, namely a PriceSpecificationElementPropertyValuation 40142 and a Description 40148.

The PriceSpecificationElementPropertyValuation 40142 attribute is a PriceSpecificationElementPropertyValuation 40146 data type. The PriceSpecificationElementPropertyValuation 40142 attribute has a cardinality of 1 40144 meaning that for each instance of the PropertyValuation 40136 entity there is one PriceSpecificationElementPropertyValuation 40142 attribute.

The Description 40148 attribute is a Description 40152 data type. The Description 40148 attribute has a cardinality of 1 40150 meaning that for each instance of the PropertyValuation 40136 entity there is one Description 40148 attribute.

The ScaleLine 40154 node element grouping is a PriceSpecificationScaleLine 40160 data type. The ScaleLine 40154 node element grouping includes a ScaleLine 40156 entity.

The ScaleLine 40154 node element grouping includes various node element groupings, namely a FirstDimensionScaleAxis Step 40192 and a SecondDimensionScaleAxisStep 40260.

The ScaleLine 40156 entity has a cardinality of 0 . . . N 40158 meaning that for each instance of the ScaleLine 40154 node element grouping there may be one or more ScaleLine 40156 entities. The ScaleLine 40156 entity includes various attributes, namely a BaseQuantity 40162, a BaseQuantityTypeCode 40168, a BaseQuantityTypeName 40174, an Amount 40180 and a Percent 40186.

The BaseQuantity 40162 attribute is a Quantity 40166 data type. The BaseQuantity 40162 attribute has a cardinality of 0 . . . 1 40164 meaning that for each instance of the ScaleLine 40156 entity there may be one BaseQuantity 40162 attribute.

The BaseQuantityTypeCode 40168 attribute is a QuantityTypeCode 40172 data type. The BaseQuantityTypeCode 40168 attribute has a cardinality of 0 . . . 1 40170 meaning that for each instance of the ScaleLine 40156 entity there may be one BaseQuantityTypeCode 40168 attribute.

The BaseQuantityTypeName 40174 attribute is a MEDIUM_Name 40178 data type. The BaseQuantityTypeName 40174 attribute has a cardinality of 0 . . . 1 40176 meaning that for each instance of the ScaleLine 40156 entity there may be one BaseQuantityTypeName 40174 attribute.

The Amount 40180 attribute is an Amount 40184 data type. The Amount 40180 attribute has a cardinality of 0 . . . 1 40182 meaning that for each instance of the ScaleLine 40156 entity there may be one Amount 40180 attribute.

The Percent 40186 attribute is a Percent 40190 data type. The Percent 40186 attribute has a cardinality of 0 . . . 1 40188 meaning that for each instance of the ScaleLine 40156 entity there may be one Percent 40186 attribute.

The FirstDimensionScaleAxisStep 40192 node element grouping is a ScaleAxisStep 40198 data type. The FirstDimensionScaleAxisStep 40192 node element grouping includes a FirstDimensionScaleAxisStep 40194 entity.

The FirstDimensionScaleAxisStep 40194 entity has a cardinality of 1 40196 meaning that for each instance of the FirstDimensionScaleAxisStep 40192 node element grouping there is one FirstDimensionScaleAxisStep 40194 entity. The FirstDimensionScaleAxisStep 40194 entity includes various attributes, namely a ScaleAxisBaseCode 40200, a ScaleAxisBaseName 40206, a ScaleAxisStepintervalBoundaryTypeCode 40212, a ScaleAxisStepIntervalBoundaryTypeName 40218, an Amount 40224, a Quantity 40230, a QuantityTypeCode 40236, a QuantityTypeName 40242, a DecimalValue 40248 and an IntegerValue 40254.

The ScaleAxisBaseCode 40200 attribute is a ScaleAxisBaseCode 40204 data type. The ScaleAxisBaseCode 40200 attribute has a cardinality of 1 40202 meaning that for each instance of the FirstDimensionScaleAxisStep 40194 entity there is one ScaleAxisBaseCode 40200 attribute.

The ScaleAxisBaseName 40206 attribute is a MEDIUM_Name 40210 data type. The ScaleAxisBaseName 40206 attribute has a cardinality of 1 40208 meaning that for each instance of the FirstDimensionScaleAxisStep 40194 entity there is one ScaleAxisBaseName 40206 attribute.

The ScaleAxisStepintervalBoundaryTypeCode 40212 attribute is a ScaleAxisStepintervalBoundaryTypeCode 40216 data type. The ScaleAxisStepintervalBoundaryTypeCode 40212 attribute has a cardinality of 1 40214 meaning that for each instance of the FirstDimensionScaleAxisStep 40194 entity there is one ScaleAxisStepintervalBoundaryTypeCode 40212 attribute.

The ScaleAxisStepintervalBoundaryTypeName 40218 attribute is a MEDIUM_Name 40222 data type. The ScaleAxisStepintervalBoundaryTypeName 40218 attribute has a cardinality of 1 40220 meaning that for each instance of the FirstDimensionScaleAxisStep 40194 entity there is one ScaleAxisStepintervalBoundaryTypeName 40218 attribute.

The Amount 40224 attribute is an Amount 40228 data type. The Amount 40224 attribute has a cardinality of 0 . . . 1 40226 meaning that for each instance of the FirstDimensionScaleAxis Step 40194 entity there may be one Amount 40224 attribute.

The Quantity 40230 attribute is a Quantity 40234 data type. The Quantity 40230 attribute has a cardinality of 0 . . . 1 40232 meaning that for each instance of the FirstDimensionScaleAxis Step 40194 entity there may be one Quantity 40230 attribute.

The QuantityTypeCode 40236 attribute is a QuantityTypeCode 40240 data type. The QuantityTypeCode 40236 attribute has a cardinality of 0 . . . 1 40238 meaning that for each instance of the FirstDimensionScaleAxisStep 40194 entity there may be one QuantityTypeCode 40236 attribute.

The QuantityTypeName 40242 attribute is a MEDIUM_Name 40246 data type. The QuantityTypeName 40242 attribute has a cardinality of 0 . . . 1 40244 meaning that for each instance of the FirstDimensionScaleAxisStep 40194 entity there may be one QuantityTypeName 40242 attribute.

The DecimalValue 40248 attribute is a DecimalValue 40252 data type. The DecimalValue 40248 attribute has a cardinality of 0 . . . 1 40250 meaning that for each instance of the FirstDimensionScaleAxisStep 40194 entity there may be one DecimalValue 40248 attribute.

The IntegerValue 40254 attribute is an IntegerValue 40258 data type. The IntegerValue 40254 attribute has a cardinality of 0 . . . 1 40256 meaning that for each instance of the FirstDimensionScaleAxisStep 40194 entity there may be one IntegerValue 40254 attribute.

The SecondDimensionScaleAxisStep 40260 node element grouping is a ScaleAxisStep 40266 data type. The SecondDimensionScaleAxisStep 40260 node element grouping includes a SecondDimensionScaleAxisStep 40262 entity.

The SecondDimensionScaleAxisStep 40262 entity has a cardinality of 0 . . . 1 40264 meaning that for each instance of the SecondDimensionScaleAxisStep 40260 node element grouping there may be one SecondDimensionScaleAxisStep 40262 entity. The SecondDimensionScaleAxisStep 40262 entity includes various attributes, namely a ScaleAxisBaseCode 40268, a ScaleAxisBaseName 40274, a ScaleAxisStepintervalBoundaryTypeCode 40280, a ScaleAxisStepintervalBoundaryTypeName 40286, an Amount 40292, a Quantity 40298, a QuantityTypeCode 40304, a QuantityTypeName 40310, a DecimalValue 40316 and an IntegerValue 40322.

The ScaleAxisBaseCode 40268 attribute is a ScaleAxisBaseCode 40272 data type. The ScaleAxisBaseCode 40268 attribute has a cardinality of 1 40270 meaning that for each instance of the SecondDimensionScaleAxisStep 40262 entity there is one ScaleAxisBaseCode 40268 attribute.

The ScaleAxisBaseName 40274 attribute is a MEDIUM_Name 40278 data type. The ScaleAxisBaseName 40274 attribute has a cardinality of 1 40276 meaning that for each instance of the SecondDimensionScaleAxisStep 40262 entity there is one ScaleAxisBaseName 40274 attribute.

The ScaleAxisStepintervalBoundaryTypeCode 40280 attribute is a ScaleAxisStepintervalBoundaryTypeCode 40284 data type. The ScaleAxisStepintervalBoundaryTypeCode 40280 attribute has a cardinality of 1 40282 meaning that for each instance of the SecondDimensionScaleAxisStep 40262 entity there is one ScaleAxisStepintervalBoundaryTypeCode 40280 attribute.

The ScaleAxisStepintervalBoundaryTypeName 40286 attribute is a MEDIUM_Name 40290 data type. The ScaleAxisStepintervalBoundaryTypeName 40286 attribute has a cardinality of 1 40288 meaning that for each instance of the SecondDimensionScaleAxisStep 40262 entity there is one ScaleAxisStepintervalBoundaryTypeName 40286 attribute.

The Amount 40292 attribute is an Amount 40296 data type. The Amount 40292 attribute has a cardinality of 0 . . . 1 40294 meaning that for each instance of the SecondDimensionScaleAxisStep 40262 entity there may be one Amount 40292 attribute.

The Quantity 40298 attribute is a Quantity 40302 data type. The Quantity 40298 attribute has a cardinality of 0 . . . 1 40300 meaning that for each instance of the SecondDimensionScaleAxisStep 40262 entity there may be one Quantity 40298 attribute.

The QuantityTypeCode 40304 attribute is a QuantityTypeCode 40308 data type. The QuantityTypeCode 40304 attribute has a cardinality of 0 . . . 1 40306 meaning that for each instance of the SecondDimensionScaleAxisStep 40262 entity there may be one QuantityTypeCode 40304 attribute.

The QuantityTypeName 40310 attribute is a MEDIUM_Name 40314 data type. The QuantityTypeName 40310 attribute has a cardinality of 0 . . . 1 40312 meaning that for each instance of the SecondDimensionScaleAxisStep 40262 entity there may be one QuantityTypeName 40310 attribute.

The DecimalValue 40316 attribute is a DecimalValue 40320 data type. The DecimalValue 40316 attribute has a cardinality of 0 . . . 1 40318 meaning that for each instance of the SecondDimensionScaleAxisStep 40262 entity there may be one DecimalValue 40316 attribute.

The IntegerValue 40322 attribute is an IntegerValue 40326 data type. The IntegerValue 40322 attribute has a cardinality of 0 . . . 1 40324 meaning that for each instance of the SecondDimensionScaleAxisStep 40262 entity there may be one IntegerValue 40322 attribute.

The Log 40328 node element grouping is a Log 40334 data type. The Log 40328 node element grouping includes a Log 40330 entity. The Log 40330 entity has a cardinality of 0 . . . 1 40332 meaning that for each instance of the Log 40328 node element grouping there may be one Log 40330 entity.

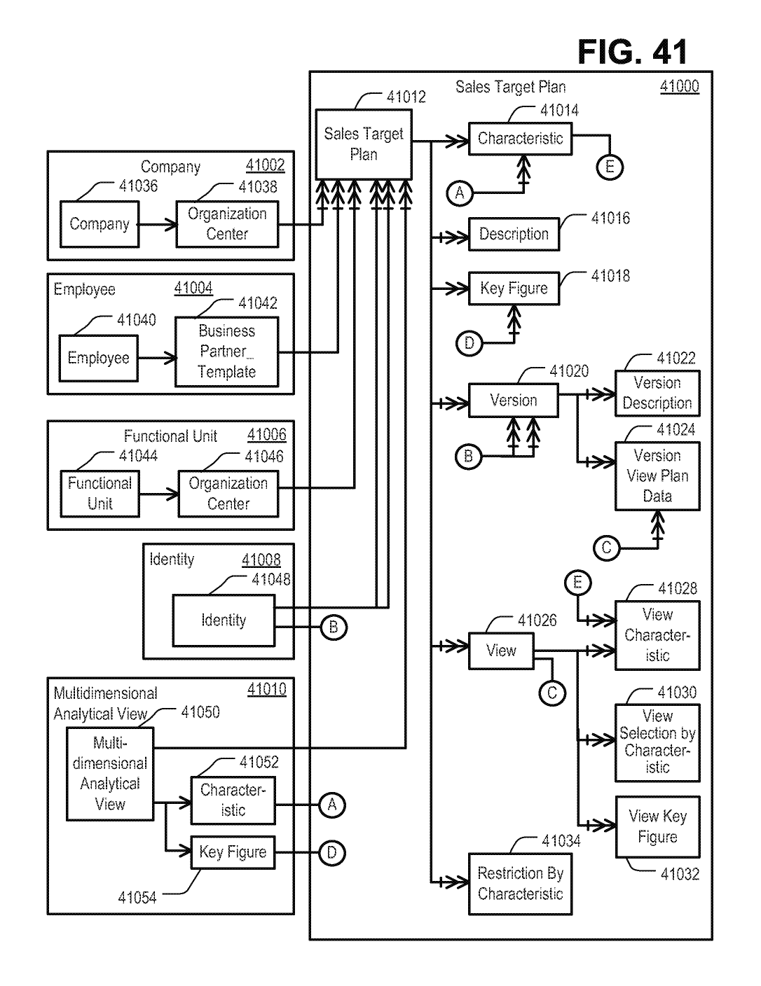

FIG. 41 illustrates an example object model for a Sales Target Plan business object 41000. Specifically, the object model depicts interactions among various components of the Sales Target Plan business object 41000, as well as external components that interact with the Sales Target Plan business object 41000 (shown here as 41002 through 41010 and 41036 through 41054). The Sales Target Plan business object 41000 includes elements 41012 through 41034. The elements 41012 through 41034 can be hierarchical, as depicted. For example, the Sales Target Plan entity hierarchically includes entities 41014 through 41020, 41026, and 41034. Some or all of the entities 41012 through 41034 can correspond to packages and/or entities in the message data types described below.

The business object Sales Target Plan is a plan that provides revenue targets for a particular sales unit and time horizon. The Sales Target Plan business object belongs to the process component Sales Planning The Sales Target Plan business object belongs to the deployment unit Customer Relationship Management. The business object Sales Target Plan has an object category of Key Figure Based Plan Object and a technical category of Standard Business Object. The business object Sales Target Plan represents a plan that projects sales target data for each sales unit of an organization for a specific time period of a fiscal year. The business object Sales Target Plan includes an identification, describing attributes, and a language-specific textual description. The business object Sales Target Plan incorporates characteristics and key figures that occur in plan data and in specifications of subsets of plan data records and versions. As an example, a sales target plan can be for a Sales Unit, for US Sales for a time horizon, for January to June of the calendar year 2010, where targets are distributed on Quarter 1 and Quarter 2, and related to product categories Radiators, Boilers and Service. As another example, a sales target plan can be a sales target for a sales unit for US sales for months from January to March for the year 2010.

The elements located directly at the node SalesTargetPlan are defined by the data type SalesTargetPlanElements. These elements include: UUID, SalesTargetPlanID, SalesUnitID, HorizonStartYearMonth, HorizonEndYearMonth, Status, MetaObjectKey, SystemAdministrativeData, ResponsibleEmployeeUUID, SalesUnitUUID, CompanyID, CompanyUUID, PlanningCurrencyCode, and SalesTargetPlanKey. MetaObjectKey may include MetaObjectKey/ProxyName and MetaObjectKeyNersionID. SalesTargetPlanKey may include SalesTargetPlanKey/SalesUnitID, SalesTargetPlanKey/HorizonStartYearMonth, and SalesTargetPlanKey/HorizonEndYearMonth. UUID may be optional may be an alternative key, is a globally unique identifier for a SalesTargetPlan, and may be based on datatype GDT: UUID. SalesTargetPlanID may be optional, may be an alternative key, is an identifier for a SalesTargetPlan, and may be based on datatype GDT: SalesTargetPlanID. SalesUnitID may be optional and may be based on datatype GDT: OrganisationalCentreID. HorizonStartYearMonth may be optional and may be based on datatype GDT: YearMonth. HorizonEndYearMonth may be optional and may be based on datatype GDT: YearMonth. Status may be optional, specifies the status of a Sales Target Plan, and may be based on datatype GDT: SalesTargetPlanStatus. MetaObjectKey may be optional and is a key of a Multidimensional Analytics View (MDAV) on which a SalesTargetPlan is based and that predefines key figures and characteristics that can be used by a SalesTargetPlan. MetaObjectKey may be based on datatype KDT: MetaObjectKey. MetaObjectKey/ProxyName may be optional, is a proxy name of a meta object, and may be based on datatype GDT: MetaObjectProxyName. MetaObjectKey/VersionID may be optional, is a version identifier of a meta object, and may be based on datatype GDT: MEDIUM_VersionID. An active version may have a version identifier of “SPACE”. A version referred by the Multidimensional Analytics View Key can be “version 0 active version”. A SalesTargetPlan as a type can be based on a specified Multidimensional Analytics View. Instances of a SalesTargetPlan can be created based on a specified MDAV. The key of a MDAV can be automatically set for each created instance. For example, the key of a MDAV have a same value “CRMSTPP” for all SalesTargetPlan instances. SystemAdministrativeData may be optional, includes administrative data that is stored in a system, such as system users and change dates/times, and may be based on datatype GDT: SystemAdministrativeData. ResponsibleEmployeeUUID may be optional, is a globally unique identifier for a person responsible for a plan, and may be based on datatype GDT: UUID. SalesUnitUUID may be optional, is a globally unique identifier for a sales unit, and may be based on datatype GDT: UUID. CompanyID may be optional, is an identifier for a company of a sales manager responsible for a plan, and may be based on datatype GDT: OrganisationalCentreID. CompanyUUID may be optional, is a globally unique identifier for a company, and may be based on datatype GDT: UUID. PlanningCurrencyCode may be optional and may be based on datatype GDT: CurrencyCode. SalesTargetPlanKey may be optional, may be an alternative key, is a grouping of elements that uniquely identifies a sales target plan by a sales unit identifier, horizon start, and horizon end, and may be based on datatype KDT: SalesTargetPlanKey. SalesTargetPlanKey/SalesUnitID may be optional, is an identifier for a sales unit, and may be based on datatype GDT: OrganisationalCentreID. SalesTargetPlanKey/HorizonStartYearMonth may be optional, is a point in time at which a horizon starts, and may be based on datatype GDT: YearMonth. SalesTargetPlanKey/HorizonEndYearMonth may be optional, is a point in time at which a horizon ends, and may be based on datatype GDT: YearMonth.

The following composition relationships to subordinate nodes may exist: Characteristic, in a 1:N cardinality relationship; Description, in a 1:CN cardinality relationship, which may be a text composition; Key Figure, in a 1:N cardinality relationship; Version, in a 1:CN cardinality relationship; View, in a 1:CN cardinality relationship; and Restriction By Characteristic, in a 1:CN cardinality relationship. The following composition relationships to dependent objects may exist: AccessControlList, with a cardinality of 1:1. The following inbound association relationships may exist: Company, from the business object Company/node Organisational Centre, with a cardinality of 1:CN; Employee, from the business object Employee/node Business Partner:Template, with a cardinality of 1:CN; SalesUnit, from the business object Functional Unit/node Organisational Centre, with a cardinality of 1:CN; CreationIdentity, from the business object Identity/node Identity, with a cardinality of 1:CN; LastChangeIdentity, from the business object Identity/node Identity, with a cardinality of 1:CN; and Multidimensional Analytical View, from the business object Multidimensional Analytical View/node Multidimensional Analytical View, with a cardinality of 1:CN.

The following actions may exist: Create Plan with Reference, Set In Preparation, and Flag As Active. A Select All query may be used to return the node identifiers of all instances of the root node. A Query By Elements query may be used to return a list of all sales target plans according to specified selection elements. The query elements are defined by the data type SalesTargetPlanElementsQueryElements. These elements include: UUID, SalesTargetPlanID, Description, SearchText, SalesUnitID, HorizonStartYearMonth, and HorizonEndYearMonth. UUID is a globally unique identifier for a sales target plan, and may be based on datatype GDT: UUID. SalesTargetPlanID is an identifier for a sales target plan, and may be based on datatype GDT: SalesTargetPlanID. Description is a description of a sales target plan, and may be based on datatype GDT: LONG_Description. SearchText includes free text including one or several words which may be used to search for information about a sales target plan, and may be based on datatype GDT: SearchText. SalesUnitID may be based on datatype GDT: OrganisationalCentreID. HorizonStartYearMonth may be based on datatype GDT: YearMonth. HorizonEndYearMonth may be based on datatype GDT: YearMonth.

Characteristic is a characteristic that can be used to distinguish plan data of a SalesTargetPlan. A characteristic is a field according to which values are selected. Characteristics can be alphanumeric, numeric, or text values. Examples include Product ID, Supplier, and Purchase Order Status. The characteristics included in a SalesTargetPlan are typical characteristics in a Sales Target Plan to which a SalesTargetPlan belongs. The characteristics of a SalesTargetPlan can be predefined by characteristics of a Multidimensional Analytics View “CRMSTPP”. The Characteristic node can be automatically created on instance creation of a SalesTargetPlan. In some implementations, a characteristic of a Multidimensional Analytics View does not occur in plan data of a SalesTargetPlan. Therefore, it can be specified whether a characteristic is used or not by a SalesTargetPlan. Example characteristics include Employees, Account, Product Category, and Product. The elements located directly at the node Characteristic are defined by the data type SalesTargetPlanCharacteristicElements. These elements include: UUID, MultidimensionalAnalyticalViewCharacteristicKey, and UsedIndicator. MultidimensionalAnalyticalViewCharacteristicKey may include MultidimensionalAnalyticalViewCharacteristicKey/MultidimensionalAnalyticalViewElemen tKey and MultidimensionalAnalyticalViewCharacteristicKey/MultidimensionalAnalyticalViewElemen tKey/ProxyName. UUID may be optional, may be an alternative key, is a globally unique identifier for a characteristic, and may be based on datatype GDT: UUID. MultidimensionalAnalyticalViewCharacteristicKey may be optional, is a key of a Multidimensional Analytics View characteristic that defines a Characteristic node in a SalesTargetPlan, and may be based on datatype KDT: MultidimensionalAnalyticalViewCharacteristicKey. MultidimensionalAnalyticalViewCharacteristicKey/MultidimensionalAnalyticalViewElemen tKey may be optional and may be based on datatype KDT: MultidimensionalAnalyticalViewElementKey. MultidimensionalAnalyticalViewCharacteristicKey/MultidimensionalAnalyticalViewElemen tKey/ProxyName may be optional and may be based on datatype GDT: MetaObjectProxyName. MultidimensionalAnalyticalViewCharacteristicKey/ProxyName may be optional and may be based on datatype GDT: MetaObjectProxyName. In some implementations, characteristics of a Multidimensional Analytics View ‘CRMSTPP’ that is referred to at a root node can occur. A key can be automatically set on instance creation of a Characteristic. A key of a Characteristic can have a same value and can be set across all created SalesTargetPlan instances. UsedIndicator may be optional, is an indicator that specifies whether or not a characteristic can be used to distinguish plan data of a SalesTargetPlan, and may be based on datatype GDT: Indicator. In some implementations, if an Indicator is set to false, a characteristic is not filled and cannot be filled in plan data of a SalesTargetPlan.

A MultidimensionalAnalyticalViewCharacteristic inbound association relationship may exist from the business object Multidimensional Analytical View/node Characteristic, in a 1:CN cardinality relationship, which is a Multidimensional Analytics View characteristic that defines a Characteristic node. The following specialization associations for navigation may exist to the node SalesTargetPlan: Parent, with a target cardinality of 1; and Root, with a target cardinality of 1.

Description Text Node is a language-dependent textual description of a SalesTargetPlan. The elements located directly at the node Description are defined by the data type SalesTargetPlanDescriptionElements. These elements include Description, which is a language-dependent textual description of a SalesTargetPlan that may be based on datatype GDT: LONG_Description. The following specialization associations for navigation may exist to the node SalesTargetPlan: Parent, with a target cardinality of 1; and Root, with a target cardinality of 1.

Key Figure is a key figure that can be projected in a plan. A key figure is a field according to which values can be selected. Key figures can be numeric values that have a unit of measure or currency assigned. Examples include Invoice Net Value and Purchase Order Quantity. The key figures included in a SalesTargetPlan can be typical key figures in the Sales Target Plan to which the SalesTargetPlan belongs. The key figures of a SalesTargetPlan can be predefined by key figures of a Multidimensional Analytics View ‘CRMSTPP’. The Key Figure node can be automatically created on instance creation of a SalesTargetPlan. An example Key Figure is Target Amount. The elements located directly at the node Key Figure are defined by the data type SalesTargetPlanKeyFigureElements. These elements include: UUID, MultidimensionalAnalyticalViewKeyFigureKey, and DefaultDistributionMethodCode. MultidimensionalAnalyticalViewKeyFigureKey may include MultidimensionalAnalyticalViewKeyFigureKey/ViewElementKey and MultidimensionalAnalyticalViewKeyFigureKey/ProxyName. MultidimensionalAnalyticalViewKeyFigureKey/ViewElementKey may include MultidimensionalAnalyticalViewKeyFigureKeyNiewElementKey/ProxyName. UUID may be optional, may be an alternative key, is a globally unique identifier for a key figure, and may be based on datatype GDT: UUID. MultidimensionalAnalyticalViewKeyFigureKey may be optional, is a key of a Multidimensional Analytics View Key Figure that defines a Key Figure node, and may be based on datatype KDT: MultidimensionalAnalyticalViewKeyFigureKey. MultidimensionalAnalyticalViewKeyFigureKey/ViewElementKey may be optional and may be based on datatype KDT: MultidimensionalAnalyticalViewElementKey. MultidimensionalAnalyticalViewKeyFigureKeyNiewElementKey/ProxyName may be optional and may be based on datatype GDT: MetaObjectProxyName. MultidimensionalAnalyticalViewKeyFigureKey/ProxyName may be optional and may be based on datatype GDT: MetaObjectProxyName. In some implementations, only key figures of a Multidimensional Analytics View ‘CRMSTPP’, which is referred to at a root node, can occur using the proxy name. A key can be automatically set on instance creation of a Key Figure node and a key of a Key Figure can have a same value set across all created SalesTargetPlan instances. DefaultDistributionMethodCode may be optional and may be based on datatype GDT: PlanningKeyFigureDistributionMethodCode. In some implementations, DefaultDistributionMethodCode can be a coded representation of a distribution method to be used for key figure values that are entered on an aggregated level.

The following inbound association relationships may exist: MultidimensionalAnalyticalViewKeyFigure, from the business object Multidimensional Analytical View/node Key Figure, with a cardinality of 1:CN, which is a Multidimensional Analytics View Key Figure that defines a Key Figure node. In some implementations, a referred Multidimensional Analytics View is active version 0. The following specialization associations for navigation may exist to the node SalesTargetPlan: Parent, with a target cardinality of 1; and Root, with a target cardinality of 1.

Version is a definite state during a planning process or a definite set of assumptions for which plan data can be kept. Versions can be used to distinguish newer from older plan data. New versions may be created to keep a snapshot or backup of a preceding state during a planning process for later regress to preceding data or for auditing or analysis purposes. Versions can also be created to separate plan data from each other that are based on different assumptions and that therefore differ in the values of key figures. The elements located directly at the node Version are defined by the data type SalesTargetPlanVersionElements. These elements include: UUID, ID, ActiveIndicator, and SystemAdministrativeData. UUID may be an alternative key, is a globally unique identifier for a version, and may be based on datatype GDT: UUID. ID is an identifier for a version, and may be based on datatype GDT: VersionID. ActiveIndicator may be optional, specifies whether a Plan Version is active, and may be based on datatype GDT: Indicator. SystemAdministrativeData includes administrative data that is stored in a system, such as system users and change dates/times, and may be based on datatype GDT: SystemAdministrativeData.

The following composition relationships to subordinate nodes may exist: Version Description, with a cardinality of 1:CN, which may be a text composition; and Version View Plan Data, with a cardinality of 1:CN, which may be filtered, where the filter elements may be defined by the datatype SalesTargetPlanVersionViewPlanDataFilterElements. These elements include ViewUUID, which may be optional and may be based on datatype GDT: UUID. The following inbound association relationships may exist: VersionCreationIdentity, from the business object Identity/node Identity, with a cardinality of 1:CN; and VersionLastChangeIdentity, from the business object Identity/node Identity, with a cardinality of 1:CN. The following specialization associations for navigation may exist to the node SalesTargetPlan: Parent, with a target cardinality of 1; and Root, with a target cardinality of 1.

A CreateTestData action may be used to create test data for a particular version of a plan. In some implementations, a report can be provided in later stages and the CreateTestData action can be removed and not planned for shipment to a customer. Changes to the object can include characteristic value combinations being generated for master data available in the system and being copied to a version of a plan on which the action is triggered. The action elements for the CreateTestData action are defined by the data type SalesTargetPlanVersionCreateTestDataActionElements. These elements include CreateMassDataIndicator, which may be optional, is an indicator that specifies whether or not mass data is to be created, and may be based on datatype GDT: Indicator. A CreatePlanDataFromReference action may be used to copy a historical data target, sales order actual, invoiced actual, and/or opportunity forecast from an existing plan version or versions for specified time ranges by a user to an existing version. A precondition can exist such that a date range selection does not overlap for an actual data sales order or invoice data, opportunity forecast data, and target data from which data is to be copied. Changes to the object can include values of individual plan data being created with data that is copied for a referenced version or versions. The action elements for the CreatePlanDataFromReference action are defined by thedata type SalesTargetPlanVersionCreatePlanDataFromReferenceActionElements. These elements include: ReferencePlanHorizonStartYearMonth, ReferencePlanHorizonEndYearMonth, ReferenceSourceVersionUUID, ReferencelnvoicePeriod, ReferenceSalesOrderPeriod, and ReferenceOpportunityPeriod. ReferencePlanHorizonStartYearMonth may be optional, represents a start year month for which target data is to be copied from reference plan versions, and may be based on datatype GDT: YearMonth. ReferencePlanHorizonEndYearMonth may be optional, represents an end year month for which target data is to be copied from reference plan versions, and may be based on datatype GDT: YearMonth. ReferenceSourceVersionUUID may be optional and may be based on datatype GDT: UUID. ReferencelnvoicePeriod may be optional, represents a date period for which invoiced actual data is to be copied from reference plan versions, and may be based on datatype GDT: DatePeriod. ReferenceSalesOrderPeriod may be optional, represents a date period for which sales order actual data is to be copied from reference plan versions, and may be based on datatype GDT: DatePeriod. ReferenceOpportunityPeriod may be optional, represents a date period for which an opportunity forecast data is to be copied from reference plan versions, and may be based on datatype GDT: DatePeriod.

A CreateCharacteristicValueCombinations action may be used to create target data in a version using a combination of characteristics that are specified as planning dimensions. The values of individual plan data can be created with initial values for combinations that are generated out of characteristics specified as planning dimensions. The action elements for the CreateCharacteristicValueCombinations action can be defined by the data type SalesTargetPlanVersionCreateCVCActionElements. These elements include CVCCreationModeValue, which may be optional and may be based on datatype GDT: NONNEGATIVE_IntegerValue.

A Query By Elements query may be used to return a list of all sales target plan versions according to specified selection elements. The query elements are defined by the data type SalesTargetPlanVersionElementsQueryElements. These elements include: UUID, ID, Description, SalesTargetPlanID, SalesTargetPlanUUID, ReportingStatusIndicator, SalesTargetPlanSalesUnitUUID, and PlanStatus. UUID is a globally unique identifier for a sales target plan version, and may be based on datatype GDT: UUID. ID is an identifier for a sales target plan version, and may be based on datatype GDT: VersionID. Description is a description of a sales target plan version, and may be based on datatype GDT: LONG_Description. SalesTargetPlanID is an identifier for a sales target plan, and may be based on datatype GDT: SalesTargetPlanID. SalesTargetPlanUUID is a globally unique identifier for a sales target plan, and may be based on datatype GDT: UUID. ReportingStatusIndicator may be based on datatype GDT: Indicator. SalesTargetPlanSalesUnitUUID may be based on datatype GDT: UUID. PlanStatus may be based on datatype GDT: SalesTargetPlanStatus.

Version Description Text Node is a language-dependent textual description of a version. The elements located directly at the node Version Description are defined by the data type SalesTargetPlanVersionDescriptionElements. These elements include Description, which is a description of a version and may be based on datatype GDT: LONG_Description. The following specialization associations for navigation may exist: Root, to the node SalesTargetPlan, with a target cardinality of 1; and Parent, to the node Version, with a target cardinality of 1.

Version View Plan Data includes plan data that is valid for a version and that fulfills a specification given by a view. Version View Plan Data includes projected key figure values and refers to instances of several characteristics. A projected key figure value of a Version View Plan Data Record can be the aggregated value of a projected key figure from a subset of individual plan data records. Version View Plan Data can result from a query execution. Aggregates can be calculated as needed and may not be stored in a query engine. The elements located directly at the node Version View Plan Data are defined by the data type SalesTargetPlanVersionViewPlanDataElements. These elements include: ProcessingOrdinalNumberValue, ViewUUID, Key, SalesUnitUUID, EmployeeUUID, ProductCategoryUUID, ProductUUID, CustomerUUID, and LocalCurrencyTargetAmount. Key may include KeyNersionUUID, Key/ViewUUID, Key/SalesUnitID, Key/EmployeeID, Key/CustomerID, Key/ProductCategoryHierarchyProductCategoryIDKey, Key/ProductKey, and Key/PlanYearMonthID. Key/ProductCategoryHierarchyProductCategoryIDKey may include Key/ProductCategoryHierarchyProductCategoryIDKey/ProductCategoryHierarchyID and Key/ProductCategoryHierarchyProductCategoryIDKey/ProductCategoryInternalID. Key/ProductKey may include Key/ProductKey/ProductTypeCode, Key/ProductKey/ProductidentifierTypeCode, and Key/ProductKey/ProductID. ProcessingOrdinalNumberValue may be optional, is a value that indicates a position of view plan data during distribution processing, and may be based on datatype GDT: OrdinalNumberValue. ViewUUID may be optional, is a globally unique identifier for a view that specifies an extent of a version view plan data, and may be based on datatype GDT: UUID. Key may be optional, may be an alternative key and is a grouping of elements that uniquely identifies version view plan data by version ID, view ID, sales unit ID, employee ID, customer ID, and product category hierarchy product category ID. Key may be based on datatype KDT: SalesTargetPlanVersionViewPlanDataKey. KeyNersionUUID may be optional, is a globally unique identifier for a version, and may be based on datatype GDT: UUID. Key/ViewUUID may be optional, is a globally unique identifier for a view, and may be based on datatype GDT: UUID. Key/SalesUnitID may be optional, is an identifier for a sales unit, and may be based on datatype GDT: OrganisationalCentreID. Key/EmployeeID may be optional, is an identifier for an employee, and may be based on datatype GDT: EmployeeID. Key/CustomerID may be optional, is an identifier for a customer, and may be based on datatype GDT: BusinessPartnerInternalID. Key/ProductCategoryHierarchyProductCategoryIDKey may be optional, is a grouping of elements that uniquely identifies a product category hierarchy product category ID by product category hierarchy ID and product category internal ID, and may be based on datatype KDT: ProductCategoryHierarchyProductCategoryIDKey.

Key/ProductCategoryHierarchyProductCategoryIDKey/ProductCategoryHierarchyID may be optional, is an identifier for a product category hierarchy, and may be based on datatype GDT: ProductCategoryHierarchyID.

Key/ProductCategoryHierarchyProductCategoryIDKey/ProductCategoryInternalID may be optional, is an identifier for a product category, and may be based on datatype GDT: ProductCategorylnternalID. Key/ProductKey may be optional, is a grouping of elements that uniquely identifies a product by product type, product identifier type, and product ID, and may be based on datatype KDT: ProductKey. Key/ProductKey/ProductTypeCode may be optional, is a coded representation of a product type such as a material or service, and may be based on datatype GDT: ProductTypeCode. Key/ProductKey/ProductidentifierTypeCode may be optional, is a coded representation of a product identifier type, and may be based on datatype GDT: ProductidentifierTypeCode. Key/ProductKey/ProductID may be optional, is an identifier for a product, and may be based on datatype GDT: ProductID. Key/PlanYearMonthID may be optional and may be based on datatype GDT: YearMonthID. SalesUnitUUID may be optional, is a globally unique identifier for a sales unit, and may be based on datatype GDT: UUID. EmployeeUUID may be optional, is a globally unique identifier for an employee, and may be based on datatype GDT: UUID. ProductCategoryUUID may be optional, is a globally unique identifier for a product category, and may be based on datatype GDT: UUID. ProductUUID may be optional, is a globally unique identifier for a product, and may be based on datatype GDT: UUID. CustomerUUID may be optional, is a globally unique identifier for a customer, and may be based on datatype GDT: UUID. LocalCurrencyTargetAmount may be optional, is a currency in which a target is stated, and may be based on datatype GDT: Amount.

A View inbound association relationship may exist from the business object Sales Target Plan/node View, with a cardinality of 1:CN, which is a view that specifies an extent of the Version View Plan Data. The following specialization associations for navigation may exist: Root, to the node SalesTargetPlan, with a target cardinality of 1; and Parent, to the node Version, with a target cardinality of 1.

A Reevaluate action may be used to change a projected key figure value of a version view plan data by a percentage. In some implementations, the Reevaluate action cannot be executed for several version view plan data simultaneously if some data includes aggregated key figure values with respect to other data. The values of the individual plan data records can be changed by a given percentage. As a side effect, other key figure values of intermediate aggregation levels can change as well if they aggregate the same individual plan data records. The action elements for the Reevaluate action are defined by the data type SalesTargetPlanVersionViewPlanDataReevaluateActionElements. These elements include ChangePercent, which may be optional, is a change in a key figure value given in percent, may be based on datatype GDT: MEDIUM_Percent, and can be a positive or negative percent value by which a projected key figure value is changed.

A Distribute Equally action can be used to distribute a current value of a projected key figure equally to individual plan data records. The values of individual plan data records can be overwritten with equal portions of a current value of a projected key figure. As a side effect, other key figure values of intermediate aggregation levels can change as well if they aggregate the same individual plan data records. The action elements for the Distribute Equally action are defined by the data type SalesTargetPlanVersionViewPlanDataDistributeEquallyActionElements.

View is a stored specification of a subset of plan data records. View can specify a selection of characteristics and filter criteria for characteristics values. By selecting characteristics in a view, an aggregation level can be implicitly defined because characteristics that are not visible in a plan data sheet of a view are hidden by aggregation. The elements located directly at the node View are defined by the data type SalesTargetPlanViewElements. These elements include UUID, which may be an alternative key, is a globally unique identifier of a view, and may be based on datatype GDT: UUID.

The following composition relationships to subordinate nodes exist: View Characteristic, with a cardinality of 1:CN; View Selection by Characteristic, with a cardinality of 1:CN; and View Key Figure, with a cardinality of 1:CN. The following specialization associations for navigation may exist to the node SalesTargetPlan: Parent, with a target cardinality of 1; and Root, with a target cardinality of 1. A Version View Plan Data association may exist to the node Version View Plan Data, with a target cardinality of CN, which includes Version View Plan Data for which a View specifies an extent. In some implementations, once a view is defined, the selection of the characteristics can no longer be changed.

A Query By Elements query may be used to return a list of all views according to a specified selection on a sales target plan business object, ViewKeyFigures, ViewCharacteristics and a ViewSelectionByCharacteristic. The query elements are defined by the data type SalesTargetPlanViewElementsQueryElements. These elements include: SalesTargetPlanUUID, SalesTargetPlanID, SalesTargetPlanCharacteristicUUID SalesTargetPlanCharacteristicMultidimensionalAnalyticalViewElementStructureCharacteristicProxyName, SalesTargetPlanKeyFigureUUID, SalesTargetPlanKeyFigureMultidimensionalAnalyticalViewElementStructureKeyFigureProxyName, SalesTargetPlanViewSelectionByCharacteristicVersionID, SalesTargetPlanViewSelectionByCharacteristicVersionUUID, SalesUnitID, EmployeeID, CustomerID, ProductCategoryHierarchyProductCategoryIDKey, ProductKey, PlanYearMonth, PlanSalesUnitUUID, VersionStatusIndicator, EmployeeUUID, CustomerUUID, ProductUUID, ProductCategoryUUID, and PlanLifeCycle Status. ProductCategoryHierarchyProductCategoryIDKey may include ProductCategoryHierarchyProductCategoryIDKey/ProductCategoryHierarchyID and ProductCategoryHierarchyProductCategoryIDKey/ProductCategoryInternalID. ProductKey may include ProductKey/ProductTypeCode, ProductKey/ProductidentifierTypeCode, and ProductKey/ProductID. SalesTargetPlanUUID is a globally unique identifier for a sales target plan, and may be based on datatype GDT: UUID. SalesTargetPlanID is an identifier for a sales target plan, and may be based on datatype GDT: SalesTargetPlanID. SalesTargetPlanCharacteristicUUID is a globally unique identifier for a sales target plan characteristic, and may be based on datatype GDT: UUID. SalesTargetPlanCharacteristicMultidimensionalAnalyticalViewElementStructureCharacteristicProxyName may be based on datatype GDT: MetaObjectProxyName. SalesTargetPlanKeyFigureUUID is a globally unique identifier for a sales target plan key figure, and may be based on datatype GDT: UUID. SalesTargetPlanKeyFigureMultidimensionalAnalyticalViewElementStructureKeyFigureProxyName may be based on datatype GDT: MetaObjectProxyName. SalesTargetPlanViewSelectionByCharacteristicVersionID is an identifier for a version that is referred to in a ViewSelectionByCharacteristic, and may be based on datatype GDT: VersionID. SalesTargetPlanViewSelectionByCharacteristicVersionUUID is an identifier for a version UUID that is referred to in a ViewSelectionByCharacteristic, and may be based on datatype GDT: UUID. SalesUnitID is an identifier for a sales unit, and may be based on datatype GDT: OrganisationalCentreID. EmployeeID is an identifier for an employee, and may be based on datatype GDT: EmployeeID. CustomerID is an identifier for a customer, and may be based on datatype GDT: BusinessPartnerinternalID. ProductCategoryHierarchyProductCategoryIDKey may be based on datatype KDT: ProductCategoryHierarchyProductCategoryIDKey. ProductCategoryHierarchyProductCategoryIDKey/ProductCategoryHierarchyID is an identifier for a product category hierarchy, and may be based on datatype GDT: ProductCategoryHierarchyID. ProductCategoryHierarchyProductCategoryIDKey/ProductCategoryinternalID is an identifier for a product category, and may be based on datatype GDT: ProductCategoryinternalID. ProductKey is a grouping of elements that uniquely identifies a product by product type, product identifier type, and product ID, and may be based on datatype KDT: ProductKey. ProductKey/ProductTypeCode is a coded representation of a product type such as a material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: ProductID. PlanYearMonth is an identifier for a month, and may be based on datatype GDT: YearMonth. PlanSalesUnitUUID may be based on datatype GDT: UUID. VersionStatusIndicator may be based on datatype GDT: Indicator. EmployeeUUID may be based on datatype GDT: UUID. CustomerUUID may be based on datatype GDT: UUID. ProductUUTD may be based on datatype GDT: UUID. ProductCategoryUUTD may be based on datatype GDT: UUID. PlanLifeCycleStatus may be based on datatype GDT: SalesTargetPlanStatus.

View Characteristic is a characteristic of a sales target plan that is selected by a view. The elements located directly at the node View Characteristic are defined by the data type SalesTargetPlanViewCharacteristicElements. These elements include CharacteristicUUID, which is a globally unique identifier for a selected sales target plan characteristic, and may be based on datatype GDT: UUID.

A Characteristic inbound aggregation relationship may exist from the business object Sales Target Plan/node Characteristic, with a cardinality of 1:CN, which is a SalesTargetPlan characteristic that is selected. The following specialization associations for navigation may exist: Root, to the node SalesTargetPlan, with a target cardinality of 1; and Parent, to the node View, with a target cardinality of 1.

View Selection by Characteristic includes identifier values for a characteristic for selecting plan data. View Selection By Characteristic can be used to extract those records that fulfill specified selection criteria and to restrict possible input values for a characteristic during the maintenance of plan data. In the View Selection By Characteristic, a subset of the values of a characteristic can be selected, such as attributes, identifiers, and statuses. The elements located directly at the node View Selection by Characteristic are defined by the data type SalesTargetPlanViewSelectionByCharacteristicElements. These elements include: CharacteristicUUID, InclusionExclusionCode, IntervalBoundaryTypeCode, LowerBoundaryCharacteristicObjectNodeFormattedID, and UpperBoundaryCharacteristicObjectNodeFormattedID. CharacteristicUUID is a globally unique identifier for a sales target plan characteristic whose values are specified as filter criteria, and may be based on datatype GDT: UUID. InclusionExclusionCode may be optional, is a code to determine whether a result set of an interval selection is included into an entire result set, and may be based on datatype GDT: InclusionExclusionCode. IntervalBoundaryTypeCode may be optional, is a coded representation of a boundary type of an interval used for selection of plan data, and may be based on datatype GDT: IntervalBoundaryTypeCode. LowerBoundaryCharacteristicObjectNodeFormattedID may be optional, is a formatted, human-readable identifier of an instance of an object which corresponds to a characteristic, may serve as a lower boundary value of an interval condition for the selection of plan data, and may be based on datatype GDT: ObjectNodeFormattedID. UpperBoundaryCharacteristicObjectNodeFormattedID may be optional, is a formatted, human-readable identifier of an instance of an object which corresponds to a characteristic, may serve as a upper boundary value of an interval condition for selection of plan data, and may be based on datatype GDT: ObjectNodeFormattedID. A Characteristic inbound aggregation relationship may exist from the business object Sales Target Plan/node Characteristic, with a cardinality of 1:CN, which is a SalesTargetPlan characteristic whose values are specified as filter criteria. The following specialization associations for navigation may exist: Root, to the node SalesTargetPlan, with a target cardinality of 1; and Parent, to the node View, with a target cardinality of 1.

View Key Figure is a key figure of a sales target plan that is selected by a view. The elements located directly at the node View Key Figure are defined by the data type SalesTargetPlanViewKeyFigureElements. These elements include KeyFigureUUID, which is a globally unique identifier for a sales target plan key figure that is selected, and may be based on datatype GDT: UUID. A Key Figure inbound aggregation relationship may exist from the business object Sales Target Plan/node Key Figure, with a cardinality of 1:CN. The following specialization associations for navigation may exist: Root, to the node SalesTargetPlan, with a target cardinality of 1; and Parent, to the node View, with a target cardinality of 1.

Restriction By Characteristic is a set of filtering options that can be used to restrict the number of value combinations to be generated. For example, a characteristic employee can be restricted to values ‘Employee 1’, ‘Employee 2’, etc. The elements located directly at the node Restriction By Characteristic are defined by the data type SalesTargetPlanRestrictionByCharacteristicElements. These elements include: CharacteristicUUID, InclusionExclusionCode, IntervalBoundaryTypeCode, LowerBoundaryCharacteristicObjectNodeFormattedID, and UpperBoundaryCharacteristicObjectNodeFormattedID. CharacteristicUUID is a globally unique identifier for a characteristic on which one or more filters are defined, and may be based on datatype GDT: UUID. InclusionExclusionCode may be optional, is a code to determine whether a result set of an interval selection is included into an entire result set, and may be based on datatype GDT: InclusionExclusionCode. IntervalBoundaryTypeCode may be optional, is a coded representation of a boundary type of an interval used for selection of plan data, and may be based on datatype GDT: IntervalBoundaryTypeCode. LowerBoundaryCharacteristicObjectNodeFormattedID may be optional, is a formatted, human-readable identifier of an instance of an object which corresponds to a characteristic, may serve as a lower boundary value of an interval condition for selection of plan data, and may be based on datatype GDT: ObjectNodeFormattedID. UpperBoundaryCharacteristicObjectNodeFormattedID may be optional, is a formatted, human-readable identifier of an instance of an object which corresponds to a characteristic, may serve as an upper boundary value of an interval condition for selection of plan data, and may be based on datatype GDT: ObjectNodeFormattedID. The following specialization associations for navigation may exist to the node SalesTargetPlan: Parent, with a target cardinality of 1; and Root, with a target cardinality of 1.

A number of implementations have been described. Nevertheless, it will be understood that various modifications may be made without departing from the spirit and scope of the disclosure. Accordingly, other implementations are within the scope of the following claims.

1. A non-transitory computer readable medium including program code for providing a message-based interface for exchanging campaign response options, the program code capable of execution by a processor, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification of a response option that specifies how a customer who has been contacted as part of a campaign can respond to the campaign, the first message derived from the common business object model and including a first message package hierarchically organized as:
a campaign response option message entity; and
a campaign response option package comprising a campaign response option entity, where the campaign response option entity includes a universally unique identifier (UUID), an identifier (ID), a status, and a life cycle status code;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

2. The computer readable medium of claim 1, wherein the campaign response option package further comprises at least one of the following: an overview package and a description package.

3. The computer readable medium of claim 1, wherein the campaign response option entity further includes at least one of the following: a category code and system administrative data.

4. A distributed system operating in a landscape of computer systems providing message-based services defined in a service registry, the system comprising:
a graphical user interface comprising computer readable instructions, embedded on tangible media, for providing a notification of a response option that specifies how a customer who has been contacted as part of a campaign can respond to the campaign, using a request;
a first memory storing a user interface controller for processing the request and involving a message including a message package derived from a common business object model, where the common business object model includes business objects having relationships that enable derivation of message-based service interfaces and message packages, the message package hierarchically organized as:
a campaign response option message entity; and
a campaign response option package comprising a campaign response option entity, where the campaign response option entity includes a universally unique identifier (UUID), an identifier (ID), a status, and a life cycle status code; and
a second memory, remote from the graphical user interface, storing a plurality of message-based service interfaces, where one of the service interfaces is operable to process the message via the service interface, where processing the message includes unpacking the first message package based on the common business object model.

5. The distributed system of claim 4, wherein the first memory is remote from the graphical user interface.

6. The distributed system of claim 4, wherein the first memory is remote from the second memory.

7. A computer readable medium including program code for providing a message-based interface for exchanging sales price list information, the medium comprising:
program code for receiving via a message-based interface exposing at least one service as defined in a service registry and from a heterogeneous application executing in an environment of computer systems providing message-based services, a first message for a synchronous request for finding a sales price list by its type code, property identifier (ID) and property value that includes a message package hierarchically organized as:
a sales price list find by type code and property ID and property value query message entity; and
a sales price list package comprising a sales price list entity; and
program code for sending a second message to the heterogeneous application responsive to the first message.

8. The computer readable medium of claim 7, wherein the sales price list entity includes at least one of the following: an ID, a release status code, a price specification list release status code, an approval status code, a consistency status code, a validity period, a creation date time interval, a last changed datetime interval, a type code, a first property valuation price specification element property valuation, a second property valuation price specification element property valuation, a third property valuation price specification element property valuation, a fourth property valuation price specification element property valuation, a fifth property valuation price specification element property valuation, a sixth property valuation price specification element property valuation, a seventh property valuation price specification element property valuation, an eighth property valuation price specification element property valuation, a ninth property valuation price specification element property valuation, a tenth property valuation price specification element property valuation, a first price specification property valuation price specification element property valuation, a second price specification property valuation price specification element property valuation, a third price specification property valuation price specification element property valuation, a fourth price specification property valuation price specification element property valuation, a fifth price specification property valuation price specification element property valuation, a sixth price specification property valuation price specification element property valuation, a seventh price specification property valuation price specification element property valuation, an eighth price specification property valuation price specification element property valuation, a ninth price specification property valuation price specification element property valuation, and a tenth price specification property valuation price specification element property valuation.

9. A distributed system operating in a landscape of computer systems providing message-based services defined in a service registry, the system comprising:
a graphical user interface comprising computer readable instructions, embedded on tangible media, for synchronous request for finding a sales price list by its type code, property ID and property value using a request;
a first memory storing a user interface controller for processing the request and involving a message including a message package hierarchically organized as:
a sales price list find by type code and property ID and property value query message entity; and
a sales price list package comprising a sales price list entity; and
a second memory, remote from the graphical user interface, storing a plurality of service interfaces, where one of the service interfaces is operable to process the message via the service interface.

10. The distributed system of claim 9, wherein the first memory is remote from the graphical user interface.

11. The distributed system of claim 9, wherein the first memory is remote from the second memory.

12. A computer readable medium including program code for providing a message-based interface for exchanging sales price specification information the medium comprising:
program code for receiving via a message-based interface exposing at least one service as defined in a service registry and from a heterogeneous application executing in an environment of computer systems providing message-based services, a first message for a synchronous request for finding a sales price specification by its type code, property identifier (ID) and property value that includes a message package hierarchically organized as:
a sales price specification find by type code and property ID and property value query elements message entity; and
a sales price specification find by type code and property ID and property value query elements package comprising a sales price specification find by type code and property ID and property value query elements entity; and
program code for sending a second message to the heterogeneous application responsive to the first message.

13. The computer readable medium of claim 12, wherein the sales price specification find by type code and property ID and property value query elements entity includes at least one of the following: a price specification element type code, a release status code, a consistency status code, a validity period, a creation date time interval, a last changed datetime interval, a first price specification element property valuation, a second price specification element property valuation, a third price specification element property valuation, a fourth price specification element property valuation, a fifth price specification element property valuation, a sixth price specification element property valuation, a seventh price specification element property valuation, an eighth price specification element property valuation, a ninth price specification element property valuation, and a tenth price specification element property valuation.

14. A distributed system operating in a landscape of computer systems providing message-based services defined in a service registry, the system comprising:
a graphical user interface comprising computer readable instructions, embedded on tangible media, for synchronous request for finding a sales price specification by its type code, property ID and property value using a request;
a first memory storing a user interface controller for processing the request and involving a message including a message package hierarchically organized as:
a sales price specification find by type code and property ID and property value query elements message entity; and
a sales price specification find by type code and property ID and property value query elements package comprising a sales price specification find by type code and property ID and property value query elements entity; and
a second memory, remote from the graphical user interface, storing a plurality of service interfaces, where one of the service interfaces is operable to process the message via the service interface.

15. The distributed system of claim 14, wherein the first memory is remote from the graphical user interface.

16. The distributed system of claim 14, wherein the first memory is remote from the second memory.

17. A computer readable medium including program code for providing a message-based interface for exchanging sales target plans that provide revenue targets for particular sales units and time horizons, the medium comprising:
program code for receiving via a message-based interface exposing at least one service as defined in a service registry and from a heterogeneous application executing in an environment of computer systems providing message-based services, a first message for providing a notification of a sales target plan that provides revenue targets for a particular sales unit and a time horizon that includes a message package hierarchically organized as:
a sales target plan message entity; and
a sales target plan package comprising a sales target plan entity, a characteristic package, and a key figure package; and
program code for sending a second message to the heterogeneous application responsive to the first message.

18. The computer readable medium of claim 17, wherein the sales target plan package further comprises at least one of the following: a description package, a version package, a view package, and a restriction by characteristic package.

19. The computer readable medium of claim 17, wherein the sales target plan entity includes at least one of the following: a universally unique identifier (UUID), a sales target plan identifier (ID), a sales unit ID, a horizon start year month, a horizon end year month, a status, and a meta object key.

20. A distributed system operating in a landscape of computer systems providing message-based services defined in a service registry, the system comprising:
a graphical user interface comprising computer readable instructions, embedded on tangible media, for providing a notification of a sales target plan that provides revenue targets for a particular sales unit and a time horizon using a request;
a first memory storing a user interface controller for processing the request and involving a message including a message package hierarchically organized as:
a sales target plan message entity; and
a sales target plan package comprising a sales target plan entity, a characteristic package, and a key figure package; and
a second memory, remote from the graphical user interface, storing a plurality of service interfaces, where one of the service interfaces is operable to process the message via the service interface.

21. The distributed system of claim 20, wherein the first memory is remote from the graphical user interface.

22. The distributed system of claim 20, wherein the first memory is remote from the second memory.
